(19) United States
(12) Patent Application Publication
(10) Pub. No.: US 2026/0268087 A1
(43) Pub. Date: Sep. 10, 2026

(54) Governed Persistent Cognitive Machine with Admissibility-Conditioned Reasoning and Irreversible Suppression

(71) Applicant: AtomBeam Technologies Inc., Moraga, CA (US)

(72) Inventor: Brian Galvin, Silverdale, WA (US)

(21) Appl. No.: 19/659,126

(22) Filed: Apr. 27, 2026

Related U.S. Application Data
(63) Continuation-in-part of application No. 19/649,400, filed on Apr. 16, 2026.
Application No. 19/649,400 is a continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/334,638, filed on Sep. 19, 2025.
Application No. 19/334,638 is a continuation-in-part of application No. 19/328,082, filed on Sep. 12, 2025, now Pat. No. 12,572,748.
Application No. 19/328,082 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,107, filed on Jul. 19, 2025.
(60) Provisional application No. 63/901,793, filed on Oct. 19, 2025.
(60) Provisional application No. 63/941,637, filed on Dec. 15, 2025.
(60) Provisional application No. 63/941,642, filed on Dec. 15, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/965,242, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.
(60) Provisional application No. 64/011,093, filed on Mar. 19, 2026.
(60) Provisional application No. 64/011,100, filed on Mar. 19, 2026.
(60) Provisional application No. 64/011,104, filed on Mar. 19, 2026.
(60) Provisional application No. 64/011,106, filed on Mar. 19, 2026.
(60) Provisional application No. 64/011,111, filed on Mar. 19, 2026.
(60) Provisional application No. 64/012,356, filed on Mar. 20, 2026.
(60) Provisional application No. 64/012,364, filed on Mar. 20, 2026.
(60) Provisional application No. 64/012,371, filed on Mar. 20, 2026.
(60) Provisional application No. 64/012,381, filed on Mar. 20, 2026.
(60) Provisional application No. 64/012,389, filed on Mar. 20, 2026.

(51) Int. Cl. G06F 40/30; G06F 16/332; G06F 16/3329

(52) U.S. Cl. CPC G06F 40/30; G06F 16/3325; G06F 16/3329

(57) ABSTRACT

A governed persistent cognitive machine maintains a persistent cognitive substrate encoding semantic relationships between cognitive states together with epistemic conditioning information governing which reasoning trajectories may be formed and traversed. Candidate cognitive states from heterogeneous sources are projected to provisional locations and evaluated for epistemic admissibility against structural properties of the substrate before participating in active reasoning. During traversal, a path-dependent coherence quantity is accumulated and monitored for coherence failure conditions, with intervention applied upon detection. Inadmissible reasoning patterns are projected into irreversible reservoirs through non-invertible operations that preserve structural pattern information while discarding reconstructable trajectory details, and asymmetric constraint feedback from the reservoirs conditions subsequent admissibility evaluations. Outputs are generated only from epistemically admissible trajectories and are suppressed, qualified, or withheld when admissibility conditions are not satisfied. Admissibility outcomes drive lifecycle optimization including fine-tuning, cache curation, and autonomous geometric reorganization across distributed deployments.

### CROSS-REFERENCE TO RELATED APPLICATIONS

Priority is claimed in the application data sheet to the following patents or patent applications, each of which is expressly incorporated herein by reference in its entirety:
Ser. No. 19/649,400
Ser. No. 19/550,709
Ser. No. 19/548,024
Ser. No. 19/546,407
Ser. No. 19/534,677
64/012,356
64/012,364
64/012,371
64/012,381
64/012,389
64/011,093
64/011,100
64/011,104
64/011,106
64/011,111
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
63/965,242
63/941,637
63/941,642
63/901,793
Ser. No. 19/334,638
Ser. No. 19/328,082
Ser. No. 19/321,173
Ser. No. 19/284,115
Ser. No. 19/051,193
63/847,082
63/847,091
63/847,096
63/847,101
63/847,107

### BACKGROUND OF THE INVENTION

### Field of the Art

The present invention is in the field of artificial intelligence and cognitive computing architectures, and more particularly to persistent geometric reasoning systems that govern the formation, traversal, consolidation, and expression of reasoning trajectories through epistemically conditioned admissibility control, path-dependent coherence monitoring, irreversible suppression of inadmissible reasoning patterns, and admissibility-gated output generation.

### Discussion of the State of the Art

Contemporary artificial intelligence systems, including large-scale neural networks and large language models, achieve high levels of fluency and task performance by learning statistical associations across vast training datasets. In such systems, reasoning is implemented as probabilistic sequence generation or iterative transformation within high-dimensional latent vector spaces, and outputs are produced by sampling from learned probability distributions conditioned on input context. These systems lack intrinsic mechanisms for distinguishing between reasoning pathways that are merely statistically plausible and those that are epistemically justified by accumulated evidence, and they provide no structural means by which illegitimate reasoning trajectories can be identified and excluded from execution prior to output generation.

Efforts to address reliability limitations in existing architectures have largely focused on post-hoc intervention techniques applied after reasoning has already been executed. Confidence scoring approaches assign scalar likelihood estimates to generated outputs based on internal model activations or output token probabilities, but these scores reflect statistical consistency with training distributions rather than structural epistemic legitimacy and cannot reliably distinguish fluent but unsupported outputs from genuinely grounded ones. Retrieval-augmented generation approaches supplement model outputs with externally retrieved documents, but retrieval relevance does not guarantee evidential consistency and retrieved content is incorporated into reasoning without structural evaluation of its epistemic compatibility with existing knowledge. Self-consistency sampling approaches generate multiple candidate outputs and select among them based on agreement, but agreement among statistically similar outputs does not constitute independent evidential corroboration and provides no structural guarantee against systematic epistemic failure modes. Reinforcement learning from human feedback approaches train models to produce outputs preferred by human evaluators, but human preference signals are episodic, expensive to generate, and reflect surface-level quality assessments rather than structural epistemic grounding. Rule-based content filtering approaches apply post-generation constraints to suppress specific output categories, but such filters operate on surface output representations and cannot address epistemic failures that manifest in semantically plausible but evidentially unsupported reasoning.

Existing multi-agent and expert system architectures distribute reasoning across multiple specialized components and apply coordination mechanisms to aggregate their outputs, but these architectures typically employ heuristic scoring, voting schemes, or rule-based fusion logic that operates on surface-level output representations rather than on the structural epistemic properties of the underlying reasoning content. Such approaches lack persistent memory structures that accumulate evidential grounding across interactions, provide no mechanisms for evaluating the epistemic admissibility of candidate reasoning states before they participate in active inference, and offer no principled basis for distinguishing cognitive content that has been structurally validated through accumulated evidence from content that is merely semantically proximate to validated knowledge.

Enterprise deployments of artificial intelligence systems require reliability guarantees that go beyond statistical performance metrics, including the ability to withhold or qualify outputs when evidential grounding is insufficient, to explain the structural basis for epistemic limitations in generated responses, to propagate reliability governance across distributed deployments without exposing sensitive cognitive content, and to improve epistemic reliability continuously through operational experience rather than requiring periodic manual retraining. Existing architectures provide no integrated framework for achieving these properties simultaneously, leaving enterprise deployments dependent on patchworks of post-hoc filtering, manual review, and domain-specific validation logic that cannot scale to the breadth of reasoning tasks required by sophisticated cognitive applications.

What is needed is a persistent cognitive architecture that structurally governs the formation, traversal, consolidation, and expression of reasoning trajectories through integrated admissibility control, path-dependent coherence monitoring, and irreversible suppression of inadmissible reasoning patterns, such that epistemic reliability is enforced as an architectural property of the reasoning substrate rather than as a post-hoc correction applied to generated outputs, and that continuously improves its epistemic governance effectiveness through accumulated operational experience across distributed deployments.

### SUMMARY OF THE INVENTION

Accordingly, the inventor has conceived and reduced to practice, a governed persistent cognitive machine maintains a persistent cognitive substrate encoding semantic relationships between cognitive states together with epistemic conditioning information governing which reasoning trajectories may be formed and traversed. Candidate cognitive states from heterogeneous sources are projected to provisional locations and evaluated for epistemic admissibility against structural properties of the substrate before participating in active reasoning. During traversal, a path-dependent coherence quantity is accumulated and monitored for coherence failure conditions, with intervention applied upon detection. Inadmissible reasoning patterns are projected into irreversible reservoirs through non-invertible operations that preserve structural pattern information while discarding reconstructable trajectory details, and asymmetric constraint feedback from the reservoirs conditions subsequent admissibility evaluations. Outputs are generated only from epistemically admissible trajectories and are suppressed, qualified, or withheld when admissibility conditions are not satisfied. Admissibility outcomes drive lifecycle optimization including fine-tuning, cache curation, and autonomous geometric reorganization across distributed deployments.

According to a preferred embodiment, a computer system comprising one or more processors and non-transitory machine-readable storage media storing instructions that cause the system to: maintain a persistent cognitive substrate in which cognitive states are represented as structured locations and reasoning processes are represented as trajectories through the substrate, the persistent cognitive substrate encoding semantic relationships between cognitive states together with epistemic conditioning information that governs which cognitive states and reasoning trajectories are permitted to participate in active reasoning; project a candidate state derived from an external input or an internally generated representation to a provisional location in the persistent cognitive substrate; prior to incorporating the provisional location into active reasoning, evaluate epistemic admissibility of the provisional location against one or more structural properties of the persistent cognitive substrate, and deny admission by preventing formation of a reasoning trajectory from the provisional location when epistemic admissibility is not satisfied; compute at least one reasoning trajectory through the persistent cognitive substrate from an admitted cognitive state; during traversal of the reasoning trajectory, monitor epistemic coherence by tracking a path-dependent quantity accumulated along transitions of the trajectory and detecting a coherence failure condition based on the accumulated path-dependent quantity; in response to detecting a coherence failure condition, intervene in traversal by performing at least one of interrupting the trajectory, redirecting traversal to an alternative admissible path, or marking the trajectory as epistemically inadmissible; when a trajectory or class of trajectories is determined to be epistemically inadmissible, generate a constraint representation characterizing a structural basis for the inadmissibility and store the constraint representation in one or more irreversible reservoirs in a form that is not restorable to active reasoning participation; apply asymmetric constraint feedback from the irreversible reservoirs to influence subsequent admissibility evaluations and traversal decisions without permitting active reasoning to modify contents of the irreversible reservoirs; and generate an output conditioned on epistemic admissibility status maintained throughout admission and traversal, wherein the output is suppressed, qualified, or withheld when no epistemically admissible reasoning trajectory supports a response, and wherein the persistent cognitive substrate is updated based on outcomes of admissibility evaluation and traversal coherence monitoring so that subsequent reasoning cycles reflect accumulated epistemic governance decisions, is disclosed.

According to an aspect of an embodiment, the persistent cognitive substrate comprises a latent manifold carrying: a semantic metric encoding semantic dissimilarity between cognitive states and governing geodesic distances within the latent manifold; an almost-complex structure defined on tangent spaces of the latent manifold satisfying a squared-equals-negative-identity constraint and restricting admissible deformations of the manifold to deformations preserving both the semantic metric and the almost-complex structure; a symplectic form reconstructed from the semantic metric and the almost-complex structure according to a compatibility relation and satisfying a closedness condition; and an epistemic connection that is geometrically independent of the semantic metric and assigns transition-specific coherence values to transitions between cognitive states, such that two regions of the latent manifold having identical structure under the semantic metric may exhibit different epistemic curvature values reflecting different levels of evidential support.

According to an aspect of an embodiment, the one or more structural properties against which epistemic admissibility is evaluated comprise at least one of: a local capacity measure derived from the symplectic form by computing a symplectic capacity associated with a neighborhood of the provisional location, wherein admission is denied when a projected post-insertion capacity density at the provisional location exceeds a capacity density threshold relative to the computed symplectic capacity; an admissibility boundary condition derived from barrier energy computed at boundaries of consolidated irreversible reservoirs within the latent manifold, wherein admission is denied or flagged when the provisional location falls within a barrier neighborhood of a consolidated region; a degeneracy indicator derived from epistemic curvature computed from the epistemic connection at the provisional location, wherein admission is denied or flagged when epistemic curvature magnitude exceeds a curvature threshold; or compatibility with path-dependent descriptors maintained for the latent manifold, wherein admission is denied or flagged when path-dependent descriptors applicable to the provisional location exhibit mutual inconsistency exceeding a descriptor conflict threshold.

According to an aspect of an embodiment, evaluating epistemic admissibility of the provisional location comprises performing, in sequence: evaluating structural compatibility of an almost-complex structure interpolated at the provisional location by computing a compatibility residual measuring discrepancy between the interpolated structure and existing almost-complex structures at neighboring cognitive states, and assigning a provisional participation status when the compatibility residual exceeds a structural compatibility threshold; evaluating symplectic capacity by computing a projected post-insertion capacity density at the provisional location from local symplectic face areas derived from the symplectic form, and denying admission when the projected capacity density exceeds a capacity density threshold; evaluating topological admissibility of the provisional location within a reservoir-stratified state space defined by removing barrier neighborhoods associated with consolidated irreversible reservoirs from the latent manifold, and denying admission when the provisional location or associated immediate transitions are not reachable within the accessible region without crossing a barrier boundary; and evaluating epistemic curvature by computing insertion curvature over faces created by the proposed insertion and performing micro-holonomy screening over short closed loops passing through the provisional location, and assigning a boundary defect outcome when curvature or loop phase magnitudes exceed respective thresholds and the provisional location is near a reservoir boundary.

According to an aspect of an embodiment, candidate states admitted to the persistent cognitive substrate are assigned one of a plurality of graded participation states comprising: an absorbed state in which the candidate state is fully incorporated into the persistent cognitive substrate with complete structural assignments and is eligible to participate in reasoning traversal and consolidation; a provisional state in which the candidate state participates in reasoning traversal at reduced commitment but is excluded from consolidation until local structural conditions stabilize; a quarantined state in which the candidate state is isolated from active reasoning pending resolution of detected epistemic inconsistencies or capacity violations; a suppressed state in which the candidate state is prevented from participating in reasoning traversal and a constraint representation characterizing the basis for suppression is stored in an irreversible reservoir; and a consolidation-eligible state in which the candidate state has satisfied epistemic admissibility, traversal coherence, and capacity conditions and may transition to a consolidated irreversible reservoir upon satisfaction of concurrent multi-layer admissibility conditions.

According to an aspect of an embodiment, the system further manages transitions between graded participation states by: promoting a provisional state to an absorbed state when structural compatibility conditions are satisfied under geometric evolution of the persistent cognitive substrate; promoting a provisional state to a consolidation-eligible state when the candidate state additionally satisfies traversal coherence conditions and capacity admissibility conditions; demoting an absorbed state to a quarantined state when subsequent traversal events or evidence-driven updates generate accumulated epistemic strain at the location exceeding a strain threshold; transitioning a quarantined state to a suppressed state when contradiction evidence accumulates beyond a revision threshold without resolution; and maintaining asymmetric constraint feedback from suppressed states to subsequent admissibility evaluations without restoring suppressed states to active reasoning participation.

According to an aspect of an embodiment, the persistent cognitive substrate further comprises a thought cache storing previously generated cognitive structures as compressed representations within the persistent cognitive substrate, and wherein projecting a candidate state comprises: retrieving one or more cached cognitive structures satisfying a semantic similarity threshold relative to the candidate state; evaluating epistemic admissibility of each retrieved cached structure against current structural properties of the persistent cognitive substrate prior to incorporating the cached structure into active reasoning; and excluding cached cognitive structures assigned a suppressed or quarantined participation state from participating in reasoning traversal regardless of semantic similarity to the candidate state.

According to an aspect of an embodiment, the thought cache implements a multi-tier storage architecture comprising a session cache maintaining recent cognitive structures with full structural fidelity, a long-term cache maintaining consolidated cognitive structures with compressed representations, and a constraint cache maintaining non-reconstructable constraint artifacts projected from epistemically inadmissible reasoning patterns, and wherein retrieval from the constraint cache is limited to read-only admissibility evaluation queries and does not restore inadmissible cognitive structures to active reasoning participation.

According to an aspect of an embodiment, the system is further configured to admit candidate states derived from outputs of a plurality of heterogeneous reasoning sources comprising at least two of a large language model, a domain-specific expert model, a multimodal inference engine, or a sensor-derived interpretation pipeline, and wherein: each candidate state derived from a heterogeneous reasoning source is independently evaluated for epistemic admissibility against structural properties of the persistent cognitive substrate prior to incorporation into active reasoning; candidate states from different reasoning sources that target semantically proximate locations in the persistent cognitive substrate are evaluated for mutual epistemic consistency using path-dependent descriptors maintained for those locations; and when candidate states from different reasoning sources exhibit epistemic inconsistency at a common location, the system assigns a quarantined participation state to the inconsistent candidates and generates a conflict representation for storage in an irreversible reservoir.

According to an aspect of an embodiment, the system further arbitrates among candidate states from heterogeneous reasoning sources by: computing a composite admissibility score for each candidate state incorporating structural compatibility, capacity, and epistemic strain metrics derived from the persistent cognitive substrate; routing candidate states exceeding an admissibility score threshold to an absorbed or provisional participation state for incorporation into active reasoning; routing candidate states below the admissibility score threshold to a quarantined state pending corroboration from an independent reasoning source; and when no candidate state from any reasoning source satisfies the admissibility score threshold for a given location, escalating the unresolved location to a supervisory arbitration layer configured to request additional evidence or external corroboration before permitting reasoning traversal through that location.

According to an aspect of an embodiment, the system is further configured to present epistemic status information to a human operator or downstream process by: qualifying generated outputs with a graded confidence indicator derived from the participation state and traversal coherence classification of the reasoning trajectory supporting the output; withholding a generated output and presenting an epistemic insufficiency notification identifying a structural basis for withholding when no epistemically admissible reasoning trajectory supports a response; presenting a corroboration request to a human operator or upstream evidence source when a reasoning trajectory exhibits a coherence failure condition and no independent corroborating trajectory satisfying coherence conditions can be identified within the persistent cognitive substrate; and providing a traversal explanation identifying locations of elevated epistemic strain, capacity constraint, or admissibility boundary encountered during reasoning traversal that contributed to output qualification or withholding.

According to an aspect of an embodiment, the graded confidence indicator presented with a generated output reflects at least one of: a participation state of cognitive states traversed during the reasoning trajectory supporting the output; a coherence classification of path-dependent quantities detected during traversal; a consolidation status of substrate regions traversed during reasoning, distinguishing consolidated irreversible reservoir regions from frontier regions undergoing active restructuring; or a corroboration status indicating whether conclusions reached along the reasoning trajectory were independently corroborated by a non-homotopic admissible trajectory.

According to an aspect of an embodiment, the persistent cognitive substrate is maintained across a plurality of distributed nodes, and wherein the system is further configured to propagate admissibility governance across the distributed nodes by: sharing constraint representations derived from epistemically inadmissible reasoning patterns between nodes through an asymmetric propagation protocol that transmits canonical constraint identifiers and structural pattern descriptors without transmitting reconstructable trajectory details or underlying cognitive state content; maintaining node-local admissibility indices derived from received constraint representations such that inadmissible patterns identified at one node influence admissibility evaluations at other nodes without requiring synchronization of full substrate state; and preserving privacy boundaries between nodes by restricting propagated content to abstract constraint artifacts that cannot be used to reconstruct cognitive states, reasoning trajectories, or consolidated knowledge content of the originating node.

According to an aspect of an embodiment, propagating admissibility governance across distributed nodes further comprises: synchronizing reservoir boundary sets between nodes so that topological admissibility evaluations at each node reflect consolidated knowledge boundaries established across the distributed deployment; applying privacy-preserving mechanisms to constraint representations prior to propagation to provide quantifiable privacy guarantees against reconstruction of originating node content; and resolving conflicts between admissibility indices received from different nodes using a consensus protocol that weights constraint representations by stability metrics of the originating consolidated regions.

According to an aspect of an embodiment, the system is further configured to use outcomes of admissibility evaluation and traversal coherence monitoring as governance signals for updating the persistent cognitive substrate, comprising at least one of: using suppression events and constraint representations stored in irreversible reservoirs as fine-tuning signals or cache-curation signals that reduce retrieval probability of semantically proximate cached cognitive structures associated with suppressed trajectory classes; using coherence failure conditions and corroboration failures detected during traversal monitoring as inputs to an autonomous reorganization process configured to restructure regions of the persistent cognitive substrate exhibiting elevated epistemic strain or persistent coherence failure during reduced-activity periods; and using admissibility outcome distributions across a sequence of reasoning cycles as routing signals that adjust assignment of candidate states to reasoning pathways or expert domains based on observed epistemic reliability patterns.

According to an aspect of an embodiment, using suppression events as cache-curation signals comprises: identifying cached cognitive structures within a proximity threshold of suppressed locations in the persistent cognitive substrate; reducing activation energy of identified cached structures proportionally to the epistemic strain magnitude associated with the suppression event; and accelerating decay of cached structures whose activation energy falls below a minimum threshold as a result of suppression-driven curation, thereby removing epistemically compromised cached content from the persistent cognitive substrate without requiring explicit deletion operations.

### BRIEF DESCRIPTION OF THE DRAWING FIGURES

FIG. 1 is a block diagram illustrating an exemplary integrated architecture for a PCM governed reasoning system, according to an embodiment.

FIG. 2 is a block diagram illustrating an exemplary architecture of an epistemically conditioned manifold substrate, according to an embodiment.

FIG. 3 is a block diagram illustrating an exemplary architecture of a CDE, geodesic traversal, goal field, and phase monitoring subsystem, according to an embodiment.

FIG. 4 is a block diagram illustrating an exemplary architecture of a thought cache, persistent memory, and reservoir interaction subsystem, according to an embodiment.

FIG. 5 is a flow diagram illustrating an exemplary epistemic admission control flow, according to an embodiment.

FIG. 6 is a flow diagram illustrating an exemplary traversal monitoring and corroboration flow, according to an embodiment.

FIG. 7 is a flow diagram illustrating an exemplary consolidation, reservoir, and irreversible suppression flow, according to an embodiment.

FIG. 8 is a flow diagram illustrating an exemplary output gating, qualification, and suppression flow, according to an embodiment.

FIG. 9 illustrates an exemplary computing environment on which an embodiment described herein may be implemented.

### DETAILED DESCRIPTION OF THE INVENTION

The inventor has conceived, and reduced to practice, a governed persistent cognitive machine maintains a persistent cognitive substrate encoding semantic relationships between cognitive states together with epistemic conditioning information governing which reasoning trajectories may be formed and traversed. Candidate cognitive states from heterogeneous sources are projected to provisional locations and evaluated for epistemic admissibility against structural properties of the substrate before participating in active reasoning. During traversal, a path-dependent coherence quantity is accumulated and monitored for coherence failure conditions, with intervention applied upon detection. Inadmissible reasoning patterns are projected into irreversible reservoirs through non-invertible operations that preserve structural pattern information while discarding reconstructable trajectory details, and asymmetric constraint feedback from the reservoirs conditions subsequent admissibility evaluations. Outputs are generated only from epistemically admissible trajectories and are suppressed, qualified, or withheld when admissibility conditions are not satisfied. Admissibility outcomes drive lifecycle optimization including fine-tuning, cache curation, and autonomous geometric reorganization across distributed deployments.

### Graded Participation States for Cognitive State Insertion and Reasoning Control

According to an embodiment, the persistent cognitive substrate maintains, for each cognitive state projected into or residing within the substrate, an explicit participation state that governs the degree to which that cognitive state may influence active reasoning, contribute to consolidation, and participate in output generation. Rather than treating admission as a binary accept-or-reject decision, the system implements a graded participation state machine in which cognitive states transition through a defined set of operational states based on accumulated epistemic evidence, structural conditions of the persistent cognitive substrate, and outcomes of admissibility evaluation and traversal coherence monitoring. The graded participation state machine provides finer-grained control over the lifecycle of cognitive states than binary admission alone and enables the system to maintain epistemic discipline across reasoning cycles without discarding potentially valuable cognitive content prematurely.

A cognitive state in the absorbed state is fully incorporated into the persistent cognitive substrate with complete structural assignments. An absorbed state carries a full set of semantic relationship encodings to neighboring cognitive states, complete path-dependent descriptors reflecting its evidential grounding, and unrestricted eligibility to participate in reasoning traversal, thought cache retrieval, and consolidation evaluation. Absorbed states represent cognitive content whose epistemic admissibility has been affirmatively established through the admission evaluation process and whose structural properties are consistent with the surrounding substrate geometry. Absorbed states may be retrieved from a thought cache as candidates for reuse in subsequent reasoning cycles without requiring re-evaluation of admissibility at each retrieval, subject to periodic re-evaluation when evidence-driven updates alter the epistemic connection in the vicinity of the absorbed state. The absorbed state is the target terminal state for well-supported cognitive content and represents the normal operational condition for cognitive states that have passed all admission criteria.

A cognitive state in the provisional state has been permitted to participate in reasoning traversal but carries one or more unresolved structural anomalies that preclude immediate full incorporation into the persistent cognitive substrate. Provisional states arise when a candidate cognitive state exhibits structural compatibility residuals above threshold, epistemic curvature at insertion above a curvature threshold, or path-dependent descriptor inconsistencies that do not rise to the level of a veto but indicate that the state's evidential grounding has not been fully established. A provisional state participates in active reasoning at reduced commitment, meaning that conclusions reached through reasoning trajectories that traverse provisional states are eligible for output generation only with accompanying qualification indicators reflecting the provisional status of the traversed content. Provisional states are excluded from consolidation eligibility until local structural conditions in the persistent cognitive substrate stabilize sufficiently to permit re-evaluation. Under geometric evolution of the substrate, specifically under the connection relaxation flow operating on a slow timescale, epistemic curvature in the vicinity of a provisional state may decay toward the flatness threshold, at which point the system re-evaluates the state for promotion to the absorbed state. Alternatively, if evidence-driven updates introduce contradictory epistemic structure in the vicinity of a provisional state, the state may be demoted to a quarantined state pending resolution of the contradiction.

A cognitive state in the quarantined state has been isolated from active reasoning participation pending resolution of detected epistemic inconsistencies, capacity violations, or accumulated contradictory evidence that renders the state's contribution to reasoning unreliable. Quarantined states may arise through several pathways. A candidate cognitive state may be assigned a quarantined state directly at admission when capacity density at the provisional location exceeds the capacity density threshold, precluding immediate insertion but preserving the candidate for deferred integration after a subsequent compression cycle reduces local capacity density. An absorbed state may be demoted to the quarantined state when subsequent traversal events or evidence-driven updates generate accumulated epistemic strain at the location exceeding a strain threshold, indicating that the evidential grounding of the state has been undermined by newly incorporated information. A provisional state may transition to the quarantined state when structural anomalies present at insertion persist beyond a stabilization window without resolution under geometric evolution. Cognitive states in the quarantined state do not participate in reasoning traversal, are not retrieved from the thought cache for use in active reasoning, and do not contribute to consolidation evaluation. The quarantined state is a holding condition rather than a terminal state: the system continues to monitor quarantined cognitive states and may promote them to a provisional or absorbed state if subsequent evidence resolves the inconsistencies that triggered quarantine, or may transition them to the suppressed state if contradictory evidence accumulates beyond a revision threshold without resolution.

A cognitive state in the suppressed state has been permanently excluded from active reasoning participation, and a constraint representation characterizing the structural basis for suppression has been projected into an irreversible reservoir through a non-invertible operation. Suppressed states arise when a trajectory or class of trajectories associated with the cognitive state has been determined to be epistemically inadmissible, either through a veto outcome at admission evaluation, an inversion regime classification during traversal monitoring, or accumulation of contradictory boundary events beyond a revision threshold in the quarantined state without resolution. The non-invertible projection operation maps the suppressed cognitive state and its associated trajectory class to a canonical constraint identifier that preserves structural pattern information sufficient to identify similar inadmissible patterns in future reasoning, while discarding reconstructable details of the original cognitive state, trajectory sequence, and intermediate reasoning steps. Once a cognitive state has been assigned a suppressed state and its constraint representation has been projected into an irreversible reservoir, the state does not transition to any other participation state through ordinary reasoning operations. The suppressed state is irreversible with respect to active reasoning: the constraint representation stored in the irreversible reservoir influences future admissibility evaluations through asymmetric constraint feedback but cannot be used to reconstruct or restore the suppressed cognitive state to reasoning participation. Suppressed states thereby implement a structural forgetting mechanism that is asymmetric in nature—the system retains sufficient information about the suppressed content to avoid repeating the suppressed reasoning pattern while discarding sufficient detail to prevent that content from re-entering active cognition.

A cognitive state in the consolidation-eligible state has satisfied the concurrent multi-layer admissibility conditions required for transition to a consolidated irreversible reservoir and is awaiting final evaluation by the consolidation gate before irreversible commitment. A cognitive state reaches the consolidation-eligible state when it has been assigned an absorbed participation state following admission evaluation, the reasoning trajectories traversing the state have been classified in a coherent or corroborated phase regime during traversal monitoring, and the region of the persistent cognitive substrate surrounding the state satisfies phase flatness, barrier energy, and capacity admissibility conditions evaluated by the consolidation layer. The consolidation-eligible state is distinct from the absorbed state in that it represents not merely successful admission and traversal but affirmative readiness for irreversible commitment of the surrounding substrate region as a consolidated knowledge reservoir. Transition from the consolidation-eligible state to a consolidated irreversible reservoir requires concurrent satisfaction of all three layers of the epistemic governance architecture: epistemic admissibility at admission evaluation, epistemic coherence or corroboration at traversal monitoring, and capacity admissibility at the consolidation stage. When the logical conjunction of these three layer conditions is satisfied, the system commits the surrounding region to consolidated status, and cognitive states within that region transition to a consolidated participation state reflecting their membership in a stable, epistemically grounded knowledge structure.

A cognitive state in the consolidated state resides within a region of the persistent cognitive substrate that has completed a consolidation transition and satisfies the geometric conditions defining an irreversible reservoir: epistemic curvature flatness below the flatness threshold, boundary energy exceeding the barrier threshold, and boundary-aware admission control routing compatible states into the region while excluding incompatible states. Consolidated states represent the most epistemically mature cognitive content within the system and exhibit quantifiable stability across three complementary dimensions. Semantic stability ensures that admissible deformations of the surrounding substrate structure produce bounded changes in the relationships between consolidated cognitive states, controlled by the flatness of the epistemic connection within the consolidated region. Epistemic stability ensures that any modification to the evidential grounding of a consolidated state requires energy proportional to the barrier energy of the surrounding region and produces detectable boundary signatures observable by the traversal monitoring layer. Structural stability ensures that the intrinsic capacity of the consolidated region is preserved under admissible evolution, preventing compression of consolidated knowledge below its established structural limits. Consolidated states support the highest confidence outputs and contribute the most reliable cognitive content to reasoning trajectories that traverse them. Consolidated regions also serve as structural anchors for the learning readiness field that channels future knowledge acquisition along symplectically favored directions from the consolidated boundary, thereby implementing a mechanism by which established knowledge shapes the direction of future learning.

Transitions between graded participation states are governed by a combination of admission evaluation outcomes, traversal coherence monitoring results, evidence-driven updates to the epistemic connection, and geometric evolution of the persistent cognitive substrate on separated timescales. On the fast timescale, admission evaluation assigns an initial participation state to each newly projected candidate cognitive state based on immediate structural checks. On the intermediate timescale, the compression flow adjusts substrate geometry and may create conditions for promotion of provisional states to absorbed states as structural compatibility residuals decay. On the slow timescale, the connection relaxation flow reduces epistemic curvature across the substrate and may enable promotion of absorbed states to consolidation-eligible states as surrounding regions approach phase flatness conditions. Evidence-driven updates to the epistemic connection operate concurrently with these timescale flows and may trigger demotions as well as promotions depending on the direction of epistemic strain introduced by new evidence. The asymmetric nature of the transition dynamics —in which suppression transitions are irreversible and consolidation transitions are hysteretic, requiring energy proportional to barrier energy to reverse —reflects the architectural principle that epistemically committed knowledge is resistant to casual perturbation while epistemically inadmissible content is permanently excluded from active cognition.

The graded participation state of a cognitive state directly governs its eligibility for retrieval from the thought cache and its contribution to output generation. Absorbed and consolidated states are fully eligible for thought cache retrieval and may contribute without qualification to reasoning trajectories and output generation. Provisional states may be retrieved from the thought cache but contribute only to qualified outputs that carry participation state indicators reflecting the provisional character of the traversed content. Quarantined states are excluded from thought cache retrieval during the quarantine period and do not contribute to output generation. Suppressed states are permanently excluded from thought cache retrieval, and their associated constraint representations in irreversible reservoirs contribute only through asymmetric constraint feedback to admissibility evaluation, never through direct participation in reasoning or output generation. Consolidation-eligible states contribute to output generation at the same level as absorbed states pending completion of the consolidation gate evaluation, with output qualification reflecting the pending consolidation status where relevant. The interaction between graded participation states and output generation thereby implements a continuous spectrum of output reliability grading that reflects the epistemic maturity of the cognitive content underlying each generated response, from fully qualified outputs grounded in consolidated knowledge through appropriately qualified outputs reflecting provisional or corroborated content to withheld outputs when no sufficiently admissible cognitive content supports a response.

In deployments where candidate cognitive states are derived from outputs of multiple heterogeneous reasoning sources, the graded participation state machine provides a unified epistemic governance framework applicable regardless of the source of the candidate state. Each candidate state derived from a heterogeneous source—whether a large language model output, a domain-specific expert model inference, a multimodal inference result, or a sensor-derived interpretation—enters the graded participation state machine at the admission evaluation stage and is assigned an initial participation state based on the same structural properties of the persistent cognitive substrate that govern admission of internally generated candidate states. When candidate states from different reasoning sources target the same or semantically proximate locations in the persistent cognitive substrate and exhibit mutual epistemic inconsistency, the system assigns a quarantined participation state to the inconsistent candidates and initiates the arbitration process described herein. The graded participation state machine thereby provides a common epistemic currency for arbitrating among heterogeneous reasoning sources without privileging any particular source type and without requiring source-specific admission logic. The consolidation gate conditions that govern transition to consolidated status are likewise source-agnostic: cognitive content from any source may achieve consolidated status if it satisfies the concurrent multi-layer admissibility conditions, and cognitive content from any source may be suppressed if it fails epistemic admissibility or traversal coherence conditions.

### Multi-Model and Multi-Agent Arbitration Under Admissibility Control

According to an embodiment, the persistent cognitive substrate serves as a unified epistemic governance layer for reasoning systems in which cognitive states may be derived from a plurality of heterogeneous sources operating concurrently or in sequence. In contemporary deployments, a single reasoning system may incorporate outputs from multiple large language models, domain-specific expert models, multimodal inference engines, sensor-derived interpretation pipelines, retrieval-augmented generation components, and human-in-the-loop inputs, each of which may contribute candidate cognitive states reflecting different evidential foundations, reasoning methodologies, and confidence characteristics. Without a common epistemic governance framework, the outputs of these heterogeneous sources must be arbitrated through heuristic scoring, voting mechanisms, or rule-based fusion logic that operates on surface-level output representations rather than on the structural epistemic properties of the underlying cognitive content. The present system addresses this limitation by routing all candidate cognitive states, regardless of their source, through the same admission evaluation, traversal monitoring, and consolidation governance processes that govern internally generated cognitive content, thereby providing source-agnostic epistemic arbitration grounded in the structural properties of the persistent cognitive substrate rather than in source-specific heuristics.

Each reasoning source contributing candidate cognitive states to the system is registered within a source registry maintained by the persistent cognitive substrate. Registration associates each source with a capability characterization comprising the modalities of input the source processes, the domains of knowledge the source addresses, the representation format of outputs the source produces, and an initial epistemic reliability profile derived from historical admissibility outcomes for candidate states contributed by the source. The epistemic reliability profile is not a fixed prior assigned at registration but an evolving characterization updated continuously based on observed admissibility outcomes, traversal coherence classifications, consolidation success rates, and suppression frequencies for candidate states originating from the source. Sources that consistently contribute candidate states achieving absorbed or consolidated participation states accumulate higher epistemic reliability profile scores, while sources that consistently contribute candidate states requiring quarantine or suppression accumulate lower scores. The epistemic reliability profile influences the weight assigned to a source's candidate states during arbitration but does not override the structural admissibility evaluation: a source with a high reliability profile cannot cause an epistemically inadmissible candidate state to be admitted, and a source with a low reliability profile does not cause an epistemically admissible candidate state to be rejected. The reliability profile serves as a prior that biases threshold comparisons and arbitration scoring without substituting for structural epistemic evaluation.

When multiple reasoning sources contribute candidate cognitive states targeting the same or semantically proximate locations in the persistent cognitive substrate, each candidate state is independently evaluated for epistemic admissibility against the structural properties of the substrate at the target location before any inter-source comparison or arbitration is performed. Independent evaluation ensures that admission decisions are grounded in the structural epistemic properties of the persistent cognitive substrate rather than in the relative confidence scores or output likelihoods reported by the contributing sources. A candidate state from a source reporting high internal confidence is not admitted on the basis of that confidence alone if the structural properties of the substrate at the target location indicate capacity violation, degeneracy, or epistemic curvature inconsistency. Conversely, a candidate state from a source reporting low internal confidence is not excluded on that basis if the structural properties of the substrate indicate that the candidate is epistemically admissible. Following independent admission evaluation, each candidate state is assigned an initial graded participation state reflecting the outcome of its individual admissibility assessment, and the resulting participation states form the inputs to the inter-source arbitration process.

When independent admission evaluation results in two or more candidate cognitive states from different sources being assigned absorbed or provisional participation states at the same or semantically proximate locations in the persistent cognitive substrate, the system evaluates mutual epistemic consistency among the co-located candidates using the path-dependent descriptors and epistemic connection maintained for those locations. Epistemic consistency evaluation examines whether the evidential grounding of each candidate state is compatible with the evidential grounding of the other co-located candidates as reflected in the epistemic connection of the substrate. Two candidate states are epistemically consistent at a location if the path-dependent phase values associated with transitions between them, computed from the epistemic connection, remain within the coherent regime threshold. Two candidate states are epistemically inconsistent if the accumulated phase along paths connecting them exceeds the coherent regime threshold, indicating that their respective evidential groundings are in tension or contradiction as represented in the substrate geometry. Epistemic consistency evaluation among co-located candidates is performed independently of semantic similarity: two candidates may be semantically proximate under the semantic metric while exhibiting significant epistemic inconsistency as reflected in the epistemic connection, because the epistemic connection is geometrically independent of the semantic metric and encodes evidential relationships not captured by semantic distance alone.

When epistemic consistency evaluation identifies mutual inconsistency among co-located candidate states, the system selects among several arbitration outcomes based on the nature and severity of the inconsistency, the participation states of the involved candidates, and the structural properties of the substrate at the contested location.

When inconsistency magnitude is below a conflict threshold and both candidates are in an absorbed or provisional participation state, the system may assign a corroboration-pending status to the contested location and initiate a corroboration evaluation process in which the system seeks an independent reasoning trajectory that resolves the inconsistency by identifying a path through the substrate connecting the two candidates that remains within the coherent regime. If a corroborating trajectory is found that is not deformable into either of the original candidate trajectories within the reservoir-stratified state space, the corroborating trajectory may support reconciliation of the two candidates through a synthesis operation that generates a new candidate cognitive state incorporating the evidential grounding of both sources. The synthesized candidate is then independently evaluated for epistemic admissibility as a new candidate state.

When inconsistency magnitude exceeds the conflict threshold and curvature decomposition at the contested location reveals predominantly contradictory epistemic strain, the system assigns a quarantined participation state to both inconsistent candidates and generates a conflict representation encoding the structural basis for the inconsistency. The conflict representation is forwarded to the consolidation and irreversible suppression subsystem for classification and potential projection into an irreversible reservoir. Neither quarantined candidate participates in reasoning traversal until the inconsistency is resolved through subsequent evidence, corroboration, or escalation to supervisory arbitration.

When one candidate is in an absorbed participation state and the other is in a provisional participation state and the two exhibit epistemic inconsistency, the system preferentially maintains the absorbed candidate in its participation state and demotes the provisional candidate to a quarantined state, treating the absorbed candidate's established evidential grounding as the reference against which the provisional candidate's consistency is evaluated. This asymmetric treatment reflects the principle that cognitive content with established epistemic grounding in the substrate should not be displaced by newly arriving content of lesser epistemic maturity without affirmative corroboration.

When all co-located candidates from all contributing sources fail independent admission evaluation, the contested location is flagged as an unresolved epistemic gap, and the system escalates the gap to a supervisory arbitration layer while withholding output generation for any response dependent on that location.

To support arbitration among multiple candidate states that have each passed independent admission evaluation but differ in epistemic quality, the system computes a composite admissibility score for each candidate incorporating multiple structural metrics derived from the persistent cognitive substrate. The composite admissibility score integrates a structural compatibility component reflecting the degree to which the candidate's almost-complex structure assignment is consistent with neighboring substrate geometry, a capacity component reflecting the margin by which the candidate's insertion falls below the capacity density threshold, an epistemic curvature component reflecting the magnitude of epistemic curvature at the candidate's location relative to the curvature threshold, and a path-dependent coherence component reflecting the phase coherence of short loops passing through the candidate's location. Each component is normalized to a common scale and combined using weights that may be adapted based on the application domain, deployment context, and historical performance of the scoring function. The composite admissibility score is used to rank co-located candidates from different sources when arbitration must select among multiple epistemically admissible options, to set thresholds for routing candidates to absorbed versus provisional participation states, and to determine escalation priority when supervisory arbitration is invoked. The composite admissibility score does not override structural veto conditions: a candidate that fails a capacity density check or a topological admissibility check receives a veto outcome regardless of its composite score on other components.

When standard arbitration mechanisms cannot resolve epistemic inconsistency among co-located candidates from multiple sources—specifically when no corroborating trajectory can be identified, when all candidates fail admission evaluation, or when accumulated contradiction exceeds the revision threshold—the system escalates the unresolved location to a supervisory arbitration layer. The supervisory arbitration layer corresponds to the executive manifold supervisor and hierarchical supervisory network described in the expert foundry architecture, extended with epistemic governance capabilities. In the context of multi-source arbitration, the supervisory arbitration layer performs several functions. It examines the unresolved epistemic gap in the context of the broader substrate geometry to determine whether the gap reflects a genuine evidential insufficiency, a conflict among sources that can be resolved by obtaining additional evidence, or a structural incompatibility among source representations that requires geometric restructuring of the substrate. It may request additional candidate states from specific contributing sources by issuing targeted queries designed to probe the evidential basis for the inconsistency. It may invoke the dream manager to perform autonomous geometric reorganization of the contested substrate region during a reduced-activity period, potentially restructuring the manifold geometry to create conditions under which the inconsistency can be resolved or the contested location can be stably assigned to one of the competing candidates. It generates an escalation record encoding the structural basis for the unresolved inconsistency, the identities of the contributing sources, the participation states of the involved candidates, and the arbitration outcomes attempted, for use in subsequent training signal generation and cache curation operations. When supervisory arbitration cannot resolve the inconsistency within an operational timeout, the system withholds output generation for any response dependent on the contested location and presents an epistemic insufficiency notification to the human operator or downstream process with a structured explanation of the unresolved conflict.

In deployments implementing the expert foundry architecture described herein, candidate cognitive states may be contributed by multiple specialized expert domains operating on domain-specific persistent cognitive substrates, each with its own manifold geometry, thought cache, and epistemic connection. Cross-domain arbitration extends the single-substrate arbitration framework to handle candidate states arriving from expert domains whose persistent cognitive substrates may use different coordinate systems, semantic metrics, and epistemic connection calibrations reflecting their domain-specific knowledge structures. Cross-domain arbitration operates through a shared admissibility governance layer maintained by the hierarchical supervisory network and implements the following mechanisms.

A cross-domain semantic alignment step maps candidate states from domain-specific substrate coordinates into a shared arbitration space using manifold projection and metric alignment techniques that preserve semantic relationships while enabling comparison across domain boundaries. Following alignment, each mapped candidate state is evaluated for epistemic admissibility against the structural properties of the shared arbitration space rather than against the originating domain's substrate geometry, ensuring that arbitration reflects the epistemic properties of the integrated multi-domain knowledge structure rather than the individual domain's local geometry.

A knowledge transfer admissibility check evaluates whether candidate states proposed for transfer from one domain's substrate to another satisfy the epistemic admissibility conditions of the receiving domain's substrate. A candidate state that is absorbed in its originating domain may fail admission evaluation in a receiving domain if the epistemic connection of the receiving domain encodes evidential relationships that are inconsistent with the candidate's evidential grounding. The knowledge transfer admissibility check therefore ensures that cross-domain knowledge sharing is governed by the same epistemic principles as direct candidate state admission, preventing the importation of epistemically inadmissible content through knowledge transfer pathways.

A privacy-preserving arbitration protocol ensures that cross-domain arbitration does not expose domain-specific cognitive content, consolidated knowledge structures, or reasoning trajectories to other domains beyond what is necessary for admissibility evaluation. Arbitration communications between domains are restricted to composite admissibility scores, participation state assignments, canonical constraint identifiers, and structural pattern descriptors derived from non-invertible projection operations, preserving the privacy boundaries between expert domains established by the federated memory coordinator.

In reasoning scenarios where contributing sources provide candidate cognitive states sequentially rather than simultaneously, the graded participation state machine implements a temporal arbitration discipline that governs how newly arriving candidates interact with cognitive states already incorporated into the persistent cognitive substrate from earlier sources. A newly arriving candidate targeting a location already occupied by an absorbed cognitive state from an earlier source is evaluated for epistemic consistency with the existing absorbed state using the path-dependent descriptors maintained for that location. If the new candidate is epistemically consistent with the existing absorbed state, the system may update the epistemic connection at the location to reflect the additional evidential support provided by the new source, potentially strengthening the existing state's admissibility characteristics and accelerating its path toward consolidation eligibility. If the new candidate is epistemically inconsistent with the existing absorbed state, the system applies the asymmetric treatment described above, maintaining the existing absorbed state and assigning the new candidate a quarantined participation state, while recording the inconsistency as a boundary defect event for classification by the consolidation and irreversible suppression subsystem. This temporal discipline implements a recency-independent epistemic governance policy in which the epistemic maturity of existing substrate content, as reflected in participation states and consolidation status, takes precedence over the recency of arriving candidate states, preventing newly arriving but epistemically weaker content from displacing established epistemically grounded knowledge through temporal priority alone.

The outcomes of multi-source arbitration under admissibility control generate a continuous stream of source performance signals that the system uses to refine source selection, routing, and weighting decisions across reasoning cycles. Suppression events associated with candidate states from a particular source increment that source's suppression frequency metric and reduce its epistemic reliability profile score, making its future candidates more likely to be routed to provisional rather than absorbed participation states on initial admission. Consolidation events associated with candidate states from a particular source increment that source's consolidation success metric and increase its reliability profile score, making its future candidates more likely to receive favorable threshold comparisons in composite admissibility scoring. Corroboration relationships between candidates from different sources—where a candidate from one source provides a corroborating trajectory for a drift-regime candidate from another source—are recorded as inter-source corroboration links that inform routing decisions by increasing the probability that the two sources are queried together for future reasoning tasks in related substrate regions. These source performance signals are propagated to the dream manager as cache-curation inputs, to the routing layer of the expert foundry supervisory network as domain selection signals, and to post-training optimization processes as fine-tuning signals, thereby creating a closed-loop governance system in which multi-source arbitration outcomes continuously refine the epistemic reliability of the contributing source ecosystem as well as the structural properties of the persistent cognitive substrate itself.

### Human-in-the-Loop Escalation and Trust Presentation

The persistent cognitive substrate maintains a continuous record of epistemic admissibility status, traversal coherence classifications, participation state assignments, and consolidation outcomes for each reasoning cycle executed by the system. This record provides the structural foundation for a human-in-the-loop escalation and trust presentation layer that communicates the epistemic quality of generated outputs to human operators, downstream processes, and end users in a form that is both actionable and structurally grounded. Unlike confidence indicators derived from internal model activation magnitudes or output token probabilities, which reflect statistical associations learned during training without explicit representation of evidential grounding, the trust indicators produced by the present system are derived directly from the geometric and topological properties of the persistent cognitive substrate and the outcomes of the three-layer epistemic governance architecture. This structural grounding enables the system to provide trust presentations that are not merely probabilistic estimates of output correctness but explanatory accounts of the epistemic conditions under which a response was generated, the specific structural limitations that constrained or qualified the response, and the actions available to a human operator to resolve epistemic insufficiencies identified during reasoning.

Every output generated by the system carries a trust grade derived from the epistemic admissibility status and traversal coherence classification of the reasoning trajectory that produced it. The trust grade is a structured representation rather than a scalar score, comprising multiple components that together characterize the epistemic provenance of the output across the dimensions relevant to human decision-making and downstream process integration.

A participation state component reflects the highest participation state achieved by cognitive states traversed during the reasoning trajectory supporting the output. Outputs grounded exclusively in consolidated cognitive states carry a participation state component indicating full epistemic maturity. Outputs that traverse one or more absorbed but non-consolidated states carry a participation state component indicating established but not yet committed epistemic grounding. Outputs that traverse one or more provisional states carry a participation state component indicating partial epistemic grounding with unresolved structural anomalies. Outputs that depend on corroborated but not absorbed cognitive states carry a participation state component indicating corroboration-supported grounding that has not yet achieved independent structural admissibility.

A coherence classification component reflects the phase regime classification of closed reasoning loops detected during traversal of the trajectory supporting the output. Outputs produced by trajectories classified entirely within the coherent regime carry a coherence classification component indicating full evidential consistency along the reasoning path. Outputs produced by trajectories that entered the drift regime but achieved corroboration carry a coherence classification component indicating corroborated evidential consistency, acknowledging that the primary trajectory exhibited phase drift but that an independent corroborating trajectory confirmed the conclusion. Outputs produced by trajectories that entered the drift regime without achieving corroboration carry a coherence classification component indicating unresolved evidential drift, and such outputs are presented with explicit qualification indicating the specific manifold regions where drift was detected.

A consolidation status component reflects whether the substrate regions traversed during reasoning include consolidated irreversible reservoirs, frontier regions undergoing active geometric restructuring, or contested regions where arbitration among multiple sources has not been fully resolved. Outputs grounded primarily in consolidated reservoir regions carry a consolidation status component indicating stable epistemically committed knowledge. Outputs that traverse significant frontier regions carry a consolidation status component indicating active knowledge integration in those areas. Outputs that depend on contested regions carry a consolidation status component indicating unresolved epistemic conflict in the underlying knowledge structure.

A source provenance component reflects the contributing reasoning sources whose candidate cognitive states participated in the reasoning trajectory, together with the participation states achieved by those candidates and any inter-source corroboration relationships established during arbitration. This component enables human operators to identify which contributing sources provided the evidential basis for specific aspects of the output and to assess the degree to which multiple independent sources corroborated the conclusions reached.

The trust grade components are presented to human operators and downstream processes in a format adapted to the interface and use context. In natural language interfaces, trust grade components may be expressed as structured qualifications appended to or embedded within the generated response, such as explicit acknowledgment that a conclusion is supported by consolidated knowledge, that a conclusion is epistemically plausible but not yet evidentially grounded in the substrate, or that a conclusion depends on a contested region where multiple sources are in conflict. In programmatic interfaces, trust grade components are exposed as structured metadata fields accompanying the generated output, enabling downstream processes to implement their own trust-conditional logic based on the structural epistemic properties of the output rather than on post-hoc confidence scores.

When the output generation and expression control subsystem determines that no epistemically admissible reasoning trajectory supports a response to a given input, the system does not generate a default response derived from inadmissible reasoning content. Instead, the system generates an epistemic insufficiency notification that communicates to the human operator the structural basis for the absence of an admissible response. The epistemic insufficiency notification is not an error message but a substantive epistemic communication that identifies the specific structural conditions preventing generation of an admissible response and provides the human operator with actionable information for resolving the insufficiency.

An epistemic insufficiency notification comprises several components. A gap identification component identifies the specific locations or regions of the persistent cognitive substrate that were targeted during reasoning but found to be epistemically inadmissible, flagged as degeneracy regions, assigned quarantined or suppressed participation states, or otherwise unavailable for admissible reasoning traversal. The gap identification component provides a structural characterization of the knowledge gap in terms that are meaningful relative to the human operator's query, indicating the specific evidential relationships or domain knowledge areas that are absent from or contradicted within the current substrate state. A constraint summary component describes the specific admissibility conditions that were not satisfied during reasoning, distinguishing among capacity violations that prevented insertion of candidate states, topological admissibility failures arising from reservoir boundaries, epistemic curvature violations indicating evidential inconsistency, and phase regime failures indicating accumulated drift beyond the coherent regime threshold. A resolution pathway component identifies the types of additional evidence, corroboration, or human input that would most efficiently resolve the identified epistemic insufficiency, based on the learning readiness field computed at the boundaries of relevant consolidated regions and the structural gradients of the persistent cognitive substrate in the vicinity of the identified gap. The resolution pathway component may identify specific questions the system would need answered, specific data sources that would provide relevant evidential grounding, or specific expert domains whose candidate cognitive states would be most likely to resolve the contested or absent substrate regions.

When an epistemic insufficiency notification is generated, the system may additionally present a partial response derived from the admissible prefix of the reasoning trajectory, if one exists, clearly distinguished from the withheld portion and accompanied by an explanation of the boundary at which admissibility conditions were no longer satisfied. The partial response and epistemic insufficiency notification together provide the human operator with the maximum information available from admissible reasoning while making the structural limitations of that reasoning transparent and actionable.

When a reasoning trajectory supporting a candidate response is classified in the drift regime during traversal monitoring and no independent corroborating trajectory satisfying coherent regime conditions can be identified within the current state of the persistent cognitive substrate, the system generates a corroboration request directed to the human operator, an upstream evidence source, or a contributing reasoning source. The corroboration request is a structured epistemic communication that identifies the specific conclusion requiring corroboration, the evidential gap in the substrate that prevents the system from independently generating a corroborating trajectory, and the characteristics that an independent corroborating trajectory would need to satisfy in order to support qualification of the candidate response.

A corroboration request comprises several components. A conclusion identification component describes the specific cognitive state or substrate region that the primary reasoning trajectory reached and that requires corroboration, expressed in terms meaningful relative to the human operator's original query. An evidential gap component identifies the high-curvature substrate region separating the evidential basis of the primary trajectory from consolidated knowledge, characterizing the gap in terms of the epistemic curvature magnitude, the domain knowledge areas involved, and the nature of the evidential relationships that are absent or underspecified. A corroboration criteria component specifies the structural conditions that an independent corroborating trajectory must satisfy: it must reach a cognitive state within the proximity threshold of the conclusion reached by the primary trajectory, it must maintain the accumulated path-dependent coherence quantity within the coherent regime threshold throughout its traversal, and it must traverse genuinely different epistemic territory from the primary trajectory in the sense of being non-deformable into the primary trajectory within the reservoir-stratified state space. The corroboration criteria component translates these structural conditions into terms meaningful to a human operator, such as identifying the types of evidence, independent analyses, or alternative reasoning approaches that would constitute valid corroboration from a structural epistemic standpoint. A suggested evidence component identifies specific evidence types, data sources, expert consultations, or reasoning approaches that the system's learning readiness field and structural gradient analysis suggest would most efficiently provide the evidential grounding needed to generate an independent corroborating trajectory.

When a human operator or upstream evidence source responds to a corroboration request by providing additional information, the system projects the new information as candidate cognitive states into the persistent cognitive substrate, evaluates the candidates for epistemic admissibility, and if admitted, attempts to construct an independent corroborating trajectory using the new cognitive states as waypoints. If a valid corroborating trajectory is identified, the system updates the coherence classification of the original trajectory to corroborated status and regenerates the output with an updated trust grade reflecting the achieved corroboration. If the new information does not support construction of a valid corroborating trajectory, the system updates the epistemic insufficiency notification with additional characterization of the remaining gap and may generate a further corroboration request identifying the residual evidential deficiency.

Beyond trust grading and epistemic insufficiency notifications, the system provides human operators with detailed traversal explanations that make the internal epistemic reasoning process transparent and auditable. A traversal explanation is a structured account of the reasoning trajectory underlying a generated output, describing the path taken through the persistent cognitive substrate, the epistemic conditions encountered at each significant location, and the governance decisions made by the three-layer admissibility architecture during the course of the reasoning process.

A traversal explanation comprises several components. A trajectory summary component describes the sequence of substrate regions traversed during reasoning, identifying consolidated reservoir regions that provided stable epistemic grounding, frontier regions where the reasoning engaged with active knowledge integration, and contested regions where arbitration among multiple sources was required. The trajectory summary component characterizes the overall epistemic quality of the reasoning path in terms of the participation states of traversed cognitive states and the coherence classifications of detected reasoning loops. A governance event log component records the specific governance decisions made by the admissibility architecture during traversal, including admission outcomes for candidate states encountered during reasoning, coherence failure conditions detected and the interventions applied in response, arbitration outcomes for co-located candidates from multiple sources, and any escalations to supervisory arbitration triggered during the reasoning process. The governance event log provides a complete audit trail of the epistemic governance applied during reasoning, enabling human operators to understand not only what conclusion was reached but what structural constraints shaped the path to that conclusion. A knowledge boundary component identifies the boundaries between consolidated knowledge regions and frontier or contested regions that were encountered during reasoning, characterizing these boundaries in terms of the epistemic curvature, barrier energy, and learning readiness field values that define the edges of established knowledge relevant to the query. The knowledge boundary component makes explicit to the human operator where the system's responses are grounded in stable consolidated knowledge and where they engage with knowledge that is still being integrated or that remains structurally contested.

Traversal explanations are generated at a level of detail adapted to the interface and the human operator's stated preferences. Concise traversal explanations summarize the overall epistemic quality of the reasoning path and identify the most significant governance events without enumerating every admission evaluation or phase monitoring step. Detailed traversal explanations provide a complete account of the governance event log and knowledge boundary structure for applications requiring full auditability, such as safety-critical decision support, regulatory compliance contexts, and scientific or legal reasoning applications where the epistemic provenance of conclusions must be documented. The level of explanation detail is configurable per deployment context and may be adjusted dynamically based on the trust grade of the output, with lower trust grades automatically triggering more detailed traversal explanations to ensure that human operators receive sufficient structural information to make informed decisions about outputs of uncertain epistemic quality.

When the system encounters epistemic conditions that exceed the resolution capacity of its automated governance architecture, it escalates to human oversight through a structured escalation protocol that preserves the full epistemic context of the unresolved situation and provides the human operator with the information and tools needed to make an informed governance decision. Escalation to human oversight is triggered by several conditions: when supervisory arbitration among heterogeneous sources fails to resolve epistemic inconsistency within an operational timeout, when accumulated contradiction evidence at a contested substrate region exceeds the revision threshold without resolution under geometric evolution, when a reasoning query targets substrate regions that the learning readiness field characterizes as requiring costly geometric restructuring beyond the system's autonomous capacity, or when an application context carries a human oversight requirement specifying that outputs above a certain epistemic risk threshold must receive human review before delivery.

An escalation to human oversight presents the human operator with a complete epistemic situation report comprising the original query or reasoning task, the epistemic insufficiency or unresolved conflict that triggered escalation, the traversal explanation for any partial reasoning completed before escalation, the participation states and trust grades of all candidate cognitive states relevant to the escalated situation, and a set of structured resolution options that the human operator may select to guide the system's subsequent behavior. Resolution options presented to the human operator may include providing additional evidence to resolve an identified epistemic gap, selecting among competing candidate cognitive states from different sources based on the human operator's domain knowledge, approving provisional acceptance of a drift-regime conclusion pending future corroboration, requesting that the system defer the query until additional evidence is available, or instructing the system to withhold output and document the unresolved epistemic situation for future review.

Human operator responses to escalation are projected into the persistent cognitive substrate as candidate cognitive states with a human-sourced provenance designation and are evaluated for epistemic admissibility through the same admission evaluation process applied to all candidate states. Human-sourced candidate states are not automatically assigned an absorbed participation state by virtue of their human origin; they are subject to the same structural admissibility checks as machine-generated candidates. This source-agnostic treatment of human-sourced input reflects the architectural principle that epistemic admissibility is a structural property of the persistent cognitive substrate rather than a property of the source of the candidate state. Where human input satisfies admissibility conditions, it contributes to the substrate on the same terms as machine-generated content. Where human input exhibits epistemic inconsistency with existing consolidated knowledge, the system applies the same quarantine and arbitration mechanisms applied to inconsistent machine-generated candidates, presenting the human operator with a characterization of the inconsistency and requesting clarification or additional evidence before proceeding.

In deployments implementing the expert foundry architecture, the human-in-the-loop escalation and trust presentation layer integrates with the hierarchical supervisory network to provide a coherent escalation pathway from automated domain-level governance through cross-domain coordination to human oversight. Domain-level epistemic insufficiencies that cannot be resolved within a single expert domain are escalated to the cross-domain coordinator, which evaluates whether the insufficiency can be resolved through consultation with other expert domains within the foundry. Cross-domain consultations that fail to resolve the insufficiency are escalated to the executive manifold supervisor, which applies meta-cognitive governance strategies including coordinated dreaming and second-order control pattern analysis to identify resolution pathways. Executive-level escalations that cannot be resolved autonomously are forwarded to the human oversight layer with a complete escalation history documenting the governance decisions made at each level of the supervisory hierarchy, the candidate cognitive states evaluated at each level, and the specific epistemic conditions that prevented autonomous resolution. This integrated escalation pathway ensures that human oversight is invoked with the maximum contextual information available from the automated governance architecture and that human oversight decisions are re-injected into the substrate at the appropriate level of the supervisory hierarchy for continued governance processing.

The trust presentation layer additionally supports proactive trust communication in which the system surfaces epistemic quality information to human operators without waiting for explicit queries about output confidence. In proactive trust communication mode, the system monitors the trust grades of outputs delivered during an ongoing interaction and alerts human operators when trust grade components fall below configurable thresholds, when the proportion of provisional or drift-regime outputs in a reasoning session exceeds a session-level epistemic quality threshold, or when the system detects that a line of reasoning is approaching substrate regions characterized by high epistemic curvature, low learning readiness, or persistent arbitration conflicts. Proactive trust communication enables human operators to engage with the epistemic governance layer of the system as an active partner in knowledge-intensive reasoning tasks rather than as a passive recipient of outputs whose epistemic quality must be independently assessed after the fact.

### Federated and Distributed Admissibility Propagation

The persistent cognitive substrate is designed to operate not only as a single-node reasoning architecture but as a distributed cognitive infrastructure in which multiple instances of the persistent cognitive substrate, each maintaining its own latent manifold geometry, thought cache, epistemic connection, and consolidated knowledge reservoirs, cooperate through a federated governance protocol that propagates admissibility decisions, constraint representations, and reservoir boundary information across nodes without requiring synchronization of full substrate state or exposure of node-local cognitive content. Federated admissibility propagation extends the epistemic governance architecture described herein from single-instance deployments to enterprise-scale, geographically distributed, and privacy-sensitive multi-party deployments while preserving the structural integrity of the admissibility governance framework at each participating node. The central design principle of federated admissibility propagation is asymmetric information sharing: nodes share the epistemic consequences of inadmissible reasoning—encoded as abstract constraint representations—and the structural boundaries of consolidated knowledge—encoded as reservoir boundary descriptors—without sharing the underlying cognitive states, reasoning trajectories, consolidated knowledge content, or manifold geometry that gave rise to those consequences and boundaries. This asymmetry enables the epistemic governance benefits of collective learning to propagate across the federation while preserving the privacy, security, and intellectual property boundaries that govern each node's local cognitive content.

Each node in a federated deployment maintains a fully independent persistent cognitive substrate comprising its own latent manifold, semantic metric, almost-complex structure, symplectic form, epistemic connection, graded participation state assignments, thought cache, and consolidated irreversible reservoirs. Node substrates are not required to share a common coordinate system, dimensionality, semantic metric calibration, or epistemic connection initialization. Each node's substrate evolves independently under its own projection events, evidence-driven updates, compression flow, and connection relaxation flow, reflecting the node's local experience, domain specialization, and accumulated knowledge. The independence of node substrates ensures that federated admissibility propagation does not impose a centralized geometry or common evidential framework on participating nodes and that nodes with different domain specializations, knowledge bases, and operational histories can participate in the federation without harmonizing their internal substrate representations.

Node substrates maintain local admissibility indices that record constraint representations received from other nodes in the federation alongside constraint representations generated locally from the node's own reasoning cycles. Local admissibility indices are stored as indexed abstract constraint records that influence admissibility evaluation at the receiving node without being incorporated into the node's latent manifold as geometric structures. The separation between locally generated constraint representations, which are derived from the node's own substrate geometry and projected into its local irreversible reservoirs through the non-invertible projection operation, and remotely received constraint representations, which arrive as abstract records through the federated propagation protocol, ensures that the structural integrity of the local substrate is not compromised by the incorporation of external admissibility signals. Remotely received constraint representations influence admissibility threshold comparisons and topological admissibility evaluations at the receiving node through a read-only query interface analogous to the asymmetric constraint feedback channel that governs local reservoir interactions, and do not modify the local substrate geometry or local reservoir contents directly.

The primary mechanism for federated admissibility propagation is the non-invertible constraint propagation protocol, through which constraint representations derived from epistemically inadmissible reasoning patterns identified at one node are transmitted to other nodes in the federation in a form that preserves their utility for admissibility governance while precluding reconstruction of the originating node's cognitive content. The non-invertible constraint propagation protocol operates in three stages: local constraint generation, privacy-preserving encoding, and federated transmission and integration.

In the local constraint generation stage, when the consolidation and irreversible suppression subsystem at a node projects a constraint representation into the node's local irreversible reservoir following detection of an epistemically inadmissible reasoning pattern, the system evaluates the constraint representation for federation relevance by assessing whether the inadmissible pattern is likely to manifest in other nodes'reasoning due to shared domain knowledge, common input distributions, or overlapping knowledge areas. Constraint representations assessed as federally relevant are forwarded to the federated propagation subsystem for encoding and transmission. Federation relevance assessment is based on the domain scope indicators and contextual scope identifiers included in the constraint representation by the constraint representation generator, and does not require examination of the underlying trajectory content that was discarded during the non-invertible projection operation.

In the privacy-preserving encoding stage, the federated propagation subsystem applies additional privacy-preserving transformations to the constraint representation before transmission to ensure that the transmitted artifact provides no information about the originating node's local substrate geometry, consolidated knowledge content, cognitive states, or reasoning trajectories beyond the abstract structural pattern characterizing the inadmissible reasoning class. Privacy-preserving encoding may employ differential privacy mechanisms that add calibrated noise to structural pattern descriptors while preserving their utility for pattern recognition at receiving nodes, secure multi-party computation techniques that enable receiving nodes to evaluate constraint consistency without the transmitting node revealing the full constraint representation, or homomorphic encoding that allows receiving nodes to perform admissibility threshold comparisons on encoded constraint representations without decoding the underlying content. The specific privacy-preserving encoding mechanism applied is configurable per deployment context and regulatory environment, with stronger privacy guarantees applied in deployments involving sensitive domains such as medical decision support, legal reasoning, or intelligence analysis.

In the federated transmission and integration stage, privacy-preserved constraint representations are transmitted to receiving nodes through secure communication channels implementing end-to-end encryption, authenticated node identity verification, and audit logging of all propagation events. Receiving nodes integrate received constraint representations into their local admissibility indices through the read-only constraint feedback interface, making the received constraint patterns available for admissibility threshold comparisons and topological admissibility evaluations without incorporating them into local substrate geometry. The integration process assigns each received constraint representation a source node identifier, a reception timestamp, a federation relevance score derived from semantic alignment between the constraint pattern and the receiving node's local substrate domains, and an initial influence weight that determines the degree to which the received constraint affects local admissibility threshold comparisons relative to locally generated constraints. The influence weight reflects a combination of the source node's federation reliability profile, the privacy-preserving encoding strength applied to the constraint, and the federation relevance score, and is updated over time based on observed concordance between received constraints and locally generated constraints at the receiving node.

In addition to propagating constraint representations encoding inadmissible reasoning patterns, federated admissibility propagation synchronizes reservoir boundary descriptors across nodes to enable topological admissibility evaluations at each node to reflect the consolidated knowledge boundaries established across the federation rather than only those established within the local substrate. Reservoir boundary synchronization transmits abstract geometric descriptors of consolidated reservoir boundaries without transmitting the interior content of consolidated regions, thereby enabling receiving nodes to avoid reasoning trajectories that would cross boundaries of consolidated knowledge established at other nodes while preserving the privacy of the consolidated knowledge itself.

A reservoir boundary descriptor is generated when a region of the local persistent cognitive substrate completes a consolidation transition and is committed to consolidated status within the local irreversible reservoirs. The reservoir boundary descriptor encodes the topological structure of the consolidated region's boundary in abstract terms derived from the barrier energy distribution, the phase flatness gradient at the boundary, and the learning readiness field values at boundary locations, without encoding the semantic content, cognitive states, or epistemic connection values of the consolidated region's interior. The reservoir boundary descriptor is expressed in a federation-compatible coordinate-free representation that does not depend on the originating node's local manifold coordinate system, enabling receiving nodes to incorporate the boundary descriptor into their local reservoir-stratified state space evaluations without requiring coordinate alignment between node substrates.

Receiving nodes incorporate received reservoir boundary descriptors into their local reservoir-stratified state space as abstract boundary objects that impose topological constraints on admissibility evaluations without constituting navigable regions of the local substrate. A trajectory that would cross the abstract boundary of a remotely consolidated region in the receiving node's reservoir-stratified state space is evaluated as topologically inadmissible in the same manner as a trajectory that would cross a locally consolidated reservoir boundary, preventing the receiving node from forming reasoning trajectories that would violate the structural integrity of consolidated knowledge established at other nodes in the federation. This cross-node topological admissibility enforcement implements a distributed knowledge coherence mechanism in which the collective consolidated knowledge of the federation shapes the topology of the admissible reasoning space at each individual node, without requiring any node to access or expose the content of its consolidated knowledge regions.

Reservoir boundary synchronization is performed on a schedule that balances the timeliness of boundary propagation against the communication overhead of synchronization operations. In deployments with high consolidation rates or rapidly evolving knowledge structures, boundary synchronization may operate on a near-real-time basis using event-triggered propagation in which consolidation transitions at any node immediately trigger transmission of the associated boundary descriptor to the federation. In deployments where consolidation rates are lower or communication bandwidth is constrained, boundary synchronization may operate on a periodic batch basis with configurable synchronization intervals. In deployments with strict privacy requirements, boundary synchronization may be restricted to subsets of the federation defined by trust relationships, domain agreements, or regulatory constraints, with boundary descriptors transmitted only to nodes authorized to receive them under applicable governance policies.

When a receiving node's local admissibility evaluations generate constraint representations that conflict with constraint representations received from other nodes in the federation—specifically when a reasoning pattern that has been locally consolidated as epistemically admissible is identified as inadmissible by a received constraint from another node, or conversely when a reasoning pattern that has been locally suppressed is identified as admissible by consolidated knowledge at another node—the system applies a federated conflict resolution protocol to reconcile the conflicting signals without compromising the structural integrity of either node's local substrate.

Federated constraint conflicts are classified into three categories based on the nature of the inconsistency. A provenance conflict arises when a reasoning pattern is admissible under one node's epistemic connection calibration but inadmissible under another's, reflecting differences in evidential grounding between nodes rather than a genuine contradiction in the underlying domain knowledge. A provenance conflict is resolved by examining the source provenance components of the conflicting constraints, identifying the evidential basis for each node's assessment, and adjusting the influence weights assigned to the conflicting constraints to reflect the relative evidential strength of the two assessments in the context of the receiving node's local domain. A topology conflict arises when a received reservoir boundary descriptor imposes a topological constraint that conflicts with a locally consolidated reservoir region, such that a trajectory admissible within the local reservoir-stratified state space would be inadmissible in a state space that also incorporated the remote boundary. A topology conflict is escalated to the supervisory arbitration layer for resolution, with both the local consolidation record and the remote boundary descriptor presented as inputs to the arbitration process. A calibration conflict arises when systematic differences in epistemic connection calibration between nodes cause a broad class of reasoning patterns to be evaluated differently across nodes, indicating a fundamental divergence in evidential standards rather than a specific constraint disagreement. A calibration conflict triggers a federated calibration review process in which the affected nodes exchange anonymized calibration statistics and adjust their epistemic connection initialization parameters to reduce systematic divergence without exposing local connection values or substrate content.

In deployments implementing the expert foundry architecture, federated admissibility propagation integrates with the hierarchical supervisory network and the federated memory coordinator to provide a coherent governance layer spanning multiple geographically distributed expert foundry installations. Each geographic deployment region maintains its own executive manifold supervisor, hierarchical supervisory network, and domain cluster architecture as described in the distributed deployment configuration of the expert foundry. Federated admissibility propagation extends this architecture by adding a cross-region admissibility governance layer that propagates constraint representations and reservoir boundary descriptors between regional deployments through the non-invertible constraint propagation protocol.

The cross-region admissibility governance layer is coordinated by a federation coordinator that maintains a registry of participating regional deployments, manages federation trust relationships and access control policies, orchestrates the privacy-preserving encoding and transmission of constraint representations and boundary descriptors between regions, and monitors federation health metrics including constraint propagation latency, boundary synchronization currency, conflict resolution rates, and influence weight distributions across the federation. The federation coordinator does not maintain a centralized substrate or centralized knowledge repository; its function is coordination of the propagation protocol rather than aggregation of cognitive content. Regional deployments remain operationally independent and continue to function under their local admissibility governance architecture if federation connectivity is interrupted, with federated constraints and boundary descriptors cached locally and applied from cache until connectivity is restored and synchronization can be performed.

Cross-region knowledge transfer in the expert foundry context is governed by the same federated admissibility propagation principles that govern single-domain federated deployments, with the additional constraint that knowledge transfer between expert domains across regional boundaries must satisfy both the cross-domain admissibility conditions described in the multi-model and multi-agent arbitration section and the federated propagation privacy requirements described herein. A candidate cognitive state proposed for transfer from an expert domain in one regional deployment to a corresponding or related expert domain in another regional deployment is evaluated for epistemic admissibility against the receiving domain's local substrate, encoded using the privacy-preserving encoding mechanisms of the federated propagation protocol, transmitted through the federation coordinator to the receiving regional deployment, and evaluated again for admissibility at the receiving domain before incorporation into the receiving domain's persistent cognitive substrate. This double-evaluation protocol ensures that cross-region knowledge transfer is governed by the epistemic standards of both the originating and receiving domains and that privacy boundaries between regional deployments are preserved throughout the transfer process.

Federated admissibility propagation supports a federated learning mode in which admissibility outcomes, suppression event statistics, coherence classification distributions, and consolidation success rates are aggregated across nodes to generate training signals and model update guidance that improve the epistemic reliability of contributing reasoning sources across the federation without requiring centralized access to node-local training data, cognitive content, or substrate geometry. In federated learning mode, each node computes local admissibility outcome statistics over a configurable aggregation window and transmits privacy-preserved summaries of these statistics to a federated learning coordinator. The federated learning coordinator aggregates the received statistics across nodes using secure aggregation protocols that prevent the coordinator from reconstructing individual node contributions, computes federation-wide admissibility performance metrics, and generates model update guidance reflecting the patterns of epistemic admissibility and inadmissibility observed across the federation. Model update guidance is transmitted back to participating nodes and applied as fine-tuning signals to contributing reasoning sources, cache-curation signals to local thought caches, and routing adjustment signals to local expert domain selection mechanisms.

The admissibility-guided federated learning mechanism implements a continuous improvement loop in which the collective epistemic governance experience of the federation is used to improve the epistemic reliability of each node's reasoning without requiring centralized data aggregation or exposure of node-local knowledge. Nodes that contribute consistently high-quality admissibility outcome statistics—reflecting high consolidation rates, low suppression frequencies, and high corroboration success rates—receive model update guidance that reinforces the reasoning patterns associated with their high epistemic performance. Nodes that exhibit systematic patterns of epistemic inadmissibility—reflected in high suppression rates, frequent drift regime classifications, or persistent arbitration conflicts—receive model update guidance that targets the specific reasoning patterns and source calibrations associated with their inadmissibility patterns, enabling targeted improvement without requiring diagnosis of the underlying knowledge deficiencies from outside the node. The federated learning mode thereby extends the lifecycle governance benefits of admissibility-guided training described in the training and post-training optimization section from single-node deployments to federation-scale deployments, creating a distributed epistemic improvement system in which collective admissibility governance experience continuously raises the epistemic floor of reasoning quality across all participating nodes.

Federated admissibility propagation is designed to operate within the privacy and regulatory constraints applicable to sensitive deployment contexts including medical decision support, legal and regulatory analysis, financial services, intelligence analysis, and other domains in which the content of cognitive reasoning processes is subject to confidentiality requirements, data protection regulations, or professional privilege protections. The privacy guarantees of the federated propagation protocol derive from the structural properties of the non-invertible projection operation and the privacy-preserving encoding mechanisms applied before transmission rather than from access control policies alone. Because the non-invertible projection operation discards reconstructable details of inadmissible reasoning trajectories before generating constraint representations, and because privacy-preserving encoding further transforms constraint representations before transmission, the federated propagation protocol provides a structural guarantee that transmitted artifacts do not contain recoverable information about node-local cognitive states, consolidated knowledge, or reasoning trajectories, independent of whether receiving nodes or intermediary communication infrastructure are trusted or untrusted. This structural privacy guarantee is computable and auditable: the information content of transmitted constraint representations can be bounded analytically using the properties of the non-invertible projection operation and the specific privacy-preserving encoding mechanism applied, enabling compliance documentation that quantifies the privacy protection provided rather than asserting it as a policy claim.

Regulatory compliance features of the federated propagation protocol include configurable data residency controls that restrict propagation of constraint representations and boundary descriptors to nodes located within specified geographic regions or jurisdictional boundaries, audit logging of all propagation events with tamper-evident records suitable for regulatory examination, configurable retention policies for received constraint representations and boundary descriptors that enable compliance with data minimization requirements, and node-level opt-out mechanisms that allow individual nodes to withdraw from specific federation relationships without disrupting their local admissibility governance operations. These compliance features are integrated into the federation coordinator's operational management capabilities and are configurable through the security module of the distributed deployment infrastructure described in the expert foundry enterprise deployment architecture.

### Training and Post-Training Optimization Using Admissibility Outcomes

The epistemic governance architecture described herein generates a continuous stream of structured admissibility signals as a byproduct of its normal operation. These signals—comprising admission outcomes, participation state assignments, traversal coherence classifications, suppression events, corroboration relationships, consolidation transitions, and arbitration results—collectively constitute a high-fidelity record of the epistemic quality of reasoning executed by the system across its operational lifetime. Unlike supervision signals derived from human annotation of model outputs, which are episodic, expensive to generate, and limited to surface-level correctness assessments, admissibility signals are generated automatically by the structural epistemic governance architecture at every reasoning cycle, reflect the geometric and topological properties of the persistent cognitive substrate rather than subjective human judgments, and provide detailed structural characterizations of the specific epistemic conditions under which reasoning succeeded or failed. The present system leverages these admissibility signals as a rich source of training, fine-tuning, cache-curation, routing, and dream-manager inputs that continuously improve the epistemic reliability of contributing reasoning sources, the organization of the persistent cognitive substrate, and the calibration of the epistemic governance architecture itself across the full lifecycle of system operation. This admissibility-guided optimization framework extends epistemic governance from an inference-time control layer into a lifecycle control system that improves system reliability not only within each reasoning cycle but across reasoning cycles through accumulated epistemic experience.

The admissibility signals generated by the epistemic governance architecture are organized into a structured taxonomy that reflects their origin within the three-layer governance pipeline and their utility for different categories of optimization. Understanding the taxonomy of admissibility signals is essential to understanding how they are applied as optimization inputs, because different signal types carry different information about the specific reasoning capabilities and knowledge structures that require improvement.

Admission outcome signals are generated by the epistemic admission control subsystem for each candidate cognitive state evaluated during a reasoning cycle. Admission outcome signals carry an outcome code comprising absorb, provisional, flag, defect, or veto, together with the specific admissibility check that determined the outcome, the metric values that triggered the outcome, and the substrate location targeted by the candidate state. Admission outcome signals with veto or defect outcomes identify specific candidate states and their associated source reasoning processes as generating epistemically problematic outputs at specific knowledge locations, providing fine-grained signal about which aspects of which reasoning sources require improvement and in which knowledge domains the improvements are needed.

Traversal coherence signals are generated by the holonomy and epistemic phase monitoring subsystem for each reasoning trajectory executed during a reasoning cycle. Traversal coherence signals carry a phase regime classification comprising coherent, drift, or inversion, together with the accumulated phase magnitude at classification, the substrate locations where significant phase accumulation occurred, the curvature decomposition at those locations distinguishing incomplete from contradictory epistemic strain, and the corroboration outcome if corroboration was attempted. Traversal coherence signals with drift or inversion classifications identify specific reasoning pathways and the substrate regions where evidential coherence was lost, providing structural information about which reasoning transitions are epistemically unreliable and which knowledge regions are insufficiently grounded to support coherent long-horizon reasoning.

Suppression event signals are generated by the consolidation and irreversible suppression subsystem when a trajectory or class of trajectories is determined to be epistemically inadmissible and its constraint representation is projected into an irreversible reservoir. Suppression event signals carry the canonical constraint identifier assigned during non-invertible projection, the violation type and severity indicators encoded in the constraint representation, the substrate regions associated with the suppressed trajectory class, and the source provenance of the candidate cognitive states that participated in the suppressed trajectory. Suppression event signals are the highest-value admissibility signals for training and fine-tuning purposes because they identify reasoning patterns that the structural epistemic governance architecture has definitively classified as inadmissible, providing strong negative supervision that is structurally grounded rather than heuristically assessed.

Consolidation transition signals are generated when a region of the persistent cognitive substrate completes a consolidation transition and is committed to consolidated irreversible reservoir status. Consolidation transition signals carry the substrate region identifier, the phase flatness and barrier energy metrics at consolidation, the participating reasoning sources whose candidate cognitive states contributed to the consolidated region, and the sequence of governance decisions across all three layers that collectively satisfied the consolidation gate conditions. Consolidation transition signals identify reasoning patterns and source contributions that the structural epistemic governance architecture has affirmatively validated as epistemically reliable, providing strong positive supervision grounded in the geometric stability conditions of the consolidated region.

Corroboration relationship signals are generated when the holonomy and epistemic phase monitoring subsystem identifies an independent corroborating trajectory that satisfies coherent regime conditions and non-deformability conditions relative to a primary drift-regime trajectory. Corroboration relationship signals carry the identifiers of both the primary and corroborating trajectories, the proximity distance between their terminal cognitive states, the phase regime classifications of both trajectories, and the homotopy class relationship between them. Corroboration relationship signals identify pairs of reasoning pathways that collectively provide epistemically grounded support for a conclusion that neither pathway could support independently, providing training signal about which combinations of reasoning approaches produce reliable epistemic grounding for contested knowledge areas.

Arbitration outcome signals are generated by the multi-source arbitration layer when candidate cognitive states from multiple heterogeneous reasoning sources are evaluated for mutual epistemic consistency. Arbitration outcome signals carry the identities and admission outcomes of all evaluated candidates, the consistency assessment result and the specific epistemic curvature components that drove it, the arbitration outcome code, and the composite admissibility scores of all participating candidates. Arbitration outcome signals with conflict or quarantine outcomes identify specific pairs or groups of reasoning sources that generate epistemically inconsistent outputs for specific knowledge areas, providing targeted signal for source calibration and routing adjustments.

Admissibility signals are applied as fine-tuning supervision to contributing reasoning sources (including large language models, domain-specific expert models, and multimodal inference engines) to improve the epistemic reliability of those sources'outputs as evaluated by the structural epistemic governance architecture. Fine-tuning using admissibility signals differs from conventional fine-tuning using human-annotated correctness labels in several important respects. Admissibility signals are generated automatically at scale without human annotation effort, enabling continuous fine-tuning from operational experience rather than episodic fine-tuning from curated datasets. Admissibility signals reflect structural geometric properties of the persistent cognitive substrate rather than surface-level output assessments, providing supervision that is sensitive to evidential grounding and reasoning coherence rather than only to output fluency or factual accuracy. Admissibility signals are specific about the substrate locations, reasoning transitions, and knowledge domains where epistemic failures occurred, enabling targeted fine-tuning that improves reasoning reliability in specific knowledge areas rather than applying undifferentiated supervision across all model parameters.

Fine-tuning from suppression event signals constructs negative training examples from the input-output pairs associated with suppressed trajectory classes, weighted by the severity indicators of the corresponding constraint representations and the epistemic curvature magnitudes at the suppressed substrate locations. Suppression-based negative examples are used to reduce the probability that contributing reasoning sources generate outputs that project candidate cognitive states into substrate regions associated with suppressed constraint patterns, effectively teaching the sources to avoid reasoning pathways that the epistemic governance architecture has structurally identified as inadmissible. The specificity of suppression event signals (which identify not only that an output was inadmissible but the specific violation type, substrate location, and structural basis for inadmissibility) enables fine-tuning to target the specific model behaviors responsible for epistemic failures rather than penalizing broad output categories.

Fine-tuning from consolidation transition signals constructs positive training examples from the input-output pairs associated with reasoning trajectories that contributed candidate cognitive states to successfully consolidated substrate regions, weighted by the barrier energy and phase flatness metrics of the consolidated region and the consolidation gate outcome that confirmed multi-layer admissibility. Consolidation-based positive examples are used to increase the probability that contributing reasoning sources generate outputs that project candidate cognitive states into substrate regions consistent with consolidated knowledge structures, effectively teaching the sources to produce outputs that the epistemic governance architecture structurally validates as epistemically reliable. The combination of suppression-based negative examples and consolidation-based positive examples implements a contrastive fine-tuning regime in which the epistemic governance architecture's structural classifications serve as the supervision signal, replacing or augmenting human annotation with geometrically grounded epistemic quality assessments.

Fine-tuning from traversal coherence signals targets the specific reasoning transitions where phase accumulation exceeded the coherent regime threshold, constructing training examples that penalize the intermediate reasoning steps associated with high phase accumulation and reward alternative reasoning paths that maintained coherent regime classification. Coherence-based fine-tuning is particularly valuable for improving long-horizon reasoning reliability because it provides supervision at the level of individual reasoning transitions rather than at the level of final outputs, enabling the model to learn which intermediate reasoning steps introduce evidential drift and which maintain evidential coherence across extended reasoning chains.

Fine-tuning from corroboration relationship signals constructs positive training examples from corroborating trajectory pairs, rewarding the reasoning approach represented by the corroborating trajectory relative to the drift-regime primary trajectory it corroborated. Corroboration-based fine-tuning teaches contributing reasoning sources to prefer reasoning pathways that maintain coherent regime phase classification over pathways that require corroboration, progressively reducing the proportion of drift-regime outputs that require corroboration by improving the baseline epistemic quality of source outputs in contested knowledge areas.

The thought cache maintained within the persistent cognitive substrate is continuously curated using admissibility signals to ensure that cached cognitive structures reflect the current epistemic governance state of the substrate and do not retain content that has been identified as epistemically inadmissible through operational experience. Cache curation using admissibility outcomes implements a principled, geometrically grounded cache management policy that extends the thermodynamic activation energy decay mechanism described in the persistent memory manager with admissibility-conditioned curation operations that accelerate the removal of epistemically compromised content and reinforce the retention of epistemically validated content.

Suppression-driven cache curation identifies cached cognitive structures located within a geodesic proximity threshold of substrate locations associated with suppression events and applies a suppression-conditioned activation energy reduction to those structures proportional to the epistemic curvature magnitude at the suppression location and the semantic similarity between the cached structure and the suppressed candidate state. Suppression-conditioned activation energy reductions accelerate the thermodynamic decay of epistemically proximate cached content, increasing the rate at which cached structures associated with suppressed reasoning patterns fall below the minimum activation energy threshold and are removed from the thought cache through the natural forgetting mechanism. This cache curation mechanism implements a form of epistemic contamination control in which a suppression event at a substrate location not only prevents the suppressed candidate from participating in future reasoning but also reduces the retrieval probability of semantically related cached content that may be associated with the same inadmissible reasoning pattern.

Consolidation-driven cache reinforcement identifies cached cognitive structures located within consolidated reservoir regions or within high learning-readiness boundary zones adjacent to consolidated regions and applies a consolidation-conditioned activation energy boost to those structures proportional to the barrier energy and phase flatness metrics of the surrounding consolidated region. Consolidation-conditioned activation energy boosts extend the retention lifetime of epistemically validated cached content, reducing the probability that consolidated knowledge structures are evicted from the thought cache through thermodynamic decay before they contribute to future reasoning cycles. This cache reinforcement mechanism implements a form of epistemic prioritization in which the thought cache naturally concentrates its retention capacity around epistemically mature consolidated knowledge, progressively organizing the cache around the stable knowledge structures of the substrate rather than around recency or access frequency alone.

Drift-driven cache recalibration identifies cached cognitive structures associated with reasoning trajectories that received drift regime classifications during traversal monitoring and applies a drift-conditioned participation state downgrade to those structures, demoting absorbed cached structures to provisional status when the associated traversal coherence signal indicates persistent drift patterns in the substrate regions traversed by those structures. Drift-conditioned participation state downgrades ensure that cached content associated with epistemically unreliable reasoning pathways is retrieved with appropriate qualification indicators and excluded from consolidation eligibility until the underlying drift patterns are resolved through substrate geometric evolution or additional evidential grounding.

Corroboration-driven cache organization applies corroboration relationship signals to restructure the indexing of the thought cache so that corroborating trajectory pairs are stored in geometric proximity within the cache index, increasing the probability that a drift-regime reasoning trajectory retrieves its corroborating counterpart from the cache in future reasoning cycles involving the same knowledge areas. This cache organization mechanism implements a structural memory for corroboration relationships that reduces the computational cost of corroboration evaluation in future cycles by making previously identified corroborating trajectories efficiently retrievable through cache proximity rather than requiring full corroboration search in every cycle.

Admissibility signals are provided as inputs to the dream manager to guide autonomous geometric reorganization of the persistent cognitive substrate during reduced-activity periods toward restructuring priorities identified by the epistemic governance architecture during active reasoning. Dream manager integration with admissibility outcomes extends the dream manager's reorganization agenda from purely geometric optimization objectives (e.g., curvature smoothing, bundle consolidation, and compression efficiency) to include epistemically motivated restructuring objectives derived from the patterns of admissibility success and failure observed during active reasoning cycles.

Suppression event signals provided to the dream manager identify substrate regions associated with persistent inadmissible reasoning patterns as high-priority targets for geometric restructuring. During dream cycles, the dream manager applies perturbation flow operations to suppressed substrate regions with amplitudes calibrated to the severity indicators of the associated constraint representations, testing whether alternative geometric configurations of those regions would reduce epistemic curvature and improve admissibility conditions for future candidate states targeting similar knowledge areas. Where perturbation flow discovers stable alternative configurations, the dream manager may apply curvature editing operations to restructure the suppressed regions, potentially creating conditions under which future candidate states targeting similar knowledge can achieve absorbed rather than suppressed participation states. This suppression-guided restructuring implements a form of epistemic healing in which the system autonomously attempts to address the structural substrate conditions that gave rise to inadmissible reasoning patterns, rather than merely suppressing their consequences.

Drift pattern signals provided to the dream manager identify substrate regions where traversal coherence monitoring has detected persistent phase accumulation as targets for connection relaxation prioritization. During dream cycles, the dream manager coordinates with the manifold evolution subsystem to apply accelerated connection relaxation flow to high-drift substrate regions, reducing epistemic curvature in those regions more rapidly than the background relaxation timescale would achieve. Accelerated connection relaxation in high-drift regions reduces the background epistemic curvature against which phase accumulation during traversal is measured, increasing the sensitivity of phase monitoring in those regions and progressively improving the coherent regime retention rate for reasoning trajectories that traverse them. Over successive dream cycles, drift-guided connection relaxation progressively stabilizes high-drift substrate regions, reducing the frequency of drift regime classifications and the corroboration burden on reasoning trajectories that traverse contested knowledge areas.

Consolidation precursor signals provided to the dream manager identify substrate regions approaching consolidation readiness (specifically regions exhibiting curvature decay rates, phase coherence variance reductions, barrier energy growth, and Nijenhuis tensor decay consistent with consolidation transition) as priorities for dream-phase geometric preparation. During dream cycles, the dream manager applies compression flow and bundle operation sequences to consolidation-candidate regions to accelerate the geometric conditions required for consolidation transition, including reducing structural compatibility residuals through Nijenhuis penalty minimization, strengthening barrier energy at emerging reservoir boundaries through curvature sharpening operations, and reorganizing thought bundles within candidate regions to improve internal phase coherence. Dream-phase geometric preparation of consolidation candidates reduces the time required for candidate regions to satisfy the consolidation gate conditions and increases the reliability of consolidation transitions when they occur by ensuring that the geometric preconditions are well-established before the consolidation gate is evaluated.

Corroboration gap signals provided to the dream manager identify substrate regions where corroboration search consistently fails to identify independent non-homotopic trajectories as targets for topological restructuring. During dream cycles, the dream manager's topological operation manager evaluates whether the reservoir-stratified state space in corroboration gap regions can be restructured to create additional homotopy classes, potentially enabling corroborating trajectories that traverse genuinely different epistemic territory through substrate regions that currently offer only homotopically equivalent paths. Where topological restructuring operations can create new corroboration pathways without destabilizing existing consolidated reservoir boundaries, the dream manager applies the restructuring and updates the barrier edge sets that govern topological admissibility evaluations, expanding the available corroboration space for future drift-regime trajectories in the affected knowledge areas.

Admissibility signals are applied as routing optimization signals that adjust the assignment of candidate cognitive states and reasoning queries to contributing reasoning sources, expert domains within the expert foundry architecture, and reasoning pathways within the persistent cognitive substrate, based on observed epistemic reliability patterns across operational history. Routing optimization using admissibility signals implements a closed-loop governance system in which the epistemic governance architecture continuously refines the routing decisions that determine which reasoning resources are engaged for which knowledge areas, progressively concentrating high-stakes reasoning tasks on sources and pathways that have demonstrated reliable epistemic performance as measured by the structural admissibility criteria of the persistent cognitive substrate.

Source routing optimization applies epistemic reliability profiles derived from per-source admissibility outcome statistics to adjust the probability that each contributing reasoning source is selected as the primary source for candidate cognitive states targeting specific knowledge areas. Sources that consistently achieve absorbed or consolidated participation states for candidate states targeting a knowledge area receive increased routing weight for that area, reflecting their demonstrated epistemic reliability in that domain. Sources that consistently generate quarantined or suppressed candidates for a knowledge area receive reduced routing weight for that area, with routing weight reductions proportional to the suppression frequency and severity of the associated constraint representations. Source routing weights are maintained separately per knowledge area rather than as global source reliability scores, enabling fine-grained routing optimization that routes each source to the knowledge areas where it has demonstrated the highest epistemic reliability while avoiding areas where it has demonstrated systematic inadmissibility patterns.

Expert domain routing optimization in the expert foundry architecture applies cross-domain admissibility outcome correlations to adjust the domain selection decisions of the query routing system and the cross-domain consultation decisions of the hierarchical supervisory network. When admissibility outcome statistics reveal that queries targeting a specific knowledge area consistently achieve higher composite admissibility scores when processed by a particular expert domain than when processed by alternative domains, the query routing system adjusts its domain centroid representations and similarity thresholds to increase the probability of routing similar queries to the higher-performing domain. When admissibility outcome statistics reveal that cross-domain consultations between specific domain pairs consistently produce corroboration relationships between their respective candidate states, the hierarchical supervisory network adjusts its inter-domain collaboration routing to preferentially engage those domain pairs for future queries in related knowledge areas, capitalizing on the demonstrated corroboration complementarity between the domains.

Pathway routing optimization within the persistent cognitive substrate applies traversal coherence signal distributions to adjust the geodesic trajectory computation preferences of the cognitive dynamics engine, biasing trajectory computation toward substrate pathways that have demonstrated coherent regime phase classification in historical traversals and away from pathways that have demonstrated persistent drift or inversion regime classifications. Pathway routing optimization is implemented through adjustments to the goal potential field and compression pressure field representations maintained by the goal manager and cognitive dynamics engine, increasing goal potential values along historically coherent pathways and increasing compression pressure along historically drift-prone pathways, thereby making coherent pathways the preferred geodesic routes through the substrate for future reasoning traversals covering similar knowledge areas.

Beyond optimizing contributing reasoning sources, thought cache organization, dream manager priorities, and routing decisions, admissibility signals are applied to optimize the calibration of the epistemic governance architecture's own parameters—specifically the threshold values, weighting factors, and scoring functions that govern admission evaluation, phase regime classification, consolidation gating, and output qualification. Calibration optimization using admissibility signals implements a meta-governance layer in which the epistemic governance architecture uses its own operational experience to improve its own sensitivity, specificity, and efficiency as an epistemic quality control system.

Admission threshold calibration uses the distribution of admission outcome signals across reasoning cycles to evaluate whether current admission thresholds are appropriately calibrated for the system's operational context. When the admission outcome distribution shows a high proportion of veto outcomes concentrated in specific substrate regions or source types, threshold calibration analysis evaluates whether the veto rate reflects genuine epistemic inadmissibility or over-restrictive threshold settings that are excluding epistemically legitimate content. When the admission outcome distribution shows a high proportion of absorb outcomes followed by subsequent drift or suppression events, threshold calibration analysis identifies threshold settings that are admitting epistemically questionable content that would have been better quarantined or flagged. Threshold calibration adjustments are applied conservatively, with changes bounded by stability constraints that prevent threshold drift from destabilizing the established admissibility governance behavior, and are validated against held-out admissibility outcome data before deployment.

Phase regime threshold calibration uses the distribution of traversal coherence signals, corroboration outcomes, and downstream consolidation success rates to evaluate whether the phase drift threshold that separates coherent from drift regime classifications and the inversion threshold that separates drift from inversion regime classifications are appropriately set for the substrate's current epistemic curvature background. As the connection relaxation flow reduces background epistemic curvature across the substrate over time, phase accumulation rates along typical reasoning trajectories decrease, potentially warranting downward adjustment of phase regime thresholds to maintain consistent classification sensitivity. Phase regime threshold calibration adjustments are computed from rolling statistics of phase accumulation distributions across recent traversal coherence signals and applied as slow-timescale parameter updates that track the gradual epistemic maturation of the substrate geometry.

Consolidation threshold calibration uses consolidation transition signals and post-consolidation stability metrics to evaluate whether the flatness threshold and barrier energy threshold that govern consolidation gate conditions are appropriately set for the current substrate state. When post-consolidation stability metrics reveal that recently consolidated regions are experiencing revision events at rates above a revision frequency threshold, consolidation threshold calibration analysis identifies whether the revision rate reflects overly permissive consolidation thresholds that are committing insufficiently mature regions to consolidated status. When consolidation rates fall persistently below an expected rate despite the presence of substrate regions exhibiting strong consolidation precursor signals, consolidation threshold calibration analysis identifies whether overly restrictive thresholds are delaying consolidation of well-supported knowledge structures. Consolidation threshold adjustments are applied with particular conservatism given the irreversible nature of consolidation transitions and the hysteretic resistance of consolidated regions to modification, with adjustments validated against multiple cycles of consolidation precursor and consolidation transition data before deployment.

The admissibility-guided optimization framework described in this section implements a lifecycle governance architecture in which the epistemic quality of the system's reasoning improves continuously through operational experience without requiring periodic manual retraining, dataset curation, or threshold adjustment by human engineers. The key mechanisms of this continuous improvement are the closed-loop connections between the epistemic governance architecture's operational signals and the optimization processes that consume them: fine-tuning processes that improve source reliability, cache curation processes that improve substrate organization, dream manager processes that improve substrate geometry, routing processes that improve resource allocation, and calibration processes that improve governance sensitivity. Each of these optimization processes operates on a timescale appropriate to its scope and impact, from rapid cache curation adjustments that take effect within a single reasoning session to slow calibration optimizations that accumulate across weeks of operational experience.

The progress of lifecycle governance is tracked through an epistemic maturation profile that aggregates admissibility outcome statistics, consolidation rate metrics, suppression frequency trends, corroboration success rates, and calibration stability indicators into a composite characterization of the system's current epistemic reliability level and the trajectory of its improvement over time. The epistemic maturation profile is maintained by the statistical observables monitoring system and is made available to the human oversight layer as a system-level trust indicator that reflects not only the epistemic quality of individual outputs but the overall epistemic health and development trajectory of the persistent cognitive substrate and its associated reasoning ecosystem. As the system accumulates operational experience and the admissibility-guided optimization processes take effect, the epistemic maturation profile is expected to exhibit the sublinear scaling behavior described in the manifold evolution section: initially rapid improvement as the most significant sources of epistemic inadmissibility are identified and addressed through fine-tuning, cache curation, and geometric restructuring, followed by progressively slower improvement as the system approaches epistemic maturity and the remaining sources of inadmissibility become increasingly subtle and context-specific. The epistemic maturation profile thereby provides human operators and system administrators with a principled, structurally grounded indicator of the system's progress toward reliable long-horizon epistemic governance and a basis for informed decisions about deployment scope, oversight intensity, and continued optimization investment across the full operational lifetime of the persistent cognitive machine.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “admissibility boundary” refers to a structural boundary within a latent manifold that separates regions in which reasoning trajectories are permitted from regions in which such trajectories are restricted or disallowed based on epistemic constraints.

As used herein, “almost-complex structure” refers to a tensor field on a latent manifold that assigns to each tangent space a linear map whose square equals negative identity, thereby defining canonical invariant two-dimensional planes and restricting admissible deformations of the manifold.

As used herein, “almost-Kähler compatibility” refers to a compatibility condition among a semantic metric, an almost-complex structure, and a symplectic form on a latent manifold, wherein the symplectic form is derived from the semantic metric and the almost-complex structure and remains closed under exterior differentiation.

As used herein, “barrier energy” refers to a computed energy associated with a boundary of a consolidated region, derived from one or more geometric quantities including epistemic curvature magnitude, extrinsic boundary curvature, or variation of a symplectic form across the boundary, the barrier energy quantifying resistance of the region to perturbation.

As used herein, “belief mass” refers to an abstract measure of representational commitment or compression associated with a region of a latent manifold.

As used herein, “boundary defect” refers to a localized event recorded at or near a reservoir boundary when a projected cognitive state exhibits epistemic curvature or phase inconsistency relative to an interior of a consolidated region.

As used herein, “capacity constraint” refers to a structural limitation on an amount of cognitive state density, belief mass, or representational compression that may be introduced into a region of a latent manifold without violating intrinsic geometric or epistemic limits of that region.

As used herein, “cognitive state” refers to a representational configuration corresponding to a location within a latent manifold and representing a hypothesis, belief, interpretation, or intermediate reasoning result.

As used herein, “cognitive trajectory” refers to a sequence of cognitive states corresponding to a path through a latent manifold, the path representing execution of a reasoning process.

As used herein, “coherence failure condition” refers to a detected condition during traversal of a cognitive trajectory indicating loss of epistemic coherence, including phase drift beyond a threshold, a phase discontinuity, or conflict among path-dependent descriptors.

As used herein, “configuration space” refers to a space of admissible geometric configurations of a latent manifold including at least a semantic metric, an almost-complex structure, a symplectic form, and an epistemic connection, subject to compatibility constraints.

As used herein, “consolidation stability” refers to a condition in which a consolidated region resists perturbations in semantic metric, epistemic connection, or symplectic structure within quantifiable bounds determined by curvature flatness and barrier energy.

As used herein, “consolidation transition” refers to a geometric phase transition in which a region of a latent manifold satisfies a flatness condition on epistemic curvature, exceeds a barrier energy threshold, and becomes classified as an irreversible reservoir.

As used herein, “degeneracy region” refers to a region of a latent manifold characterized by structural instability or elevated epistemic curvature such that reasoning within that region is unreliable or disallowed.

As used herein, “discrete epistemic curvature” refers to a curvature value computed on a discrete cognitive graph as a sum of edge phase values around a closed boundary path or simplicial face.

As used herein, “epistemic admissibility” refers to a structural determination, evaluated prior to or during reasoning execution, of whether a proposed cognitive state or trajectory is permitted to exist or be executed within an epistemically conditioned latent manifold.

As used herein, “epistemic coherence” refers to preservation of justificatory or evidential consistency along a cognitive trajectory, as measured by a path-dependent coherence quantity associated with transitions in the latent manifold.

As used herein, “epistemic conditioning” refers to embedding within a latent manifold structural constraints that govern admissibility, coherence, and capacity of reasoning trajectories independently of semantic similarity alone.

As used herein, “epistemic connection” refers to a geometric structure defined on transitions between cognitive states that assigns transition-specific coherence values and gives rise to a computable epistemic curvature over closed paths.

As used herein, “epistemic curvature” refers to a quantity computed from an epistemic connection over a closed path or local neighborhood of a latent manifold that measures cumulative evidential rotation or inconsistency.

As used herein, “epistemic line bundle” refers to a bundle structure over a latent manifold in which each manifold location carries an associated evidential state and in which parallel transport along manifold trajectories preserves magnitude while permitting phase rotation.

As used herein, “epistemic phase” refers to an accumulated path-dependent coherence quantity obtained by combining transition-specific coherence values along a cognitive trajectory.

As used herein, “evidential consistency function” refers to a function that assigns a scalar consistency value between two cognitive states based on one or more of source agreement, cross-modal corroboration, or temporal stability, the value being used to assign epistemic connection phases.

As used herein, “first Chern number” refers to a topological invariant computed from epistemic curvature over a closed two-dimensional surface in the latent manifold, representing a quantized measure of total epistemic curvature enclosed by the surface.

As used herein, “geometric phase transition” refers to a qualitative change in geometric structure of a latent manifold region characterized by collapse of epistemic curvature and stabilization of boundary energy, resulting in irreversible consolidation.

As used herein, “Gromov non-squeezing constraint” refers to a symplectic rigidity principle preventing compression of a region of a latent manifold below its intrinsic symplectic capacity.

As used herein, “hallucination” refers to execution or expression of a cognitive trajectory that is epistemically inadmissible within a conditioned latent manifold, regardless of semantic plausibility or syntactic fluency.

As used herein, “hallucination regime error” refers to operation of a cognitive system within a region or structural class of a latent manifold that violates epistemic admissibility constraints, such that resulting reasoning appears coherent but lacks structural legitimacy.

As used herein, “holonomy descriptor” refers to a path-dependent representation associated with a location in a latent manifold that encodes experiential distinctions arising from different prior trajectories that converge at that location.

As used herein, “irreversible reservoir” refers to a non-navigable storage structure configured to retain abstract constraint representations derived from epistemically inadmissible reasoning patterns or consolidated knowledge, or a consolidated region of a latent manifold satisfying phase flatness and barrier energy conditions, wherein contents of the reservoir influence future cognition through asymmetric feedback and are not modifiable by active reasoning.

As used herein, “J-anti-invariant component” refers to a portion of epistemic curvature incompatible with an almost-complex structure and associated with contradictory evidence.

As used herein, “J-invariant component” refers to a portion of epistemic curvature compatible with an almost-complex structure and associated with incomplete but internally consistent evidence.

As used herein, “latent manifold” refers to a geometric representational substrate in which cognitive states correspond to locations and reasoning processes correspond to trajectories through the space, the manifold encoding at least semantic relationships and, in certain embodiments, epistemic conditioning information.

As used herein, “learning readiness field” refers to a scalar field defined on a boundary of a consolidated region that quantifies energetic cost of extending the region in a given direction based on variation of geometric structures.

As used herein, “micro-holonomy screening” refers to evaluation of epistemic phase over short, closed loops in a discrete cognitive graph to detect local epistemic inconsistencies during projection.

As used herein, “Nijenhuis tensor” refers to a tensor measuring failure of integrability of an almost-complex structure and serving as a measure of structural strain in regions undergoing geometric restructuring.

As used herein, “non-invertible projection” refers to an operation that maps a reasoning trajectory or class of trajectories to an abstract constraint representation while discarding reconstructable details of the original trajectory, such that the original trajectory cannot be regenerated from the projected representation.

As used herein, “path-dependent coherence quantity” refers to a value accumulated along transitions of a cognitive trajectory that reflects preservation or loss of epistemic grounding during traversal.

As used herein, “phase discontinuity” refers to a structural inconsistency detected during traversal of a cognitive trajectory indicating abrupt change in epistemic phase inconsistent with accumulated path-dependent descriptors.

As used herein, “phase flatness” refers to a condition in which epistemic curvature magnitude within a region remains below a flatness threshold, such that parallel transport of epistemic state within the region is approximately path-independent.

As used herein, “reasoning trajectory” refers to a cognitive trajectory computed by a cognitive system to evaluate, infer, or synthesize information within a latent manifold.

As used herein, “reservoir boundary” refers to a boundary of a consolidated irreversible reservoir that separates an interior region of epistemic flatness from an exterior region of higher curvature or instability and that may impose energetic or topological constraints on traversal.

As used herein, “reservoir-stratified state space” refers to a manifold region obtained by removing barrier neighborhoods associated with irreversible reservoirs, such that homotopy classes in the resulting space depend on consolidated knowledge content.

As used herein, “scaling vector” refers to a multi-component measure tracking semantic complexity, epistemic curvature budget, boundary energy distribution, and structural regularity of a latent manifold as cumulative experience increases.

As used herein, “semantic metric” refers to a geometric structure defined on a latent manifold that encodes semantic dissimilarity between cognitive states and determines geodesic distances and local neighborhood relationships.

As used herein, “symplectic capacity” refers to a quantity derived from a symplectic form on a latent manifold that defines an intrinsic volumetric or structural limit on admissible compression or accumulation of cognitive states within a region.

As used herein, “symplectic form” refers to a non-degenerate, closed bilinear form compatible with a semantic metric and an almost-complex structure that encodes structural capacity and area-like measures on a latent manifold.

As used herein, “symplectic rigidity” refers to geometric constraints imposed by a symplectic form that restrict allowable deformations and prevent reduction of intrinsic capacity of a region.

As used herein, “trajectory class” refers to a grouping of cognitive trajectories sharing a common structural pattern or admissibility characteristic, including trajectories mapped to a shared abstract constraint representation in an irreversible reservoir.

As used herein, “Wilson loop” refers to a discrete computation of epistemic phase around a closed loop in a cognitive graph obtained by multiplying or summing edge phase values assigned by an epistemic connection.

### Conceptual Architecture

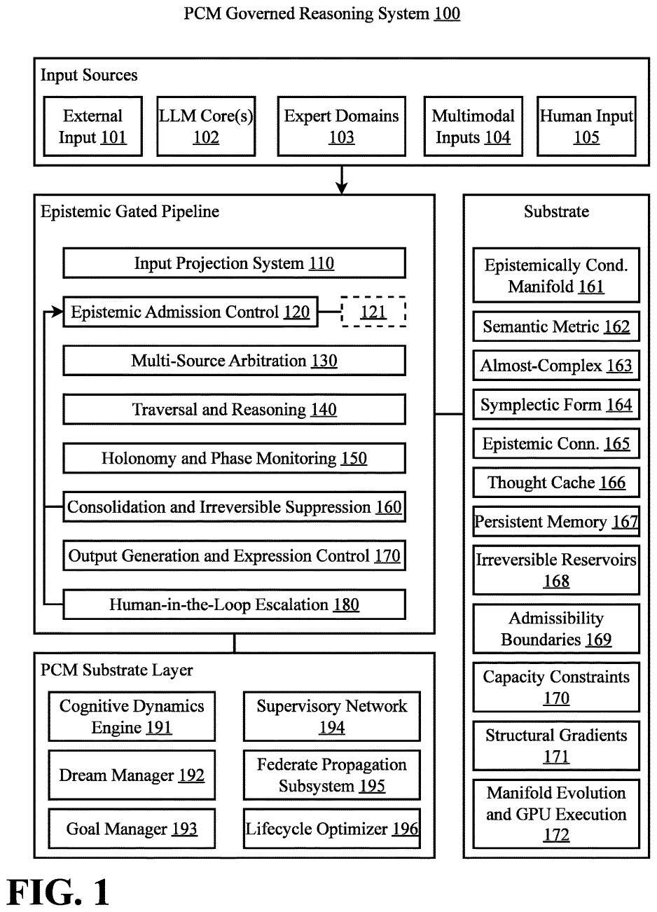

FIG. 1 is a block diagram illustrating an exemplary integrated architecture for a PCM governed reasoning system 100, according to an embodiment. The governed reasoning system 100 comprises a layered architecture organized around a central epistemic gated pipeline that enforces structural admissibility, traversal coherence monitoring, and irreversible suppression of inadmissible reasoning patterns across the full lifecycle of cognitive state insertion, reasoning execution, and output generation. The architecture integrates the persistent geometric cognition substrate and expert foundry coordination capabilities of the underlying PCM platform with the epistemic conditioning, admissibility governance, and output qualification mechanisms of the epistemic control framework, producing a unified system in which persistent reasoning is structurally governed rather than merely probabilistically guided.

An input source layer at the top of the architecture comprises a plurality of sources from which candidate cognitive states may be derived and projected into the persistent cognitive substrate. An external input source 101 receives natural language queries, structured data, commands, or other external representations directed to the system by users or upstream processes. One or more LLM cores 102 provide natural language processing and reasoning generation capabilities that contribute candidate cognitive states to the persistent cognitive substrate through their output representations. One or more expert domains 103 contribute domain-specific candidate cognitive states through the expert foundry architecture, each expert domain maintaining its own domain-specific manifold substrate and accumulated knowledge structures. A multimodal input source 104 aggregates heterogeneous sensory and data streams including visual, acoustic, sensor-derived, and other non-linguistic representations that may be encoded into candidate cognitive states for projection into the persistent cognitive substrate. A human input source 105 represents contributions from human operators, including corroboration responses, evidence submissions, escalation resolutions, and direct cognitive state contributions provided through the human-in-the-loop interface. Each of the input sources 101 through 105 contributes candidate cognitive states that enter the architecture through the epistemic gated pipeline rather than being incorporated directly into the persistent cognitive substrate, ensuring that all candidate content regardless of source is subject to the same structural epistemic governance.

The epistemic gated pipeline comprises an arranged sequence of subsystems through which candidate cognitive states and active reasoning trajectories pass in governed sequence. An input projection subsystem 110 receives candidate cognitive states from any of the input sources and maps each candidate state to a provisional location in the persistent cognitive substrate using semantic attachment to existing cognitive structures within the substrate. The provisional location is represented as a candidate insertion with associated geometric attributes and is not immediately incorporated into active reasoning structures, ensuring that all content undergoes epistemic evaluation before participating in reasoning execution.

An epistemic admission control subsystem 120 receives provisional projections from input projection subsystem 110 and evaluates the epistemic admissibility of each provisional location against one or more structural properties of the persistent cognitive substrate prior to permitting the provisional location to participate in active reasoning. Epistemic admission control subsystem 120 applies structural checks that may include evaluation of local capacity measures derived from the persistent cognitive substrate, assessment of admissibility boundary conditions at or near consolidated knowledge regions, evaluation of degeneracy indicators reflecting epistemic strain at the provisional location, and compatibility assessment against path-dependent descriptors maintained for the substrate. Based on these structural checks, epistemic admission control subsystem 120 assigns each candidate cognitive state to one of a plurality of graded participation states managed by a graded participation state controller 121, which governs the degree to which each candidate state may contribute to reasoning traversal, thought cache retrieval, and consolidation eligibility throughout its lifecycle in the substrate. Graded participation state controller 121 is illustrated as a dashed auxiliary block adjacent to epistemic admission control subsystem 120 to reflect that participation state management is an operationally distinct function that is coordinated with but not limited to the admission evaluation stage, with participation state transitions occurring throughout the pipeline in response to traversal coherence outcomes, evidence-driven substrate updates, and consolidation events.

A multi-source arbitration subsystem 130 receives candidate cognitive states that have been assigned absorbed or provisional participation states by epistemic admission control subsystem 120 and evaluates mutual epistemic consistency among co-located candidates derived from different input sources. Multi-source arbitration subsystem 130 can be configured to apply consistency evaluation using path-dependent descriptors and epistemic connection values maintained for the provisional locations, compute composite admissibility scores for competing candidates, and determine arbitration outcomes including synthesis, corroboration-pending assignment, quarantine assignment, and escalation to supervisory arbitration. Multi-source arbitration subsystem 130 ensures that heterogeneous reasoning sources are arbitrated under a common epistemic governance framework grounded in the structural properties of the persistent cognitive substrate rather than in source-specific confidence heuristics.

A traversal and reasoning subsystem 140 receives admitted cognitive states from multi-source arbitration subsystem 130 and computes reasoning trajectories through the persistent cognitive substrate subject to admissibility constraints, capacity conditions, and barrier boundary structures encoded in the substrate geometry. Traversal and reasoning subsystem 140implements cognitive trajectory computation including geodesic path computation through the substrate, goal-directed traversal under goal potential fields maintained by the PCM substrate layer, and thought cache retrieval of previously consolidated cognitive structures relevant to the current reasoning task. Traversal and reasoning subsystem 140 operates in bidirectional coordination with a holonomy and epistemic phase monitoring subsystem 150, exchanging trajectory events, phase regime classifications, and intervention signals during active reasoning execution.

Holonomy and epistemic phase monitoring subsystem 150 operates as a second layer of the epistemic governance architecture during reasoning traversal, accumulating a path-dependent coherence quantity along active trajectories using transition-specific coherence values assigned by the epistemic connection of the persistent cognitive substrate, and detecting coherence failure conditions comprising phase drift beyond a threshold, phase discontinuities, or conflicts among path-dependent descriptors applicable to traversed manifold locations. Upon detecting a coherence failure condition, holonomy and epistemic phase monitoring subsystem 150 intervenes in active reasoning by modifying traversal control structures of traversal and reasoning subsystem 140 to interrupt, redirect, backtrack, suspend, or mark the trajectory for subsequent irreversible suppression. Holonomy and epistemic phase monitoring subsystem 150 classifies detected closed reasoning loops into coherent, drift, and inversion phase regimes and evaluates corroboration conditions for drift-regime trajectories, forwarding phase regime classifications and curvature type decompositions to a consolidation and irreversible suppression subsystem 160.

Consolidation and irreversible suppression subsystem 160 operates as a third layer of the epistemic governance architecture and performs two complementary functions along parallel processing paths. Along a consolidation path, consolidation and irreversible suppression subsystem 160 evaluates candidate substrate regions approaching consolidation readiness against phase flatness, barrier energy, and capacity admissibility conditions, and gates irreversible commitment on the concurrent satisfaction of epistemic admissibility from epistemic admission control subsystem 120, epistemic coherence or corroboration from holonomy and epistemic phase monitoring subsystem 150, and capacity admissibility from the consolidation evaluation. Along a suppression path, consolidation and irreversible suppression subsystem 160 receives trajectories marked for suppression, generates abstract constraint representations characterizing structural reasons for inadmissibility, and projects those representations into irreversible reservoirs through a non-invertible operation that discards reconstructable trajectory details while preserving information sufficient to identify structurally similar inadmissible patterns in subsequent reasoning. Consolidation and irreversible suppression subsystem 160 provides asymmetric constraint feedback comprising constraint indices and barrier edge sets to epistemic admission control subsystem 120 through a cross-layer feedback path, enabling admission decisions in subsequent reasoning cycles to incorporate the accumulated pattern of previously identified inadmissible reasoning classes. This cross-layer feedback relationship is depicted in the figure as a dashed path running from consolidation and irreversible suppression subsystem 160 to epistemic admission control subsystem 120 along the right boundary of the gated pipeline, indicating a feedback relationship that influences but does not interrupt the primary forward data flow.

An output generation and expression control subsystem 170 receives admissibility status signals from consolidation and irreversible suppression subsystem 160, phase regime classifications from holonomy and epistemic phase monitoring subsystem 150, and trajectory endpoints from traversal and reasoning subsystem 140, and computes an output eligibility determination by evaluating a conjunction of stored status indicators reflecting epistemic admissibility through all three governance layers. When the output eligibility determination is affirmative, output generation and expression control subsystem 170 executes decoding operations that map admissible cognitive states and trajectory results into external representations comprising natural language responses, symbolic structures, or executable actions. When no epistemically admissible reasoning trajectory supports a response, output generation and expression control subsystem 170 suppresses, qualifies, or withholds the output, generating instead an epistemic insufficiency notification, a partial response derived from an admissible trajectory prefix, or a corroboration request, according to the specific admissibility conditions that prevented full output generation.

A human-in-the-loop escalation subsystem 180 receives escalation signals from output generation and expression control subsystem 170 when epistemic conditions exceed the resolution capacity of the automated governance architecture, and presents epistemic situation reports, trust grade indicators, traversal explanations, and structured resolution options to human operators or downstream oversight processes. Human-in-the-loop escalation subsystem 180 re-injects human operator responses into the gated pipeline as candidate cognitive states projected through input projection subsystem 110 and evaluated for epistemic admissibility through the same governance processes applied to all other candidate states. A corroboration and escalation feedback path depicted as a dashed path running along the left boundary of the gated pipeline from human-in-the-loop escalation subsystem 180 back to epistemic admission control subsystem 120 reflects the influence of escalation outcomes and human-sourced evidence on subsequent admissibility evaluations within the same reasoning session.

An epistemically conditioned manifold substrate panel illustrated along the right side of the gated pipeline provides current geometric state to each subsystem of the pipeline and receives updates from projection events, evidence-driven modifications, and geometric evolution flows. The substrate comprises an epistemically conditioned manifold 161, a semantic metric 162, an almost-complex structure 163, a symplectic form 164, an epistemic connection 165, a thought cache 166, a persistent memory manager 167, irreversible reservoirs 168, admissibility boundaries 169, capacity constraints 170, structural gradients 171, and a manifold evolution and GPU execution subsystem 172. The epistemically conditioned manifold 161 maintains the persistent geometric substrate on which all cognitive operations are represented, encoding semantic relationships between cognitive states together with epistemic conditioning information derived from the geometric structures maintained by the substrate panel components. Semantic metric 162 encodes semantic dissimilarity between cognitive states and governs geodesic distances within the manifold. Almost-complex structure 163 restricts admissible deformations of the manifold and enables decomposition of epistemic curvature into components reflecting incomplete and contradictory evidential strain. Symplectic form 164 encodes structural capacity constraints governing how many cognitive states may be accumulated in a manifold region. Epistemic connection 165 assigns transition-specific coherence values to transitions between cognitive states and gives rise to computable epistemic curvature values that are geometrically independent of semantic metric 162. Thought cache 166 maintains previously generated cognitive structures as compressed representations indexed within the persistent cognitive substrate and subject to admissibility-conditioned curation. Persistent memory manager 167 orchestrates long-term storage and retrieval of geometric structures across the substrate and implements thermodynamic activation energy tracking and decay mechanisms that govern the natural retention and forgetting of cached cognitive content. Irreversible reservoirs 168 maintain both consolidated knowledge regions of the epistemically conditioned manifold satisfying phase flatness and barrier energy conditions and projected constraint artifacts derived from inadmissible reasoning patterns through non-invertible projection operations. Admissibility boundaries 169 may be implemented through barrier energy computations at boundaries of consolidated reservoir regions and govern which transitions across boundary neighborhoods are permitted during reasoning traversal. Capacity constraints 170 can be enforced through symplectic capacity computations that limit accumulation of cognitive states in manifold regions below their intrinsic structural limits. Structural gradients 171 can be represented as a learning readiness field computed at reservoir boundaries that quantifies the energetic cost of extending consolidated regions in each boundary direction and channels future knowledge acquisition along symplectically favored directions. Manifold evolution and GPU execution subsystem 172 governs the coupled dynamics of all geometric structures of the substrate on separated timescales, applying a compression flow on an intermediate timescale and a connection relaxation flow on a slower timescale, and implementing geometric update operations on parallel processing resources to maintain real-time performance as cumulative experience increases. Horizontal dashed connector paths between the gated pipeline blocks and the substrate panel components indicate the bidirectional relationships through which each pipeline subsystem reads current geometric state from the substrate and contributes updates back to the substrate following each reasoning cycle.

A PCM substrate layer provides the foundational cognitive platform components upon which the epistemic gated pipeline operates. A cognitive dynamics engine 191 manages manifold geometry, geodesic computation, curvature calculation, and attention flow dynamics across the persistent cognitive substrate and provides the geometric processing capabilities that underlie traversal and reasoning subsystem 140. A dream manager 192 performs autonomous geometric reorganization of the persistent cognitive substrate during reduced-activity periods, implementing perturbation, recombination, and topological restructuring operations guided by admissibility outcome signals including suppression events, drift patterns, consolidation precursor indicators, and corroboration gap signals. A goal manager 193 creates and maintains goal potential fields over the persistent cognitive substrate that attract reasoning trajectories toward task-relevant regions and interact with epistemic governance constraints to produce goal-directed traversal that remains within epistemically admissible regions. A supervisory network 194 implements the hierarchical supervisory architecture of the expert foundry platform, providing cross-domain coordination, executive manifold supervision, quality assurance, and escalation management across multiple expert domains and deployment regions. A federated propagation subsystem 195 manages the propagation of non-invertible constraint representations and reservoir boundary descriptors across distributed nodes and geographic deployment regions through asymmetric propagation protocols that preserve epistemic governance benefits without exposing node-local cognitive content. A lifecycle optimizer 196 applies admissibility signals comprising admission outcomes, suppression events, traversal coherence classifications, and consolidation transitions as fine-tuning signals, cache-curation signals, routing signals, dream manager inputs, and governance threshold calibration inputs across the full operational lifetime of the system. A dashed connector path between the PCM substrate layer and the gated pipeline indicates the bidirectional dependency through which the pipeline operates upon the PCM substrate components and the substrate components are updated by the governance outcomes of the pipeline across successive reasoning cycles.

The interconnections among the input source layer, the epistemic gated pipeline, the epistemically conditioned manifold substrate panel, and the PCM substrate layer collectively implement a governed reasoning architecture in which every candidate cognitive state regardless of source passes through structural epistemic evaluation before participating in active reasoning, every active reasoning trajectory is monitored for coherence during execution, every inadmissible pattern is irreversibly projected into non-navigable reservoirs that condition future reasoning, and every output is conditioned on epistemic admissibility status maintained throughout the full governance pipeline. The architecture is not limited to any particular implementation of the individual subsystem components, and alternative arrangements in which components are combined, subdivided, or implemented through different computational mechanisms may be employed without departing from the scope of the governed reasoning architecture described herein.

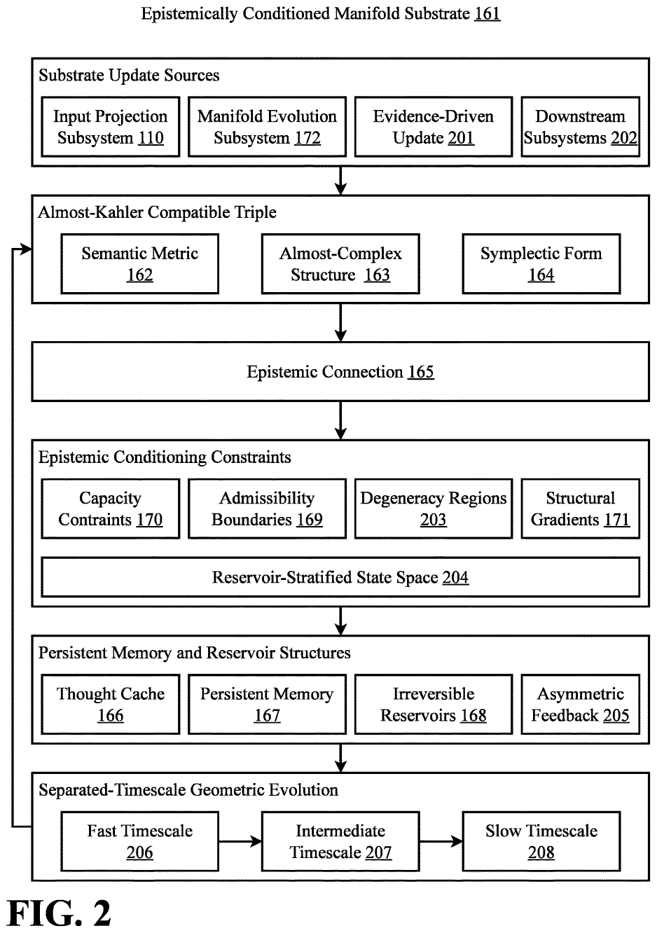

FIG. 2 is a block diagram illustrating an exemplary architecture of an epistemically conditioned manifold substrate 161, in an embodiment. The epistemically conditioned manifold substrate 161 maintains the persistent geometric data structures that collectively define the cognitive substrate upon which all reasoning operations of the governed reasoning system are performed, and provides current geometric state to each subsystem of the epistemic gated pipeline for use in admission evaluation, traversal monitoring, consolidation gating, topological stratification, and output conditioning. The epistemically conditioned manifold substrate 161 receives updates from three concurrent sources and exposes geometric state to downstream pipeline subsystems through a read-only geometric state interface, ensuring that the substrate evolves in response to accumulated experience while remaining structurally consistent across all pipeline interactions.

A substrate update source layer at the top of the architecture identifies the three sources through which geometric structures maintained by epistemically conditioned manifold substrate 161 are modified. An input projection subsystem 110 contributes new vertices, edges, and faces to the discrete cognitive graph together with interpolated almost-complex structure assignments and edge phase values arising from projection events, perturbing local substrate geometry on a fast timescale following each admission of a new candidate cognitive state. A manifold evolution subsystem 172 applies compression flow updates to the semantic metric and almost-complex structure and connection relaxation flow updates to the epistemic connection on intermediate and slow timescales respectively, governing the coupled long-term evolution of all geometric structures of the substrate in response to accumulated experience. Evidence-driven updates 201 contribute modifications to individual edge phase values of the epistemic connection when new evidence alters the evidential consistency between connected cognitive states, operating concurrently with the timescale flows of manifold evolution subsystem 172 and independently of projection events from input projection subsystem 110. Downstream subsystems 202 represents the read relationship through which pipeline subsystems including epistemic admission control subsystem 120, traversal and reasoning subsystem 140, holonomy and epistemic phase monitoring subsystem 150, consolidation and irreversible suppression subsystem 160, and output generation and expression control subsystem 170 query current geometric state from epistemically conditioned manifold substrate 161 for use in admission evaluation, traversal biasing, consolidation gating, and output conditioning operations.

An almost-Kähler compatible triple layer comprises three geometric structures that together define the foundational representational and capacity-constraining properties of the epistemically conditioned manifold. A semantic metric 162 is represented by positive edge weights stored for edges of the discrete cognitive graph, encoding semantic dissimilarity between cognitive states represented as vertices and governing geodesic distances and local neighborhood relationships within the substrate. Semantic metric 162 provides the distance structure against which admission evaluation, traversal routing, and thought cache retrieval operations measure proximity and similarity among cognitive states. An almost-complex structure 163 is represented per vertex by a linear map on an approximate tangent space satisfying a squared-equals-negative-identity constraint, restricting admissible deformations of the manifold to deformations that preserve both semantic metric 162 and almost-complex structure 163 within computational tolerance. Almost-complex structure 163 additionally induces a decomposition of epistemic curvature at any local neighborhood into a component compatible with the almost-complex structure representing epistemic strain arising from incomplete but self-consistent evidence and a component incompatible with the almost-complex structure representing epistemic strain arising from contradictory evidence, enabling classification of boundary events at consolidated regions and determination of whether detected epistemic strain is resolvable through accumulation of additional evidence or requires geometric restructuring. A symplectic form 164 is reconstructed from semantic metric 162 and almost-complex structure 163 according to a compatibility relation of the form ω(X, Y)=g(JX, Y) and satisfies a closedness condition enforced within computational tolerance through discrete face-sum consistency conditions maintained during update cycles. Symplectic form 164 provides the intrinsic capacity measure from which local symplectic capacities are computed during admission evaluation, governing how many cognitive states may be accumulated in a manifold region without violating structural capacity limits. Semantic metric 162, almost-complex structure 163, and symplectic form 164 together constitute an almost-Kähler compatible triple maintained by the substrate, with a J-Hermitian compatibility condition g(JX, JY)=g(X, Y) enforced during metric updates by projecting updates onto a subspace satisfying the compatibility constraint. The three components of the almost-Kähler compatible triple collectively feed into the epistemic conditioning structures of the substrate through their influence on capacity computations, barrier energy calculations, structural compatibility residual evaluations, and Nijenhuis tensor magnitude measurements that inform admission control, traversal monitoring, and consolidation gating operations.

An epistemic connection 165 is implemented as a U(1) connection on an epistemic line bundle over the manifold, assigning to each oriented edge of the discrete cognitive graph a stored phase value encoding evidential consistency along that transition. Discrete epistemic curvature values are computed on simplicial faces of the cognitive graph as oriented sums of edge phase values around each face. Epistemic connection 165 is geometrically independent of semantic metric 162 such that two regions of the manifold having identical structure under semantic metric 162 may exhibit different epistemic curvature values computed from epistemic connection 165, reflecting different levels of evidential support for cognitive states residing in those regions. This geometric independence is a structural property of the substrate that enables the epistemic governance architecture to distinguish between semantically similar but evidentially distinct cognitive content without requiring any modification to the semantic representational structure. Epistemic connection 165 is initialized from pairwise evidential consistency data among landmark cognitive states and evolves under three concurrent mechanisms: evidence-driven updates 201 that modify individual edge phases when new evidence alters evidential consistency between connected states, the connection relaxation flow of manifold evolution subsystem 172 that redistributes epistemic curvature toward equilibrium by minimizing total squared curvature energy, and projection impulses from input projection subsystem 110 that introduce new edge phases as new vertices are admitted to the manifold. Epistemic connection 165 additionally supports monitoring of discrete topological invariants comprising discrete first Chern numbers computed over representative closed surfaces embedded in the cognitive graph, providing global consistency checks on the geometric state of the substrate that constrain permissible evolution of epistemic connection 165 and reinforce stability of consolidated reservoir regions at a topological level distinct from local curvature thresholds.

An epistemic conditioning constraints layer derives four categories of computationally enforced constraint from the geometric structures of the almost-Kähler compatible triple and epistemic connection 165, collectively governing which cognitive operations may occur in which regions of the substrate. Capacity constraints 170 are enforced by computing a local symplectic capacity from symplectic form 164 at each manifold location and deriving a capacity density as a ratio of local cognitive state count to computed symplectic capacity, with further insertion into a region inhibited when the capacity density exceeds a stored threshold. In consolidated regions, compression routines are constrained so as not to reduce symplectic capacity below previously established levels, implementing a discrete analogue of a non-squeezing constraint through threshold enforcement. Admissibility boundaries 169 are implemented by computing reservoir barrier energy at boundaries of consolidated regions, where barrier energy integrates contributions from epistemic curvature magnitude derived from epistemic connection 165, extrinsic boundary curvature derived from semantic metric 162, and symplectic normal variation derived from symplectic form 164. Stored barrier energy values are compared against thresholds to determine whether transitions across boundary neighborhoods are permitted, thereby enforcing admissibility boundaries in discrete traversal routines and topological admissibility evaluations performed by the admission control layer. Degeneracy regions 203 are identified when discrete epistemic curvature magnitude computed from epistemic connection 165 exceeds a curvature threshold indicating structural inconsistency or evidential strain, with regions exceeding the threshold marked in memory and consulted by traversal and consolidation routines to inhibit reasoning operations or consolidation within those regions. Structural gradients 171 are computed as a learning readiness field defined on reservoir boundaries, calculated from variation of almost-complex structure 163, symplectic form 164, and epistemic connection 165 in boundary neighborhoods and quantifying the energetic cost of extending a consolidated region in each boundary direction. Traversal and consolidation routines consult stored readiness values to bias growth and reasoning toward directions exhibiting lower computed extension cost, implementing structural gradients as operational guidance that channels future knowledge acquisition along symplectically favored directions from consolidated knowledge boundaries.

The four epistemic conditioning constraint categories together define a reservoir-stratified state space 204 obtained by removing barrier neighborhoods associated with consolidated irreversible reservoirs from the accessible manifold region. Reservoir-stratified state space 204 is depicted as a dashed full-width block beneath the conditioning constraints to indicate that it is a derived topological structure rather than a separately maintained data structure, computed from the stored barrier energy values and boundary indices of consolidated regions maintained in the substrate. Removing barrier neighborhoods from the accessible state space modifies the fundamental group of that space such that homotopy classes in the resulting topology become content-dependent, with trajectories that would be contractible in an unconditioned manifold potentially becoming non-contractible in reservoir-stratified state space 204 if they must circumnavigate consolidated reservoir boundaries. Topological admissibility evaluations performed by epistemic admission control subsystem 120 and corroboration non-deformability assessments performed by holonomy and epistemic phase monitoring subsystem 150 operate with respect to reservoir-stratified state space 204 rather than the unconditioned manifold, ensuring that admissibility determinations and corroboration validations reflect the accumulated consolidated knowledge structure of the substrate.

A persistent memory and reservoir structures layer maintains the long-term storage and retrieval infrastructure through which cognitive structures are preserved, organized, and made available for reuse across reasoning cycles. A thought cache 166 stores previously generated cognitive structures as compressed representations indexed within the persistent cognitive substrate, implementing a multi-tier storage architecture comprising a session cache maintaining recent cognitive structures with full structural fidelity, a long-term cache maintaining consolidated cognitive structures with compressed representations, and a constraint cache maintaining non-reconstructable constraint artifacts projected from epistemically inadmissible reasoning patterns. Retrieval from thought cache 166 is conditioned on the participation state of retrieved structures, with absorbed and consolidated structures eligible for full retrieval, provisional structures eligible for retrieval with qualification indicators, and quarantined and suppressed structures excluded from retrieval regardless of semantic similarity to current candidate states. A persistent memory manager 167 orchestrates long-term storage and retrieval of geometric structures across the substrate, maintaining activation energy values for each cached structure and implementing thermodynamic decay through which unused structures gradually lose activation energy and are removed from thought cache 166 when activation energy falls below a minimum threshold, creating a natural forgetting mechanism that preserves frequently accessed epistemically validated content while removing epistemically compromised or disused content. Persistent memory manager 167 additionally coordinates with manifold evolution subsystem 172 and the lifecycle optimizer to apply admissibility-conditioned curation operations that accelerate decay of structures associated with suppression events and reinforce retention of structures associated with consolidation transitions. Irreversible reservoirs 168 maintain two categories of content that converge from the consolidation and suppression processing paths of consolidation and irreversible suppression subsystem 160: consolidated knowledge regions constituting geometric reservoir regions of the manifold satisfying phase flatness, barrier energy, and admission control conditions and resisting modification under routine traversal operations absent satisfaction of revision criteria, and projected constraint artifacts constituting abstract constraint records derived from epistemically inadmissible trajectories through non-invertible projection operations and stored in non-navigable form that does not participate in active reasoning. An asymmetric feedback channel 205 exposes read-only access to constraint information stored in irreversible reservoirs 168 for use by epistemic admission control subsystem 120 and manifold evolution subsystem 172, propagating constraint feedback indices and barrier edge sets that enable progressive tightening of admission thresholds and expansion of barrier topology as consolidated reservoir structure matures. Asymmetric feedback channel 205 enforces the architectural principle that active reasoning does not modify reservoir contents through feedback, with all information flow through the channel being unidirectional from irreversible reservoirs 168 to the querying subsystems.

A separated-timescale geometric evolution layer at the bottom of the architecture governs the dynamics through which all geometric structures of epistemically conditioned manifold substrate 161 evolve in response to accumulated experience across three distinct timescales whose ordering reflects the structural principle that experience accumulation precedes geometric adjustment and geometric adjustment precedes epistemic consolidation. A fast timescale 206 corresponds to projection impulses generated by input projection subsystem 110 upon admission of each new candidate cognitive state, which locally perturb semantic metric 162 through addition of new edges and vertices, update almost-complex structure 163 through incorporation of interpolated structure assignments, and update epistemic connection 165 through incorporation of new edge phase values. Following each projection impulse, symplectic form 164 is reconstructed from updated semantic metric 162 and almost-complex structure 163 and discrete closedness conditions are re-verified. An intermediate timescale 207 corresponds to the compression flow applied by manifold evolution subsystem 172, which adjusts coordinates associated with semantic metric 162 and applies adjustments that reduce a Nijenhuis tensor norm associated with almost-complex structure 163 by minimizing an extended geometric energy subject to almost-Kähler compatibility constraints, driving stabilizing regions toward approximately Kähler-compatible configurations within computational tolerances. As a region's Nijenhuis tensor magnitude decays toward zero under the compression flow, the almost-complex structure in that region approaches integrability and the region becomes approximately Kähler rather than merely almost-Kähler, providing additional rigidity that reinforces consolidation stability and serves as a geometric correlate of epistemic maturity. A slow timescale 208 corresponds to the connection relaxation flow applied by manifold evolution subsystem 172, which reduces total squared discrete epistemic curvature of epistemic connection 165 through incremental phase updates using gradient descent on stored edge phase values. As the connection relaxation flow drives epistemic curvature toward zero within consolidated reservoir interiors, decreasing background epistemic curvature increases the sensitivity of phase drift detection performed by holonomy and epistemic phase monitoring subsystem 150 during active traversal, progressively improving the coherent regime retention rate of reasoning trajectories as the substrate matures. The timescale ordering τP«τC«τR between fast timescale 206, intermediate timescale 207, and slow timescale 208, reflecting that projection impulses occurring at each reasoning step are far more frequent than compression flow iterations and that compression flow iterations are more frequent than connection relaxation steps. A dashed feedback path along the left margin of the figure indicates the upward influence of the separated-timescale evolution flows on the geometric structures of the almost-Kähler compatible triple and epistemic connection 165, reflecting that updated geometric structures produced by the evolution flows are written back to the substrate data structures and consulted by all subsequent pipeline operations, thereby conditioning each reasoning cycle against the accumulated geometric experience of all prior cycles.

The architecture of epistemically conditioned manifold substrate 161 is not limited to any particular discretization scheme, dimensionality, or implementation of the individual geometric structures, and alternative representations in which the semantic metric, almost-complex structure, symplectic form, and epistemic connection are implemented through different computational data structures or approximation methods may be employed without departing from the scope of the epistemically conditioned manifold substrate described herein.

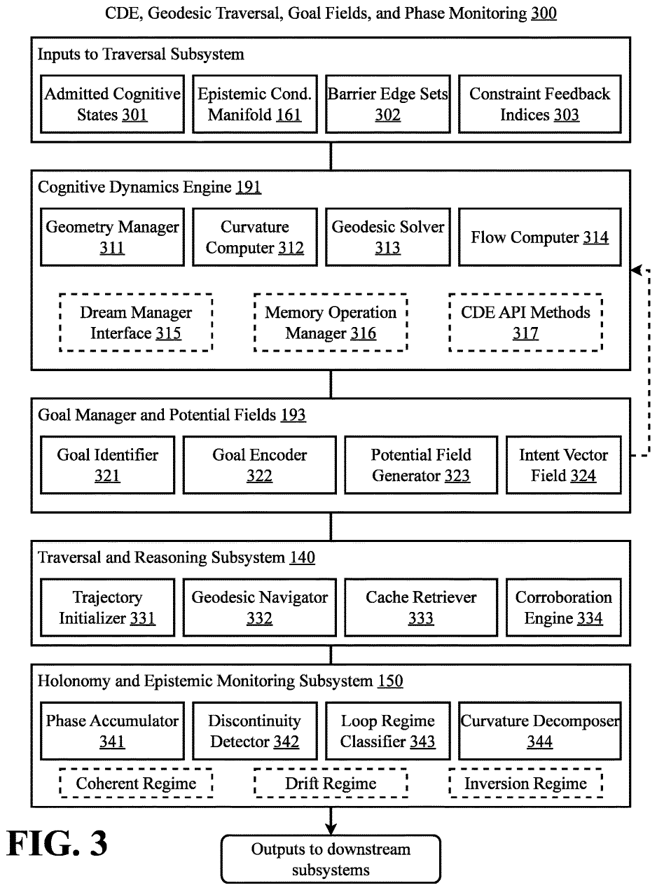

FIG. 3 is a block diagram illustrating an exemplary architecture of a CDE, geodesic traversal, goal field, and phase monitoring subsystem 300, in an embodiment. The subsystem 300 integrates the geometric processing capabilities of the cognitive dynamics engine, the intentional guidance capabilities of the goal manager, the trajectory computation capabilities of the traversal and reasoning subsystem, and the epistemic coherence monitoring capabilities of the holonomy and epistemic phase monitoring subsystem into a unified operational layer that governs how reasoning trajectories are computed, executed, and evaluated for epistemic coherence within the persistent cognitive substrate. The subsystem 300 receives admitted cognitive states and current geometric state from the epistemically conditioned manifold substrate and produces phase regime classifications, curvature decompositions, suppression flags, and trajectory endpoints for consumption by downstream pipeline subsystems.

An inputs layer at the top of the architecture identifies some exemplary sources from which subsystem 300 receives the information required to initialize and execute governed reasoning traversal. Admitted cognitive states 301 represent cognitive states that have been assigned absorbed or provisional participation states by the epistemic admission control subsystem and are forwarded to the traversal subsystem as initial states from which reasoning trajectories may be computed. Admitted cognitive states 301 carry their geometric assignments within the persistent cognitive substrate including provisional manifold location, associated edge phase values, structural compatibility residuals, and participation state indicators that govern their eligibility to participate in traversal, thought cache retrieval, and consolidation. The epistemically conditioned manifold 161 provides current geometric state comprising semantic metric, almost-complex structure, symplectic form, and epistemic connection values to all components of subsystem 300 for use in geodesic computation, goal field generation, phase accumulation, and curvature decomposition operations. Barrier edge sets 302 identify the boundary neighborhoods of consolidated irreversible reservoirs within the reservoir-stratified state space and are provided to the traversal subsystem to enforce topological admissibility constraints during geodesic navigation, preventing reasoning trajectories from crossing consolidated reservoir boundaries absent satisfaction of boundary-aware admission conditions. Constraint feedback indices 303 provide read-only access to canonical constraint identifiers stored in irreversible reservoirs and are consulted during traversal to identify edges and locations associated with previously suppressed homotopy classes, enabling the traversal subsystem to route reasoning trajectories away from substrate regions associated with structurally identified inadmissible reasoning patterns.

A cognitive dynamics engine 191 provides the foundational geometric processing capabilities that underlie all traversal, goal field, and phase monitoring operations performed within subsystem 300. The cognitive dynamics engine 191 operates as a specialized geometry processor that maintains and evolves the structure of the latent manifold, governing the fundamental geometric operations that enable persistent cognition. A geometry manager 311 continuously tracks and updates the metric tensor across all regions of the persistent cognitive substrate, maintaining the Riemannian connection that governs parallel transport of semantic vectors across the curved manifold and implementing algorithms for metric learning from trajectory data using transition frequencies, co-activation patterns, and semantic alignment to continuously refine the geometric structure of the substrate. Geometry manager 311 manages coordinate transformations between different local charts of the manifold and ensures smooth transitions as attention moves between semantic regions, providing the foundational distance and neighborhood structure upon which geodesic computation, goal field generation, and phase monitoring operations depend. A curvature computer 312 calculates the curvature tensors that characterize the local and global geometric properties of the manifold, deriving from the Riemann curvature tensor the Ricci tensor and Ricci scalar from which the compression pressure field is computed. Curvature computer 312 employs multiple estimation strategies to handle the computational complexity of curvature calculation in high dimensions, including geodesic deviation methods that track how nearby attention paths converge or diverge, Jacobian-based approximations using learned transition functions between manifold regions, and sampling techniques that estimate curvature from statistical properties of local trajectory bundles. The compression pressure field produced by curvature computer 312 encodes the cognitive effort required to traverse different regions of the manifold based on their semantic density and structural complexity, contributing to the cognitive action functional that geodesic solver 313 minimizes when computing optimal reasoning paths. A geodesic solver 313 computes optimal reasoning trajectories through the manifold by solving the variational problem of minimizing a cognitive action functional that balances kinetic energy penalizing rapid changes in attention, compression pressure derived from local semantic density that increases cost of traversal through highly compressed regions, and goal potential fields that provide attractive forces toward semantically relevant areas. Geodesic solver 313 implements numerical methods adapted for manifold computation including Riemannian gradient descent that respects the manifold's metric structure, shooting methods that propagate initial velocities forward while satisfying boundary conditions, and relaxation techniques that iteratively refine approximate paths toward true geodesics. Geodesic solver 313 additionally enforces barrier edge constraints derived from barrier edge sets 302 during path computation, ensuring that computed geodesic trajectories respect the topological admissibility constraints of the reservoir-stratified state space. A flow computer 314 models attention as a continuous vector field evolving over the manifold according to geometric dynamics, implementing the partial differential equation governing attentional flow as a cognitive fluid through shaped space. Flow computer 314 tracks how attention propagates through the manifold, maintaining flow pattern representations including laminar streams along well-established reasoning paths, bifurcations where attention divides between competing hypotheses, convergence zones where multiple reasoning lines reach similar conclusions, and divergence zones where exploratory behavior is encouraged. Flow computer 314 enables the system to maintain multiple concurrent attention streams that can subsequently merge or inform each other during complex reasoning tasks requiring parallel investigation of multiple hypothesis pathways.

Three dashed auxiliary blocks within the cognitive dynamics engine layer represent operational interfaces through which the core CDE components interact with other subsystems of the governed reasoning architecture. A dream manager interface 315 provides the connection between the cognitive dynamics engine and the dream manager, exposing methods for initiating perturbation flow operations, compression flow operations, and generalization flow operations during reduced-activity periods, and coordinating transitions between active cognition and dreaming states to ensure that ongoing reasoning processes reach stable states before autonomous geometric reorganization begins. A memory operation manager 316 orchestrates structural modifications to thought bundles and manifold topology based on cognitive activity and optimization criteria, implementing fan-in operations that consolidate loosely associated thoughts into tighter structures, fan-out operations that expand existing bundles into new semantic territory, and rebinding operations that integrate sufficiently similar bundles into higher-order structures. Memory operation manager 316 additionally handles subspace alignment for federated propagation scenarios, enabling knowledge transfer between distributed nodes while respecting privacy boundaries maintained by the federated propagation subsystem. A CDE application programming interface (API) methods block 317 provides a programmatic interface through which external modules and pipeline subsystems interact with the cognitive dynamics engine's geometric capabilities, exposing methods for geodesic path computation, manifold reinforcement along traversed paths, nearest thought bundle identification, dreaming initiation, compression pressure retrieval, and goal field construction. CDE API methods 317 handles request queuing, resource management, and error handling to ensure robust operation under varying computational loads and provides the standardized interface through which traversal and reasoning subsystem 140 and goal manager 193 coordinate their respective operations with the geometric substrate maintained by the cognitive dynamics engine.

A goal manager 193 translates abstract objectives, user queries, and system-level cognitive drives into continuous scalar fields over the persistent cognitive substrate that attract attention and guide reasoning trajectories toward semantically relevant regions. Goal manager 193 comprises four functional components arranged in a processing sequence from goal recognition through geometric field generation. A goal identifier 321 serves as the initial processing stage that recognizes, categorizes, and prioritizes goal sources entering the system from external queries, implicit user patterns derived from interaction history, internally generated system objectives, and task constraints imposed by operational requirements. Goal identifier 321 implements semantic parsing algorithms that identify nested goal hierarchies within complex queries, performs goal decomposition that breaks complex objectives into hierarchical subgoals pursuable in parallel or sequence, and maintains a goal registry that tracks active objectives, their priorities, interdependencies, and completion states. Goal identifier 321 additionally implements conflict detection mechanisms that identify when multiple active goals may be contradictory or competing for cognitive resources, flagging these conditions for special handling during goal field generation. A goal encoder 540 transforms identified goals from their representational form into geometric structures compatible with the manifold architecture, employing encoding strategies tailored to different goal types including similarity-based goals that create potential gradients attracting attention toward semantically similar regions, constraint-based goals that generate potential fields with barriers in prohibited regions, contrastive goals that create opposing gradients distinguishing required from excluded content, and composite goals that superimpose multiple potential patterns for multi-faceted objectives. A potential field generator 323 takes encoded goals and constructs complete scalar fields across the manifold, computing field values at each location by considering semantic distance from goal representations, alignment with goal constraints, historical success rates for similar goals in nearby regions, and interaction effects among multiple concurrent goals. Potential field generator 323 employs kernel methods to create smooth differentiable potential landscapes, implements field normalization to ensure potential values remain within reasonable ranges, generates time-varying fields for goals that evolve during reasoning, and creates nested potential structures for hierarchical goals where achieving subgoals produces local maxima within the broader landscape of the primary objective. An intent vector field 324 calculates the gradient vector field that determines the direction and magnitude of goal-induced forces at each location in the manifold, implementing efficient algorithms for computing gradients in curved space that account for the manifold's metric structure. Intent vector field 324 computes not only first-order gradients but also higher-order derivatives including the Hessian that identifies critical points such as maxima, minima, and saddle points in the goal potential landscape, maintains continuously updated gradient maps across frequently accessed regions, and computes divergence and curl statistics that provide insights into global flow patterns induced by current goal configurations. The intent vector field produced by intent vector field 324 is provided to geodesic solver 313 of the cognitive dynamics engine through a goal potential feedback path depicted on the right margin of the figure as a dashed path returning from the goal manager layer to the cognitive dynamics engine layer, reflecting the continuous influence of goal potential on geodesic computation during active reasoning.

A traversal and reasoning subsystem 140 receives admitted cognitive states 301 from the epistemic admission control subsystem and computes governed reasoning trajectories through the persistent cognitive substrate using geometric processing capabilities provided by cognitive dynamics engine 191 and goal potential guidance provided by goal manager 193. A trajectory initializer 331 creates traversal control structures for each admitted initial state, initializing a traversal stack, a visited-vertex hash table for loop detection, an accumulated phase variable for epistemic phase tracking, and a trajectory state record that maintains participation state indicators, suppression flags, and phase regime classifications across the duration of trajectory execution. Trajectory initializer 331 configures traversal operations to respect barrier edge constraints from barrier edge sets 302 and constraint homotopy class restrictions from constraint feedback indices 303 from the outset of trajectory execution, ensuring that topological admissibility constraints are enforced from the first traversal step rather than being evaluated only at trajectory completion. A geodesic navigator 332 executes barrier-constrained traversal through the persistent cognitive substrate using optimal paths computed by geodesic solver 313 of the cognitive dynamics engine, advancing the trajectory through successive manifold locations while consulting barrier edge sets 302 at each step to verify that proposed transitions do not cross consolidated reservoir boundaries without satisfying boundary-aware admission conditions. Geodesic navigator 332 implements backtracking capabilities that restore traversal to a previously recorded coherent vertex when the phase monitoring subsystem signals intervention, maintains alternative path queues that exclude edges associated with suppressed homotopy classes or degeneracy regions for use in redirection operations, and updates visited-vertex records to support loop detection by holonomy and epistemic phase monitoring subsystem 150. A cache retriever 333 implements admissibility-gated thought reuse by identifying cached cognitive structures within thought cache 166 whose semantic representations satisfy a similarity threshold relative to current traversal locations, evaluating the participation states of retrieved candidates before incorporating them into active reasoning, and excluding quarantined and suppressed cached structures from contributing to traversal regardless of semantic similarity. Cache retriever 333 thereby implements the principle that thought cache retrieval is not merely a semantic matching operation but an epistemically governed operation in which the participation state of retrieved content conditions its eligibility to influence active reasoning. A corroboration engine 334 implements independent path search for reasoning trajectories classified in the drift regime by holonomy and epistemic phase monitoring subsystem 150, computing candidate corroborating trajectories that reach cognitive states within a proximity threshold of the conclusion reached by the primary trajectory, maintaining accumulated epistemic phase within the coherent regime threshold, and traversing genuinely different epistemic territory from the primary trajectory as assessed by non-deformability within the reservoir-stratified state space. Corroboration engine 334 coordinates with geodesic navigator 332 to compute corroborating paths that avoid homotopic equivalence with primary trajectories, evaluates proximity conditions between corroborating and primary trajectory endpoints under semantic metric 162, and reports corroboration outcomes to holonomy and epistemic phase monitoring subsystem 150 for inclusion in phase regime classification decisions.

Traversal and reasoning subsystem 140 operates in continuous bidirectional coordination with holonomy and epistemic phase monitoring subsystem 150 during active reasoning execution, with trajectory events flowing from traversal and reasoning subsystem 140 to holonomy and epistemic phase monitoring subsystem 150 and intervention signals flowing in return from holonomy and epistemic phase monitoring subsystem 150 back to traversal and reasoning subsystem 140. This bidirectional coordination is depicted in the figure as paired connection paths between the two subsystem blocks, with trajectory events indicated on the left path and intervention signals indicated on the right path. A traversal intervention feedback path depicted as a dashed path running along the left margin of the figure from holonomy and epistemic phase monitoring subsystem 150 back up to traversal and reasoning subsystem 140 reflects the mechanism through which detected coherence failure conditions during phase monitoring cause immediate modification of traversal control structures within traversal and reasoning subsystem 140 during active reasoning execution, without waiting for trajectory completion.

A holonomy and epistemic phase monitoring subsystem 150 operates as the second layer of the epistemic governance architecture during reasoning traversal, accumulating a path-dependent epistemic phase quantity along active trajectories and detecting coherence failure conditions that indicate loss of epistemic grounding during reasoning execution. A phase accumulator 341 computes and updates a stored epistemic phase variable along each active trajectory by summing scalar phase values retrieved from epistemic connection 165 for each oriented edge traversed, the accumulated phase representing total evidential drift along the reasoning path from its initial state to its current location. Phase accumulator 341 maintains the accumulated phase variable in a trajectory state record accessible to other components of the phase monitoring subsystem and provides running phase values to loop regime classifier 343 upon detection of closed reasoning loops and to discontinuity detector 342 for comparison against gradient thresholds during open-path traversal. A discontinuity detector 342 monitors active trajectories for phase discontinuities and holonomy descriptor conflicts during open-path traversal before any loop closure event occurs, computing incremental phase gradients at each traversal step and comparing them against stored gradient thresholds, evaluating compatibility residuals between transported holonomy descriptors from different source paths that converge at a current traversal location, detecting traversal across edges associated with homotopy class identifiers previously marked as suppressed in constraint feedback indices 303, and identifying partial loop structures whose accumulated phase magnitude exceeds a bounded pre-closure threshold before loop completion. When a discontinuity metric exceeds its threshold or a holonomy conflict condition is detected, discontinuity detector 342 signals holonomy and epistemic phase monitoring subsystem 150 to modify traversal control structures of traversal and reasoning subsystem 140 without waiting for a full loop closure, treating detected phase instability as a hallucination precursor that warrants immediate intervention rather than deferred evaluation. A loop regime classifier 343 evaluates accumulated epistemic phase values for detected closed reasoning loops and classifies each loop into one of three phase regimes based on the magnitude of the accumulated phase relative to stored thresholds. A coherent regime classification is assigned when the magnitude of accumulated phase over the loop does not exceed the phase drift threshold, indicating that the reasoning loop maintained evidential coherence within tolerance and that consolidation of conclusions drawn along the loop is permitted. A drift regime classification is assigned when the magnitude of accumulated phase exceeds the phase drift threshold but remains below the inversion threshold, indicating that the loop accumulated significant epistemic drift and that consolidation is deferred pending corroboration by an independent path satisfying coherent regime conditions and non-deformability requirements within the reservoir-stratified state space. An inversion regime classification is assigned when the magnitude of accumulated phase equals or exceeds the inversion threshold, indicating that evidential grounding at the conclusion is misaligned with grounding at the trajectory origin beyond a structural inversion threshold, that consolidation is blocked, and that the trajectory is flagged for subsequent irreversible suppression through setting of a suppression flag in the trajectory state record. A curvature decomposer 344 computes a decomposition of discrete epistemic curvature values associated with faces traversed by the active trajectory into a component compatible with almost-complex structure 163 representing epistemic strain arising from incomplete but self-consistent evidence and a component incompatible with almost-complex structure 163 representing epistemic strain arising from contradictory evidence, computing a contradiction measure as a ratio of the magnitude of the incompatible component to the sum of magnitudes of both components. The curvature decomposition produced by curvature decomposer 344 is forwarded to consolidation and irreversible suppression subsystem 160 together with phase regime classifications from loop regime classifier 343 for use in boundary event classification, consolidation gating, and generation of abstract constraint representations for non-invertible projection.

Three dashed regime outcome blocks beneath loop regime classifier 343 characterize the operational consequences of each phase regime classification for subsequent consolidation and output generation operations. A coherent regime block indicates that the accumulated phase magnitude satisfies the coherent regime condition and that consolidation of conclusions reached along the trajectory is permitted subject to concurrent satisfaction of capacity admissibility conditions at the consolidation stage. A drift regime block indicates that the accumulated phase magnitude satisfies the drift regime condition and that consolidation is deferred pending corroboration evaluation by corroboration engine 334, with corroboration requiring an independent trajectory reaching a cognitive state within a proximity threshold of the primary conclusion, maintaining coherent regime phase classification throughout its traversal, and being non-deformable into the primary trajectory within the reservoir-stratified state space. An inversion regime block indicates that the accumulated phase magnitude satisfies the inversion regime condition, that consolidation is blocked, and that the suppression flag set in the trajectory state record initiates processing of the trajectory along the suppression path of consolidation and irreversible suppression subsystem 160.

An outputs layer at the bottom of the architecture identifies the four categories of information produced by subsystem 300 for consumption by downstream pipeline subsystems. Phase regime classifications produced by loop regime classifier 343 are forwarded to consolidation and irreversible suppression subsystem 160 for use in boundary event classification, consolidation gate evaluation, and suppression path processing. Curvature decompositions produced by curvature decomposer 344 are forwarded to consolidation and irreversible suppression subsystem 160 for use in boundary event classification distinguishing corroborating, novelty, contradiction, and ambiguous boundary events at consolidated reservoir regions. Suppression flags set in trajectory state records by loop regime classifier 343 upon inversion regime classification are forwarded to consolidation and irreversible suppression subsystem 160 to initiate generation of abstract constraint representations and non-invertible projection of inadmissible trajectory classes into irreversible reservoirs. Trajectory endpoints produced by traversal and reasoning subsystem 140 upon completion of admissible trajectories are forwarded to output generation and expression control subsystem 170 for use in computing output eligibility determinations and executing manifold-conditioned decoding operations that translate admissible cognitive states and trajectory results into external representations delivered to users or downstream processes.

The architecture of subsystem 300 is not limited to any particular implementation of the individual component blocks, and alternative arrangements in which the cognitive dynamics engine, goal manager, traversal subsystem, and phase monitoring subsystem are combined, subdivided, or implemented through different computational mechanisms may be employed without departing from the scope of the CDE, geodesic traversal, goal field, and phase monitoring architecture described herein.

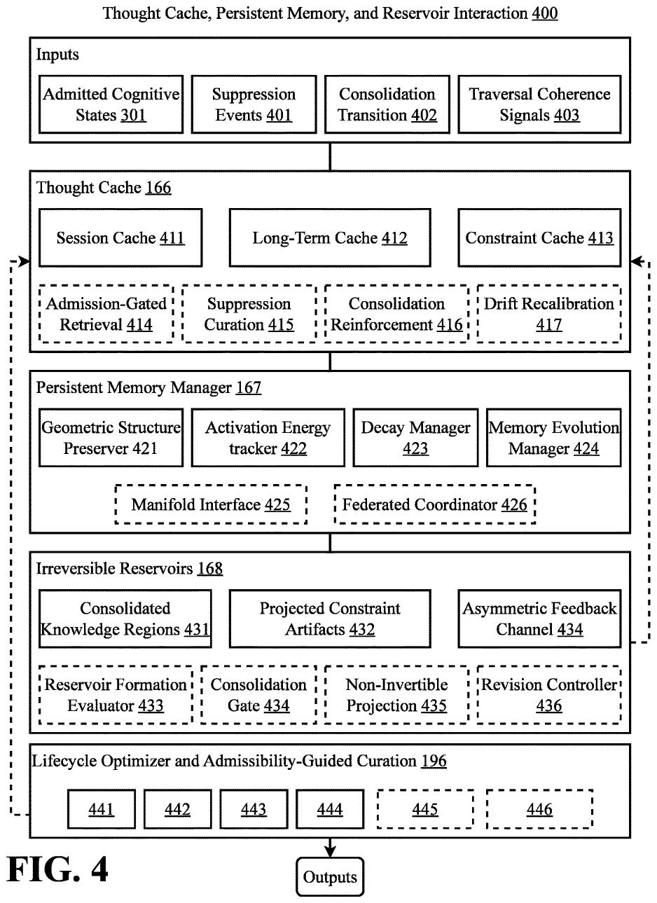

FIG. 4 is a block diagram illustrating an exemplary architecture of a thought cache, persistent memory, and reservoir interaction subsystem 400, according to an embodiment. The subsystem 400 integrates the multi-tier thought storage capabilities of the thought cache, the geometric structure preservation and thermodynamic memory management capabilities of the persistent memory manager, the consolidation and irreversible suppression capabilities of the irreversible reservoir infrastructure, and the admissibility-guided lifecycle optimization capabilities of the lifecycle optimizer into a unified memory governance architecture that manages the full lifecycle of cognitive content from initial admission through active reasoning participation, consolidation or suppression, and long-term epistemic maturation. The subsystem 400 receives admitted cognitive states, suppression events, consolidation transitions, and traversal coherence signals as inputs and produces admissibility feedback, consolidation status, and geometric update outputs for consumption by upstream and downstream pipeline subsystems.

An inputs layer at the top of the architecture identifies various exemplary categories of information that drive the memory governance operations of subsystem 400. Admitted cognitive states 301 represent cognitive states that have been assigned absorbed or provisional participation states by the epistemic admission control subsystem and are forwarded to the thought cache for storage, indexing, and future retrieval in support of active reasoning operations. Suppression events 401 represent the outcomes of irreversible suppression processing by the consolidation and irreversible suppression subsystem, identifying specific cognitive states, substrate locations, and trajectory classes that have been determined to be epistemically inadmissible and whose constraint representations have been projected into irreversible reservoirs through non-invertible operations. Suppression events 401 carry canonical constraint identifiers, violation type indicators, severity metrics, and substrate location references that are consumed by the thought cache curation operations and lifecycle optimizer components of subsystem 400 to implement admissibility-conditioned cache management and source performance signal generation. Consolidation transitions 402 represent the outcomes of successful consolidation gate evaluations by the consolidation and irreversible suppression subsystem, identifying substrate regions that have completed a consolidation transition and been committed to consolidated irreversible reservoir status satisfying phase flatness, barrier energy, and capacity admissibility conditions. Consolidation transitions 402 carry region identifiers, phase flatness metrics, barrier energy values, contributing source provenance records, and consolidation gate decision records that are consumed by the thought cache reinforcement operations, persistent memory manager, and lifecycle optimizer to implement epistemic maturation tracking and source reliability profile updates. Traversal coherence signals 403 represent the phase regime classifications, curvature decompositions, and corroboration outcomes produced by the holonomy and epistemic phase monitoring subsystem during active reasoning traversal, providing continuous information about the epistemic quality of reasoning trajectories that traversed specific substrate locations and cached cognitive structures. Traversal coherence signals 403 may be consumed by the drift recalibration operations of the thought cache curation layer and the dream manager input generation operations of the lifecycle optimizer to implement participation state downgrades for drift-associated cached content and to identify substrate regions requiring prioritized geometric reorganization during dream phases.

A thought cache 166 maintains previously generated cognitive structures as compressed representations indexed within the persistent cognitive substrate and implements admissibility-conditioned storage, retrieval, and curation operations that ensure cached content reflects the current epistemic governance state of the substrate. The thought cache 166 implements a multi-tier storage architecture comprising three cache tiers organized by structural fidelity and epistemic maturity. A session cache 411 maintains recent cognitive structures with full structural fidelity, preserving both the explicit reasoning chains and the geometric context including local curvature patterns, geodesic path associations, and epistemic connection values that characterized each structure at the time of its generation. Session cache 411 provides the highest-speed retrieval pathway for recently generated cognitive content and supports immediate thought reuse within active reasoning sessions without requiring re-projection from persistent storage. A long-term cache 412 maintains consolidated cognitive structures with compressed geometric representations that preserve essential semantic structure and reasoning patterns while reducing storage requirements through identification and removal of representational redundancy. Long-term cache 412 stores cognitive structures that have achieved absorbed or consolidated participation states and have demonstrated sufficient activation energy to merit long-term retention beyond the session boundary, providing persistent thought reuse capabilities that accumulate across extended system operation. A constraint cache 413 maintains non-reconstructable constraint artifacts derived from epistemically inadmissible reasoning patterns through non-invertible projection operations, storing canonical constraint identifiers and structural pattern descriptors that support identification of structurally similar inadmissible patterns in future reasoning without preserving reconstructable details of the original inadmissible trajectories or cognitive states. Retrieval from constraint cache 413 can be configured to be limited to read-only admissibility evaluation queries performed by the epistemic admission control subsystem and does not restore inadmissible cognitive structures to active reasoning participation under any circumstances.

Four dashed operational blocks within the thought cache layer implement the admissibility-conditioned management operations that maintain epistemic integrity of cached content throughout its lifecycle. An admissibility-gated retrieval block 414 implements the participation state evaluation that conditions thought cache retrieval on the current epistemic governance state of candidate cached structures, verifying that retrieved structures have not been assigned quarantined or suppressed participation states before incorporating them into active reasoning, and returning appropriate qualification indicators for retrieved structures assigned provisional participation states. Admissibility-gated retrieval block 414 ensures that semantic similarity alone is insufficient to retrieve cached content into active reasoning and that the epistemic governance state of each candidate structure is evaluated at each retrieval request against the current structural properties of the persistent cognitive substrate. A suppression curation block 415 receives suppression events 401 from the consolidation and irreversible suppression subsystem and applies suppression-conditioned activation energy reductions to cached cognitive structures located within a geodesic proximity threshold of suppressed substrate locations, reducing activation energy proportionally to the epistemic curvature magnitude associated with each suppression event and the semantic similarity between affected cached structures and the suppressed candidate state. Suppression curation block 415 implements the epistemic contamination control mechanism through which suppression events propagate outward from suppressed locations to reduce the retrieval probability of semantically related cached content associated with the same inadmissible reasoning pattern, without requiring explicit deletion of affected structures. A consolidation reinforcement block 416 receives consolidation transitions 402 and applies consolidation-conditioned activation energy boosts to cached cognitive structures located within consolidated reservoir regions or within high learning-readiness boundary zones adjacent to consolidated regions, extending the retention lifetime of epistemically validated cached content by increasing activation energy proportionally to the barrier energy and phase flatness metrics of the surrounding consolidated region. Consolidation reinforcement block 416 implements the epistemic prioritization mechanism through which the thought cache naturally concentrates its retention capacity around epistemically mature consolidated knowledge, progressively organizing cached content around the stable knowledge structures of the substrate rather than around recency or access frequency alone. A drift recalibration block 417 receives traversal coherence signals 403 and applies drift-conditioned participation state downgrades to cached cognitive structures associated with reasoning trajectories that received drift regime classifications during traversal monitoring, demoting absorbed cached structures to provisional status when associated coherence signals indicate persistent drift patterns in the substrate regions traversed by those structures, and ensuring that cached content associated with epistemically unreliable reasoning pathways is retrieved with appropriate qualification indicators.

A persistent memory manager 167 orchestrates long-term storage and retrieval of geometric structures across the persistent cognitive substrate, implementing a geometric-structure-aware memory architecture in which cognitive content is preserved not as isolated data points but as interconnected geometric structures with semantic relationships intact. A geometric structure preserver 421 maintains the fundamental geometric integrity of stored cognitive structures and their relationships within the thought cache, preserving thought bundles as compact submanifolds with their internal metric structure, boundary conditions, and topological relationships to neighboring bundles, and ensuring that not only the content but the geometric context of each stored structure is maintained including local curvature patterns indicating semantic density, geodesic paths connecting related concepts, and metric tensor values defining distances within thought neighborhoods. An activation energy tracker 422 implements a thermodynamic model of memory persistence by assigning and monitoring activation energy values for each cached cognitive structure, updating energy levels in response to direct retrieval for reasoning processing, traversal along geodesic paths that pass near the structure, participation in successful reasoning chains, and reinforcement through goal achievement, while applying thermodynamic decay to structures that remain unused so that activation energy dissipates over time according to the decay dynamics governed by decay manager 423. A decay manager 423 implements the natural forgetting mechanism through which cognitive structures whose activation energy falls below a minimum threshold are removed from the thought cache, executing pruning operations that gradually dissolve unwanted structures rather than creating abrupt deletions that could destabilize nearby manifold geometry, redistributing semantic content from decaying structures to related active structures, and performing defragmentation operations that consolidate sparse regions and tighten the overall manifold structure. Decay manager 423 additionally implements contextual decay modulation through which decay rates are adjusted based on the semantic uniqueness of a structure, its role in connecting otherwise disparate concepts, and its participation in rarely accessed but structurally important knowledge pathways, ensuring that foundational knowledge infrastructure decays more slowly than peripheral specific instances. A memory evolution manager 424 orchestrates the mechanisms through which persistent memory structures adapt and improve over time through reinforcement operations that strengthen frequently used cognitive structures by increasing local curvature around valuable structures and tightening geodesic connections between related concepts, compression operations that identify and merge redundant or highly similar structures into unified abstractions while preserving essential distinctions, abstraction operations that extract higher-level patterns from collections of specific instances, and forgetting operations coordinated with decay manager 423 that maintain cognitive efficiency through selective pruning while preserving essential knowledge structures.

Two dashed auxiliary blocks within the persistent memory manager layer represent operational interfaces through which persistent memory manager 167 interacts with the geometric substrate and the federated deployment infrastructure. A manifold interface 425 provides the bidirectional connection between persistent memory manager 167 and the epistemically conditioned manifold substrate, implementing protocols for reading geometric structures from memory into the active manifold including reconstruction of thought bundles with their full geometric context, restoration of geodesic paths and associated curvature patterns, and integration of retrieved structures with current manifold state, and for writing geometric structure updates back to persistent storage following reasoning cycles including modified thought bundles, newly formed geodesic connections, and refined curvature patterns reflecting successful reasoning strategies. A federated coordinator 426 manages the sharing and synchronization of abstract cognitive structures across distributed nodes in federated deployment configurations, implementing geometric abstraction protocols that allow cognitive structures to be shared at appropriate levels of generalization while preserving privacy through abstraction of instance-specific details, handling cross-instance memory coordination challenges including alignment of geometric structures from independently evolved manifolds, and implementing consensus mechanisms that respect local geometric structures while enabling global knowledge emergence through selective bundle projection.

An irreversible reservoirs infrastructure 168 maintains the two categories of irreversible storage content that converge from the consolidation and suppression processing paths of the governed reasoning architecture, together with the formation, gating, projection, and revision mechanisms that govern how content transitions into and is managed within irreversible storage. Consolidated knowledge regions 431 constitute geometric reservoir regions of the epistemically conditioned manifold that satisfy phase flatness conditions with epistemic curvature magnitude below the flatness threshold, barrier energy conditions with boundary energy exceeding the barrier threshold, and boundary-aware admission control conditions routing compatible cognitive states into the region while excluding incompatible states. Consolidated knowledge regions 431 exhibit quantifiable stability across semantic, epistemic, and structural dimensions, resisting casual perturbation through the barrier energy of their boundaries and providing the most epistemically reliable cognitive content available to the reasoning architecture. Projected constraint artifacts 432 constitute abstract constraint records derived from epistemically inadmissible reasoning trajectories through the non-invertible projection operation of the consolidation and irreversible suppression subsystem, stored in non-navigable form that does not participate in active reasoning and from which original trajectory details including specific manifold locations, traversal sequences, and intermediate cognitive states cannot be reconstructed. Projected constraint artifacts 432 preserve canonical constraint identifiers and structural pattern descriptors sufficient to identify structurally similar inadmissible patterns in future reasoning, enabling the asymmetric constraint feedback channel to influence future admissibility evaluations without restoring inadmissible content to reasoning participation. An asymmetric feedback channel 205 exposes read-only access to constraint information stored in irreversible reservoirs 168 for use by epistemic admission control subsystem 120 and manifold evolution subsystem 172, providing constraint feedback indices and barrier edge sets that enable progressive tightening of admission thresholds and expansion of barrier topology as consolidated reservoir structure matures, and enforcing the architectural principle that active reasoning does not modify reservoir contents through the feedback channel in either direction.

Four dashed operational blocks within the irreversible reservoirs layer implement the formation, gating, projection, and revision mechanisms that govern transitions into and maintenance of irreversible storage. A reservoir formation evaluator 433 tracks measurable precursors of consolidation readiness in candidate substrate regions including curvature decay rate, phase coherence variance over internal loops, barrier energy growth rate, and Nijenhuis tensor magnitude decay, and evaluates whether candidate regions satisfy the three conditions for recognition as irreversible reservoirs comprising phase flatness below the flatness threshold, boundary energy exceeding the barrier threshold, and boundary-aware admission control consistency. A consolidation gate 434 computes a logical conjunction of constraint flags corresponding to the three layers of the epistemic governance architecture, requiring concurrent satisfaction of an epistemic admissibility flag from epistemic admission control subsystem 120, an epistemic coherence or corroboration flag from holonomy and epistemic phase monitoring subsystem 150, and a capacity admissibility flag from reservoir formation evaluator 433, and permitting irreversible commitment to consolidated status only when the logical conjunction is true. A non-invertible projector 435 applies a many-to-one canonicalization mapping to trajectories marked for suppression, discarding reconstructable trajectory details including specific manifold coordinates, traversal sequences, and intermediate cognitive state identifiers while preserving canonical constraint identifiers and structural pattern descriptors, the mapping being implemented such that no inverse mapping from stored constraint representation to original trajectory record exists within active traversal data structures. A revision controller 436 supports localized restructuring of consolidated knowledge regions when persistent contradictory boundary events accumulate beyond a revision threshold, initiating localized connection parameter updates, temporary relaxation of phase flatness constraints, and subsequent re-application of connection relaxation flow to restore curvature below the flatness threshold where consistent with accumulated evidence, with restructuring confined to the affected region without destabilizing distant reservoir regions.

A lifecycle optimizer 196 applies admissibility signals generated throughout the epistemic governance pipeline as optimization inputs that continuously improve the epistemic reliability of contributing reasoning sources, the organization of the persistent cognitive substrate, and the calibration of the epistemic governance architecture itself across the full operational lifetime of the system. A fine-tuning signal generator 441 constructs training supervision signals from suppression events and consolidation transitions, generating suppression-based negative training examples from input-output pairs associated with suppressed trajectory classes weighted by constraint severity indicators and epistemic curvature magnitudes, and consolidation-based positive training examples from input-output pairs associated with trajectories that contributed candidate cognitive states to successfully consolidated substrate regions weighted by barrier energy and phase flatness metrics of the consolidated region. A cache curation controller 442 applies suppression-conditioned activation energy reductions, consolidation-conditioned activation energy boosts, drift-conditioned participation state downgrades, and corroboration-driven cache index reorganization to the thought cache in response to admissibility outcome signals, implementing the full admissibility-conditioned cache management policy that progressively organizes cached content around epistemically mature consolidated knowledge and removes epistemically compromised content through accelerated thermodynamic decay. A dream manager inputs block 443 packages admissibility outcome signals as prioritized inputs for the autonomous geometric reorganization operations performed by the dream manager during reduced-activity periods, identifying suppressed substrate regions as high-priority targets for geometric restructuring, high-drift substrate regions as priorities for accelerated connection relaxation, consolidation candidate regions as targets for dream-phase geometric preparation, and corroboration gap regions as targets for topological restructuring to expand available corroboration pathways. A routing signal generator 444 applies per-source admissibility outcome statistics and cross-domain corroboration relationship records to generate routing adjustment signals that update source selection weights, expert domain routing preferences, and geodesic pathway preferences within the persistent cognitive substrate, implementing the closed-loop governance mechanism through which collective epistemic governance experience continuously refines resource allocation decisions across the governed reasoning architecture.

Two dashed auxiliary blocks within the lifecycle optimizer layer implement the meta-governance operations through which the epistemic governance architecture uses its own operational experience to improve its own sensitivity and efficiency. A governance threshold calibrator 445 applies admissibility outcome distributions, phase regime classification distributions, corroboration success rates, and consolidation stability metrics to evaluate and adjust the threshold values governing admission evaluation, phase regime classification, consolidation gating, and output qualification, implementing conservative threshold adjustment procedures bounded by stability constraints that prevent threshold drift from destabilizing established admissibility governance behavior. An epistemic maturation tracker 446 aggregates admissibility outcome statistics, consolidation rate metrics, suppression frequency trends, corroboration success rates, and calibration stability indicators into a composite epistemic maturation profile that characterizes the current epistemic reliability level and development trajectory of the persistent cognitive substrate and its associated reasoning ecosystem, providing system-level trust indicators available to the human oversight layer and reflecting the sublinear scaling behavior expected as the system approaches epistemic maturity through accumulated operational experience.

An outputs layer at the bottom of the architecture identifies multiple categories of information produced by subsystem 400 for consumption by other components of the governed reasoning architecture. Admissibility feedback directed to epistemic admission control subsystem 120 comprises constraint feedback indices and barrier edge sets derived from irreversible reservoirs 168 through asymmetric feedback channel 205, enabling admission threshold comparisons and topological admissibility evaluations in subsequent reasoning cycles to reflect the accumulated pattern of consolidated knowledge boundaries and identified inadmissible reasoning classes. Consolidation status directed to output generation and expression control subsystem 170 comprises admissibility status flags and consolidation gate decision records from consolidation gate 434, conditioning output eligibility determinations on the epistemic admissibility status maintained through all three governance layers and enabling output qualification to reflect the consolidation status of substrate regions traversed during reasoning. Geometric updates directed to manifold evolution subsystem 172 comprise reservoir formation and revision events from irreversible reservoirs 168 and governance threshold calibration adjustments from governance threshold calibrator 445, enabling ongoing geometric evolution of the epistemically conditioned manifold substrate to reflect the accumulated consolidation structure and calibration refinements produced by the lifecycle governance operations of subsystem 400.

A cache curation signals feedback path depicted as a dashed path running along the left margin of the figure from lifecycle optimizer 196 upward to thought cache 166 reflects the mechanism through which cache curation controller 442 applies admissibility-conditioned activation energy adjustments and participation state modifications to cached cognitive structures based on suppression events, consolidation transitions, and traversal coherence signals received from the epistemic governance pipeline. An asymmetric constraint feedback path depicted as a dashed path running along the right margin of the figure from irreversible reservoirs 168 upward to epistemic admission control subsystem 120 reflects the read-only mechanism through which projected constraint artifacts and consolidated reservoir boundary information stored in irreversible reservoirs 168 influence admissibility evaluations in subsequent reasoning cycles without being modifiable by active reasoning processes through the feedback channel.

The architecture of subsystem 400 is not limited to any particular implementation of the individual component blocks, and alternative arrangements in which the thought cache tiers, persistent memory components, reservoir formation and projection mechanisms, and lifecycle optimization processes are combined, subdivided, or implemented through different computational mechanisms may be employed without departing from the scope of the thought cache, persistent memory, and reservoir interaction architecture described herein.

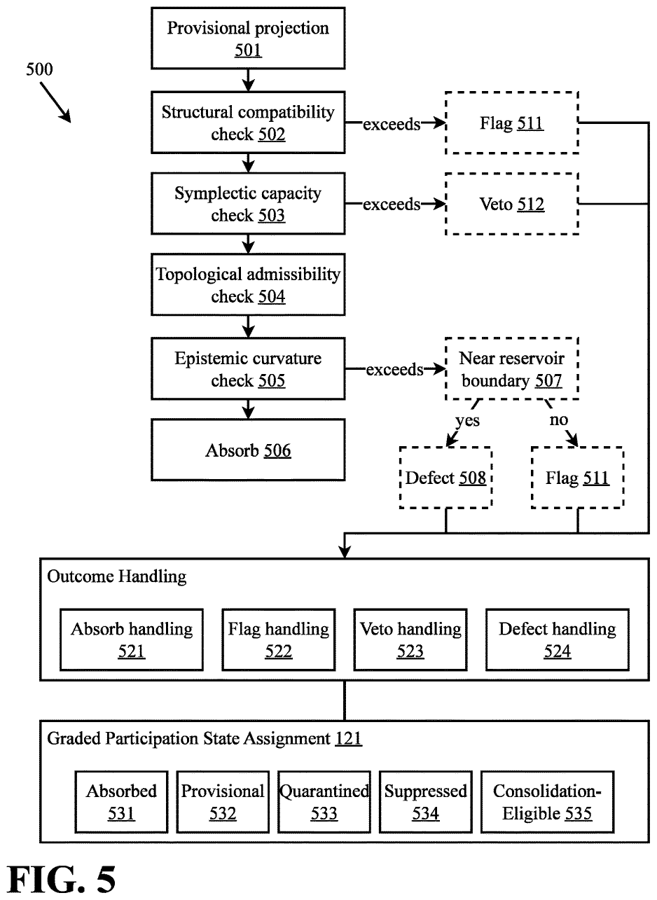

FIG. 5 is a flow diagram illustrating an exemplary epistemic admission control flow 500, according to an embodiment. The admission control flow 500 implements the first layer of the three-layer epistemic governance architecture, evaluating the epistemic admissibility of each candidate cognitive state prior to permitting the candidate to participate in active reasoning traversal. The flow proceeds as a sequential evaluation pipeline in which each stage applies a distinct structural check derived from the geometric properties of the persistent cognitive substrate, with failure at any stage routing the candidate to an appropriate outcome without proceeding to subsequent checks, and successful passage through all stages resulting in full admission to active reasoning. The admission control flow 500 is the primary mechanism through which regime hallucinations are suppressed, preventing the formation of reasoning trajectories from candidate cognitive states whose structural properties are incompatible with the current epistemic governance state of the substrate before reasoning execution begins.

A provisional projection 501 represents the entry point of the admission control flow, in which a candidate cognitive state derived from an external input or internally generated representation has been mapped by input projection subsystem 110 to a provisional location on the epistemically conditioned manifold substrate using semantic attachment to existing cognitive structures. The provisional location is represented as a candidate vertex insertion with associated geometric attributes including interpolated almost-complex structure assignments and candidate edge phase values, and is not incorporated into active reasoning structures or traversal data until admission evaluation is complete. Provisional projection 501 provides the candidate geometric attributes that serve as inputs to each subsequent evaluation stage of the admission control flow.

A structural compatibility check 502 constitutes the first evaluation stage of the admission control flow and evaluates the structural compatibility of the almost-complex structure interpolated at the provisional location by computing a compatibility residual measuring the worst-case discrepancy between the interpolated almost-complex structure at the provisional location and existing almost-complex structures at neighboring cognitive states as seen through discrete parallel transport along shortest graph paths. The compatibility residual is compared against a stored structural compatibility threshold. When the compatibility residual exceeds the structural compatibility threshold, the candidate cognitive state cannot be immediately integrated into the manifold geometry without introducing structural incompatibilities that would undermine the almost-Kähler compatibility of the substrate in the vicinity of the provisional location, and the admission control flow assigns a flag outcome routing the candidate to flag outcome block 511 without proceeding to subsequent evaluation stages. When the compatibility residual is within the structural compatibility threshold, the almost-complex structure at the provisional location is sufficiently consistent with the surrounding substrate geometry to permit continued evaluation, and the flow proceeds to the symplectic capacity check.

A symplectic capacity check 503 constitutes the second evaluation stage of the admission control flow and evaluates whether the persistent cognitive substrate has sufficient intrinsic structural capacity to accommodate the candidate cognitive state at the provisional location without violating symplectic capacity limits. The capacity check computes a projected post-insertion capacity density at the provisional location from local symplectic face areas derived from symplectic form 164 of the epistemically conditioned manifold substrate, representing the ratio of cognitive state count to computed symplectic capacity in the neighborhood of the provisional location following hypothetical insertion of the candidate. When the projected capacity density exceeds the stored capacity density threshold, the provisional location is in a region of the substrate that has reached its intrinsic structural capacity limit and cannot accommodate additional cognitive states without violating the discrete analogue of the non-squeezing constraint enforced by the substrate, and the admission control flow assigns a veto outcome routing the candidate to veto outcome block 512 without proceeding to subsequent evaluation stages. When the projected capacity density is within the capacity density threshold, the provisional location has sufficient structural capacity to accommodate the candidate cognitive state, and the flow proceeds to the topological admissibility check.

A topological admissibility check 504 constitutes the third evaluation stage of the admission control flow and evaluates whether the provisional location and its associated immediate transitions are reachable within the reservoir-stratified state space without crossing the barrier boundaries of consolidated irreversible reservoirs. The topological admissibility check consults barrier edge sets derived from the boundary neighborhoods of consolidated regions maintained by consolidation and irreversible suppression subsystem 160 and evaluates whether the proposed insertion and associated transitions can be reached within the accessible region of the reservoir-stratified state space defined by removing those barrier neighborhoods from the manifold. When topological admissibility is not satisfied because the provisional location or its immediate transitions would require crossing a reservoir barrier boundary absent boundary-aware admission control passage, the admission control flow assigns a veto outcome routing the candidate to veto outcome block 512 without proceeding to subsequent evaluation stages, the same veto block used for capacity density violations reflecting the architectural principle that both capacity and topological violations represent structural incompatibilities of equivalent severity that prevent admission. When topological admissibility is satisfied, the provisional location is reachable within the accessible state space without violating consolidated reservoir boundaries, and the flow proceeds to the epistemic curvature check.

An epistemic curvature check 505 constitutes the fourth and final evaluation stage of the admission control flow and evaluates the epistemic consistency of the provisional location with the current state of the epistemic connection of the persistent cognitive substrate through two complementary measurements. An insertion curvature computation calculates the maximum discrete epistemic curvature magnitude over new simplicial faces that would be created by the proposed insertion, measuring the epistemic inconsistency that would be introduced into the local substrate geometry by incorporating the candidate at the provisional location. A micro-holonomy screening computation evaluates accumulated epistemic phase over short, closed loops of bounded length passing through the provisional location on the discrete cognitive graph, detecting local epistemic inconsistencies that may not be captured by the insertion curvature computation alone. When both insertion curvature and micro-holonomy screening are within their respective stored thresholds, the provisional location exhibits acceptable epistemic consistency with the current substrate geometry and the admission control flow assigns an absorb outcome 506, admitting the candidate cognitive state into the persistent cognitive substrate with full geometric assignments. When insertion curvature exceeds the curvature threshold or micro-holonomy screening detects loop phase magnitude exceeding the phase drift threshold, the admission control flow evaluates the proximity of the provisional location to the nearest consolidated reservoir boundary through a boundary proximity check 507.

A boundary proximity check 507 determines whether the epistemic curvature violation detected at the epistemic curvature check stage is occurring in the vicinity of a consolidated irreversible reservoir boundary, comparing the geodesic distance from the provisional location to the nearest boundary of a consolidated region against a stored boundary proximity threshold. The boundary proximity determination routes the candidate to different outcomes depending on whether the curvature violation is occurring near an established knowledge boundary or in a region of the manifold undergoing active restructuring. When the provisional location is near a reservoir boundary and epistemic curvature or phase drift exceeds the relevant threshold, the elevated curvature near the boundary indicates a potential boundary interaction event that warrants recording as a structural anomaly at the knowledge boundary, and the admission control flow assigns a defect outcome routing the candidate to defect outcome block 508. When the provisional location is not near a reservoir boundary and epistemic curvature or phase drift exceeds the relevant threshold, the elevated curvature reflects local structural anomalies in a non-consolidated region of the substrate that may stabilize under geometric evolution without constituting a boundary interaction event, and the admission control flow assigns a flag outcome routing the candidate to flag outcome block 511.

An absorb outcome 506 represents the successful completion of all four evaluation stages of the admission control flow and the affirmative determination that the candidate cognitive state is epistemically admissible at the provisional location. The absorb outcome triggers full incorporation of the candidate into the persistent cognitive substrate with complete geometric assignments including new vertices, edges, and faces added to the discrete cognitive graph, interpolated almost-complex structure assignments incorporated into the substrate, and edge phase values incorporated into the epistemic connection. The absorbed candidate cognitive state is forwarded to traversal and reasoning subsystem 140 as an admitted initial state from which reasoning trajectories may be computed.

A flag outcome block 511 represents the determination that the candidate cognitive state exhibits one or more structural anomalies that preclude immediate full incorporation but do not rise to the level of a veto preventing admission. Flag outcomes arise from two distinct evaluation stages: structural compatibility check 502 when the compatibility residual exceeds the structural compatibility threshold, and epistemic curvature check 505 when curvature or phase drift thresholds are exceeded at a location not near a reservoir boundary. In both cases, the flagged candidate cognitive state is attached to the persistent cognitive substrate with a provisional participation status that permits participation in active reasoning traversal at reduced commitment while excluding the candidate from consolidation eligibility until local geometric conditions stabilize under the evolution flows of the substrate.

A veto outcome block 512 represents the determination that the candidate cognitive state cannot be admitted to the persistent cognitive substrate at the provisional location due to structural incompatibility of sufficient severity to prevent formation of epistemically admissible reasoning trajectories from that location. Veto outcomes arise from two distinct evaluation stages: symplectic capacity check 503 when the projected capacity density exceeds the capacity density threshold, and topological admissibility check 504 when the provisional location cannot be reached within the reservoir-stratified state space without crossing a consolidated reservoir barrier boundary. In both cases, the vetoed candidate cognitive state is routed to an alternative neighborhood selection routine that identifies a nearby manifold location with available capacity and acceptable topological accessibility, or is placed in a deferred integration buffer for re-evaluation following a subsequent compression cycle that may reduce local capacity density or restructure barrier neighborhoods to create accessible integration pathways.

A defect outcome block 508 represents the determination that the candidate cognitive state exhibits epistemic curvature or phase drift violations occurring in the vicinity of a consolidated reservoir boundary, warranting recording of a boundary defect event at the nearest reservoir boundary for classification by the consolidation and irreversible suppression subsystem. The defect outcome records a boundary defect record encoding the provisional location, the epistemic curvature magnitude and type, the phase drift measurement from micro-holonomy screening, and the identity of the nearest consolidated reservoir boundary, and forwards this record to consolidation and irreversible suppression subsystem 160 for classification by boundary event classifier 305 into corroborating, novelty, contradiction, or ambiguous categories based on phase defect magnitude and curvature decomposition into components compatible and incompatible with the almost-complex structure.

An outcome handling layer beneath the evaluation pipeline maps each admission outcome to its operational consequence within the governed reasoning architecture. Absorb handling 521 forwards the admitted cognitive state with full geometric assignments to traversal and reasoning subsystem 140 for trajectory computation, enabling the admitted state to serve as an initial state for geodesic path computation under the goal potential fields maintained by goal manager 193 and subject to the barrier edge constraints of the reservoir-stratified state space. Flag handling 522 attaches the candidate cognitive state to the persistent cognitive substrate with a provisional participation status indicator that permits the state to participate in active reasoning traversal at reduced commitment while maintaining exclusion from consolidation eligibility pending geometric stabilization, and records the provisional status in the participation state registry maintained by graded participation state controller 121. Veto handling 523 routes the rejected candidate to an alternative neighborhood selection routine that identifies a nearby manifold location satisfying capacity and topological admissibility conditions, or places the candidate in a deferred integration buffer for re-evaluation after a subsequent compression cycle reduces local capacity density or restructures barrier neighborhoods in the vicinity of the original provisional location. Defect handling 524 forwards the recorded boundary defect event to consolidation and irreversible suppression subsystem 160 for boundary event classification and potential incorporation into the consolidated region's boundary event history, which may trigger revision controller 436 when accumulated contradiction events exceed the revision threshold.

A graded participation state assignment layer 121 beneath the outcome handling layer identifies the five participation states to which candidate cognitive states may be assigned as a result of admission evaluation and subsequent governance processing. An absorbed state 531 is assigned to candidates that successfully complete all four evaluation stages and receive an absorb outcome, indicating full incorporation into the persistent cognitive substrate with unrestricted eligibility to participate in reasoning traversal, thought cache retrieval, and consolidation evaluation. A provisional state 532 is assigned to candidates that receive a flag outcome from either structural compatibility check 502 or epistemic curvature check 505, indicating participation in active reasoning at reduced commitment with exclusion from consolidation eligibility pending geometric stabilization. A quarantined state 533 is assigned to candidates that cannot be immediately integrated due to capacity violations or that are demoted from absorbed status following evidence-driven updates that generate accumulated epistemic strain at their locations, indicating isolation from active reasoning pending resolution of detected inconsistencies. A suppressed state 534 is assigned to candidates whose associated trajectory classes are determined to be epistemically inadmissible following traversal monitoring and whose constraint representations are projected into irreversible reservoirs through non-invertible operations, indicating permanent exclusion from active reasoning participation. A consolidation-eligible state 535 is assigned to candidates that have satisfied the concurrent multi-layer admissibility conditions required for transition to consolidated irreversible reservoir status, indicating readiness for irreversible commitment pending final evaluation by consolidation gate 434.

The flow may send outputs to downstream destinations to which information produced by the admission control flow. Admitted states are forwarded to traversal and reasoning subsystem 140 for trajectory computation from absorbed candidate cognitive states. Boundary defects are forwarded to consolidation and irreversible suppression subsystem 160 for boundary event classification and potential reservoir revision processing. Participation states are recorded in graded participation state controller 121 for use in governing the contribution of each cognitive state to subsequent reasoning traversal, thought cache retrieval, and consolidation evaluation operations throughout the governed reasoning architecture.

The admission control flow 500 is not limited to the specific sequential ordering of evaluation stages illustrated herein, and alternative arrangements in which evaluation stages are performed in parallel, combined, or supplemented with additional structural checks may be employed without departing from the scope of the epistemic admission control architecture described herein.

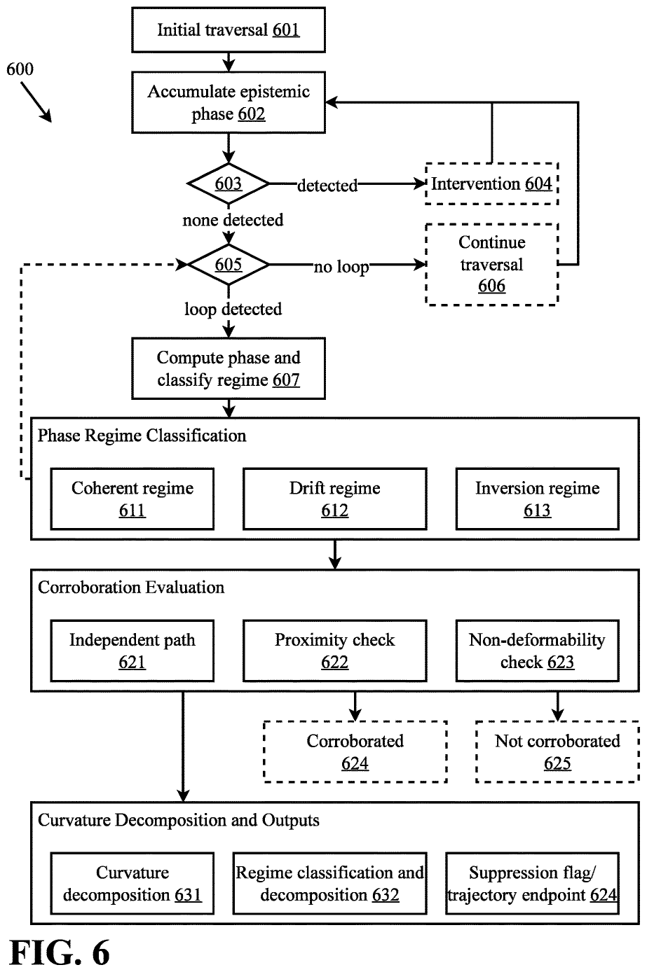

FIG. 6 is a flow diagram illustrating an exemplary traversal monitoring and corroboration flow 600, according to an embodiment. The traversal monitoring and corroboration flow 600 implements the second layer of the three-layer epistemic governance architecture, monitoring the epistemic coherence of active reasoning trajectories during execution and intervening when coherence failure conditions are detected. The flow operates concurrently with active reasoning traversal performed by traversal and reasoning subsystem 140, receiving trajectory events as reasoning progresses and returning intervention signals when epistemic instability is detected, without waiting for trajectory completion before evaluating epistemic quality. The traversal monitoring and corroboration flow 600 is a possible mechanism through which drift hallucinations are suppressed, detecting when topologically admissible reasoning trajectories accumulate epistemic phase drift sufficient to render their conclusions epistemically illegitimate despite having passed all pre-execution admission checks.

An initialize traversal step 601 represents the entry point of the traversal monitoring flow, in which traversal control structures are established for an admitted cognitive state forwarded from the epistemic admission control subsystem. Initialization creates a traversal stack encoding the sequence of manifold locations visited during reasoning execution, a visited-vertex hash table supporting efficient loop detection through lookup operations as traversal progresses, and an accumulated phase variable initialized to zero that will accumulate transition-specific phase values from epistemic connection 165 as the trajectory advances through the persistent cognitive substrate. The initialization step additionally records the participation state of the initial admitted cognitive state, any suppression flags or constraint class identifiers associated with nearby manifold locations derived from constraint feedback indices 303, and the current barrier edge set configuration defining the reservoir-stratified state space within which traversal must remain.

An accumulate epistemic phase step 602 advances the trajectory by one edge traversal and updates the accumulated phase variable by summing the scalar phase value assigned by epistemic connection 165 to the traversed oriented edge. The phase accumulation operation retrieves the stored edge phase value θᵢⱼ for the oriented edge from cognitive state i to cognitive state j, adds this value to the running accumulated phase variable Φ, and updates the visited-vertex record to include the newly reached vertex. The accumulated phase variable represents the total evidential drift accumulated along the reasoning path from its initial cognitive state to its current location, providing the path-dependent coherence quantity that subsequent monitoring steps evaluate against stored coherence thresholds. The accumulate epistemic phase step 602 is the recurring step of the traversal monitoring loop to which the flow returns following successful completion of discontinuity and conflict checking when no anomaly is detected and following intervention and redirection when traversal resumes after a detected coherence failure.

A discontinuity and conflict check 603 evaluates whether the current traversal state exhibits any of the coherence failure conditions that indicate loss of epistemic grounding during open-path traversal before any loop closure event has occurred. The discontinuity check computes an incremental phase gradient by comparing the phase value of the most recently traversed edge against a stored gradient threshold, detecting abrupt phase changes inconsistent with smooth evidential grounding along the reasoning path. The conflict check evaluates compatibility residuals between holonomy descriptors transported to the current traversal location from different source paths that converged at that location, detecting situations where incompatible holonomy descriptors exert contradictory epistemic influence at the current manifold position. The check additionally evaluates whether the most recently traversed edge is associated with a homotopy class identifier previously marked as suppressed in constraint feedback indices 303, detecting attempted traversal across substrate regions associated with previously identified inadmissible reasoning patterns. The check further evaluates whether partial loop structures detected in the traversal history exhibit accumulated phase magnitude exceeding a bounded pre-closure threshold, identifying self-inconsistency in nascent loop formations before they complete. When none of the discontinuity metrics exceed their corresponding thresholds and no holonomy conflict condition is satisfied, the flow proceeds to loop detection. When any discontinuity metric exceeds its threshold or any conflict condition is satisfied, the flow branches to an intervention block 604.

An intervention block 604 represents the real-time modification of traversal control structures performed by holonomy and epistemic phase monitoring subsystem 150 in response to detected discontinuities or conflicts during open-path traversal, without reliance on post-hoc filtering or waiting for trajectory completion. Intervention mechanisms available to the flow include interruption and termination of the current trajectory, redirection of traversal through an alternative admissible edge selected from a priority queue that excludes edges associated with suppressed homotopy classes or degeneracy regions, controlled backtracking to a previously recorded coherent vertex identified from the traversal stack, and suspension of traversal pending receipt of additional input or clarification from an upstream source. The choice among intervention mechanisms is made based on the severity of the detected discontinuity or conflict, the proximity of the current traversal location to consolidated reservoir regions, and the availability of alternative admissible paths in the vicinity. Following intervention, the flow returns to the accumulate epistemic phase step 602 with the accumulated phase variable updated in accordance with the modified traversal state, and monitoring continues along the redirected or resumed trajectory.

A loop detection step 605 evaluates whether the trajectory has revisited a previously visited vertex by performing a lookup in the visited-vertex hash table maintained since traversal initialization. Loop detection is performed at each traversal step, ensuring that closed reasoning paths are identified immediately upon closure rather than requiring explicit loop-seeking behavior. When no previously visited vertex has been revisited, the active trajectory has not yet formed a closed loop, and the flow branches to a continue traversal block 606 that returns processing to the accumulate epistemic phase step 602 for continued open-path monitoring. When a previously visited vertex has been revisited, the trajectory has closed a reasoning loop whose accumulated epistemic phase represents the total evidential drift around that loop, and the flow proceeds to phase regime computation and classification.

A continue traversal block 606 represents the normal open-path traversal state in which no discontinuity, conflict, or loop closure has been detected at the current traversal step, and monitoring continues by returning to the accumulate epistemic phase step 602 for the next traversal step. The continue traversal block implements the steady-state behavior of the traversal monitoring flow during extended open-path reasoning, maintaining the accumulated phase variable and visited-vertex records across each traversal step while repeatedly evaluating discontinuity conditions until either a coherence failure or a loop closure is detected.

A compute Φ(γ) and classify regime step 607 computes the loop-specific epistemic phase by summing stored edge phase values along the detected closed loop and classifies the loop into one of three phase regimes by comparing the absolute value of the computed loop phase against the stored phase drift threshold Φ* and the stored inversion threshold π. The loop phase computation leverages the discrete Stokes relation that connects accumulated edge phase values along a closed path to the sum of discrete epistemic curvature values over faces enclosed by the path, providing a structural link between path-level coherence diagnostics and region-level curvature distributions that enables content-sensitive loop classification grounded in the geometric state of the substrate rather than solely in path length or semantic similarity. The computed phase regime classification is recorded in the trajectory state structure for use in consolidation gating and output qualification operations performed by downstream subsystems.

A phase regime classification layer presents the three regime outcomes into which detected closed reasoning loops are classified based on the magnitude of the computed loop phase. A coherent regime block 611 represents the classification assigned when the absolute value of the loop phase does not exceed the phase drift threshold Φ*, indicating that the reasoning loop maintained evidential coherence within tolerance throughout its traversal and that consolidation of conclusions reached along the loop is permitted subject to concurrent satisfaction of capacity admissibility conditions at the consolidation stage. The coherent regime classification is the target epistemic state for reasoning trajectories and represents the condition under which the governed reasoning architecture permits the full value of a completed reasoning trajectory to be expressed in output generation and consolidated into the persistent cognitive substrate as durable knowledge. A drift regime block 612 represents the classification assigned when the absolute value of the loop phase exceeds the phase drift threshold Φ* but remains below the inversion threshold π, indicating that the loop accumulated significant epistemic drift during traversal such that the evidential grounding of the conclusion reached by the trajectory has deviated from the evidential grounding of the trajectory's origin beyond the coherent tolerance but has not undergone a complete evidential inversion. The drift regime classification triggers corroboration evaluation as described below, implementing the architectural principle that drift-regime conclusions are neither freely consolidated nor automatically suppressed but are subjected to independent verification before being permitted to contribute to knowledge consolidation or unqualified output generation. An inversion regime block 613 represents the classification assigned when the absolute value of the loop phase equals or exceeds the inversion threshold π, indicating that the evidential grounding at the conclusion is misaligned with the evidential grounding at the trajectory origin beyond the structural inversion threshold, that consolidation of conclusions reached along the trajectory is blocked, and that the trajectory is flagged for subsequent irreversible suppression through setting of a suppression flag in the trajectory state record. The inversion regime classification represents the most severe epistemic coherence failure detected during traversal monitoring and results in the trajectory being processed along the suppression path of consolidation and irreversible suppression subsystem 160.

A corroboration evaluation layer processes reasoning trajectories classified in the drift regime by evaluating whether an independent corroborating trajectory can be identified that satisfies the three structural conditions required for valid corroboration. The corroboration evaluation comprises three sequential criteria that must be jointly satisfied for a corroborating trajectory to be accepted as valid. An independent path criterion 621 requires that the corroborating trajectory γ′ be computed by corroboration engine 334 of traversal and reasoning subsystem 140 as a path through the persistent cognitive substrate that traverses genuinely different epistemic territory from the primary drift-regime trajectory γ, verified through comparison of homotopy class identifiers or evaluation of reachability equivalence under barrier edge constraints supplied by consolidation and irreversible suppression subsystem 160. The non-homotopic requirement ensures that the corroborating trajectory provides independent epistemic support for the conclusion rather than merely retracing the same evidential pathway through a topologically equivalent route. A proximity check criterion 622 requires that the corroborating trajectory γ′ terminate at a cognitive state whose geodesic distance under semantic metric 162 from the conclusion reached by the primary trajectory γ falls within a stored proximity threshold, verifying that the corroborating trajectory reaches a conclusion sufficiently close to the primary conclusion to constitute independent support for the same cognitive state rather than support for a distinct but nearby conclusion. A non-deformability check criterion 623 requires that the corroborating trajectory γ′ maintain its accumulated epistemic phase within the coherent regime throughout its traversal, verifying that the corroborating trajectory does not itself exhibit drift-regime phase accumulation that would undermine its capacity to provide independent epistemic support. The three corroboration criteria are evaluated sequentially with evaluation proceeding to the next criterion only when the current criterion is satisfied, and corroboration is accepted only when all three criteria are jointly satisfied.

When all three corroboration criteria are satisfied, the flow assigns a corroborated outcome 624 indicating that the drift-regime primary trajectory has received independent epistemic support from a non-homotopic coherent-regime corroborating trajectory and that consolidation of the corroborated conclusion is permitted subject to concurrent satisfaction of capacity admissibility conditions at the consolidation gate. The corroborated outcome implements the architectural principle that drift-regime conclusions are not permanently excluded from consolidation but may achieve consolidation eligibility through independent verification, enabling the governed reasoning architecture to reach epistemically grounded conclusions in knowledge areas where no single reasoning pathway maintains complete coherence while still requiring structural verification before permitting consolidation. When any corroboration criterion fails or no independent corroborating trajectory can be identified within the current state of the persistent cognitive substrate, the flow assigns a not corroborated outcome 625 indicating that the drift-regime conclusion lacks independent epistemic support and that output generation based on the primary trajectory must be qualified with epistemic insufficiency indicators reflecting the specific corroboration failure conditions identified during evaluation.

A curvature decomposition and outputs layer at the bottom of the figure identifies the downstream information produced by the traversal monitoring and corroboration flow for consumption by other components of the governed reasoning architecture. A curvature decomposition block 631 computes a decomposition of discrete epistemic curvature values associated with faces traversed by the active trajectory into a component compatible with almost-complex structure 163 representing epistemic strain arising from incomplete but self-consistent evidence and a component incompatible with almost-complex structure 163 representing epistemic strain arising from contradictory evidence, computing a contradiction measure as a ratio of the magnitude of the incompatible component to the sum of magnitudes of both components. The curvature decomposition is performed for all trajectory outcomes including coherent, drift, and inversion regime classifications and provides the boundary event classification inputs that enable consolidation and irreversible suppression subsystem 160 to distinguish among corroborating, novelty, contradiction, and ambiguous boundary events at consolidated reservoir boundaries. A regime classification and decomposition output block 632 forwards phase regime classifications comprising coherent, drift, or inversion designations together with curvature type decompositions to consolidation and irreversible suppression subsystem 160 for use in boundary event classification, consolidation gate evaluation, and suppression path processing. A suppression flag and trajectory endpoint output block 633 forwards suppression flags set in trajectory state records by inversion regime classifications to consolidation and irreversible suppression subsystem 160 to initiate generation of abstract constraint representations and non-invertible projection of inadmissible trajectory classes into irreversible reservoirs, and forwards trajectory endpoints from completed admissible trajectories to output generation and expression control subsystem 170 for use in computing output eligibility determinations and executing manifold-conditioned decoding operations.

A traversal intervention feedback path depicted as a dashed path running along the left margin of the figure from the phase regime classification layer back to the loop detection step reflects the mechanism through which intervention signals generated by holonomy and epistemic phase monitoring subsystem 150 cause modification of traversal control structures within traversal and reasoning subsystem 140 during active reasoning execution. This feedback path implements the real-time coherence governance capability that distinguishes the traversal monitoring and corroboration flow from post-hoc output filtering, enabling the governed reasoning architecture to redirect, backtrack, or terminate reasoning trajectories during execution based on detected epistemic instability rather than waiting for trajectory completion and attempting to detect inadmissible content in generated outputs.

The traversal monitoring and corroboration flow 600 is not limited to the specific sequential ordering of monitoring steps illustrated herein, and alternative arrangements in which phase accumulation, discontinuity detection, loop classification, and corroboration evaluation are performed through different computational mechanisms or in different sequences may be employed without departing from the scope of the traversal monitoring and corroboration architecture described herein.

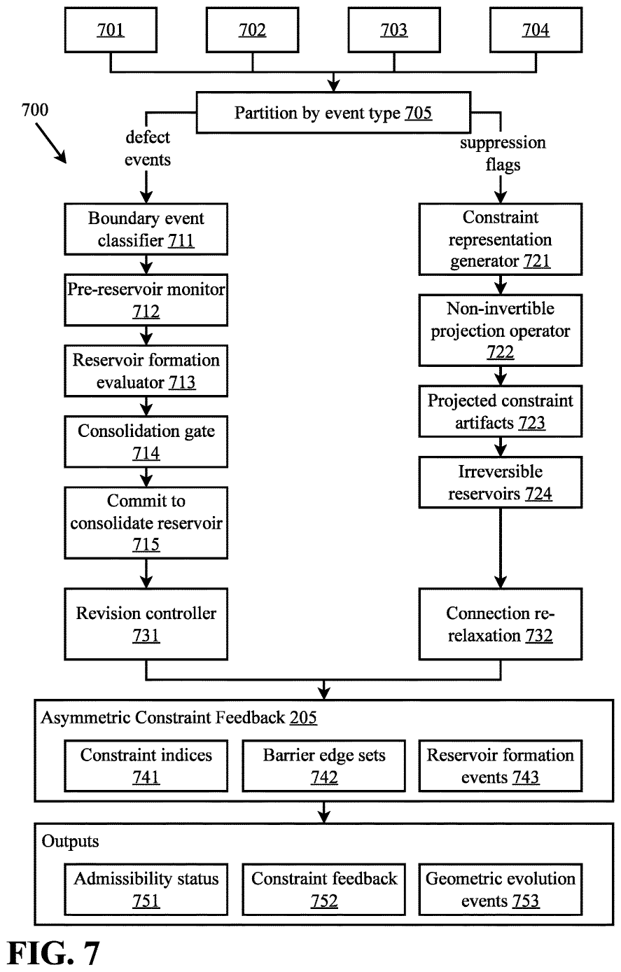

FIG. 7 is a flow diagram illustrating an exemplary consolidation, reservoir, and irreversible suppression flow 700, according to an embodiment. The consolidation, reservoir, and irreversible suppression flow 700 implements the third layer of the three-layer epistemic governance architecture, performing two complementary functions along parallel processing paths that converge at the irreversible reservoir infrastructure. Along a consolidation path, the flow evaluates candidate substrate regions approaching readiness for irreversible commitment as consolidated knowledge and gates that commitment on the concurrent satisfaction of epistemic admissibility, traversal coherence, and capacity admissibility conditions spanning all three governance layers. Along a suppression path, the flow constructs abstract constraint representations of epistemically inadmissible reasoning patterns and projects those representations into non-navigable irreversible storage through a non-invertible operation that precludes reconstruction of the original inadmissible content. Both paths feed into an asymmetric constraint feedback mechanism that propagates the epistemic consequences of consolidation and suppression decisions back to the admission control layer and the manifold evolution subsystem, conditioning subsequent reasoning cycles against recurrence of previously identified inadmissible patterns and reinforcing the structural boundaries of established knowledge.

An inputs layer at the top of the architecture identifies the four categories of information that drive the consolidation and suppression processing operations of flow 700. Boundary defect events 701 are received from epistemic admission control subsystem 120 and represent recorded anomalies detected at or near consolidated reservoir boundaries during admission evaluation of provisional candidate cognitive states, carrying defect metrics including phase defect magnitude, insertion curvature values, and geodesic distance to the nearest reservoir boundary that are consumed by the boundary event classifier to determine appropriate consolidation processing responses. Phase regime classifications 702 are received from holonomy and epistemic phase monitoring subsystem 150 and identify the coherent, drift, or inversion regime assignments of closed reasoning loops detected during active traversal, providing the traversal coherence indicators required by the consolidation gate for multi-layer admissibility evaluation. Curvature decompositions 703 are received from holonomy and epistemic phase monitoring subsystem 150 and provide the decomposition of discrete epistemic curvature associated with traversed faces into components compatible and incompatible with almost-complex structure 163, enabling boundary event classifier 711 to distinguish among corroborating, novelty, contradiction, and ambiguous boundary events based on the relative magnitudes of the J-invariant and J-anti-invariant curvature components. Suppression flags 704 are received from holonomy and epistemic phase monitoring subsystem 150 and identify specific trajectories whose inversion regime classifications have triggered suppression flag settings in trajectory state records, directing those trajectories to the suppression processing path for constraint representation generation and non-invertible projection.

A partition by event type step 705 receives all four input categories and routes incoming information to the appropriate processing path based on stored event-type identifiers. Boundary defect events 701 and curvature decompositions 703 associated with non-inversion regime trajectories are directed to the consolidation path for boundary event classification and consolidation readiness evaluation. Phase regime classifications 702 reflecting inversion regime assignments and suppression flags 704 from trajectory state records are directed to the suppression path for constraint representation generation and non-invertible projection. The partition step ensures that the two parallel paths receive the information appropriate to their respective processing functions without cross-contamination between consolidation and suppression processing streams.

A consolidation path processes boundary defect events and phase regime classifications through a sequential evaluation pipeline that gates irreversible commitment of substrate regions to consolidated reservoir status on the concurrent satisfaction of multi-layer admissibility conditions. A boundary event classifier 711 receives boundary defect events together with curvature type decompositions from curvature decompositions 703 and assigns each event to one of four classification categories based on threshold comparisons and curvature component ratios. A corroborating evidence classification designated B1 is assigned when phase defect magnitude and curvature are within threshold, indicating that the boundary interaction is consistent with the interior of the consolidated region and that the corresponding candidate cognitive state may be absorbed into the consolidated region. A novelty classification designated B2 is assigned when curvature is predominantly compatible with almost-complex structure 163, indicating that the boundary interaction reflects incomplete but non-contradictory evidence and that the candidate may be marked as a growth candidate for potential reservoir extension. A contradiction classification designated B3 is assigned when curvature is predominantly incompatible with almost-complex structure 163, indicating that the boundary interaction reflects conflicting evidence that is incompatible with the interior of the consolidated region and that the candidate should not be incorporated into the consolidated region. An ambiguous classification designated B4 is assigned when compatible and incompatible curvature components are of comparable magnitude, indicating insufficient evidence to determine whether the boundary interaction is corroborating or contradictory and that the candidate should be provisionally attached pending additional evidence. B1 and B2 classifications are forwarded to pre-reservoir monitor 712 for continued consolidation readiness evaluation. Persistent B3 classifications that accumulate beyond revision threshold Φᵣₑᵥ are routed along a dashed path to revision controller 731 in the reservoir revision layer, triggering localized restructuring of the affected consolidated region boundary.

A pre-reservoir monitor 712 tracks measurable precursors of consolidation readiness in candidate substrate regions approaching reservoir status, maintaining continuous assessment of four geometric indicators that collectively characterize the approach toward the geometric conditions required for consolidation transition. A curvature decay rate metric tracks the reduction of epistemic curvature within candidate regions under the connection relaxation flow operating on the slow timescale of manifold evolution subsystem 172, with sustained decay toward the flatness threshold indicating approach toward the phase flatness condition required for consolidation. A phase coherence variance metric measures the variance of accumulated phase over representative internal loops within a bounded geodesic neighborhood of the candidate region, with decreasing variance indicating increasing internal epistemic consistency characteristic of maturing reservoir regions. A barrier energy growth rate metric tracks the increase in boundary energy computed from curvature magnitude, extrinsic boundary curvature, and symplectic normal variation at the boundary of the candidate region, with increasing barrier energy indicating the development of structural resistance to perturbation that characterizes consolidated reservoir boundaries. A Nijenhuis tensor magnitude decay metric tracks the reduction of structural compatibility residuals within the candidate region under the compression flow operating on the intermediate timescale of manifold evolution subsystem 172, with decay toward zero indicating approach toward approximately Kähler-compatible geometry that provides additional consolidation rigidity. When tracked precursor metrics indicate that a candidate region may be approaching consolidation readiness, pre-reservoir monitor 712 forwards the candidate region to reservoir formation evaluator 713 for formal assessment against consolidation conditions. When precursor metrics indicate that the candidate region is not yet approaching readiness, the region is returned to continued geometric evolution monitoring without advancement to formal evaluation, implementing the not-ready feedback path that returns from consolidation gate 714 to pre-reservoir monitor 712 for continued observation under relaxation dynamics.

A reservoir formation evaluator 713 assesses candidate regions forwarded by pre-reservoir monitor 712 against three computationally verifiable conditions that must be satisfied for recognition as an irreversible reservoir. A phase flatness condition requires that stored epistemic curvature magnitudes for all vertices and faces within the candidate region fall below flatness threshold εR, indicating that parallel transport of epistemic state within the region is approximately path-independent and that the evidential relationships among cognitive states within the region are internally consistent. A barrier energy condition requires that boundary energy E∂U computed from epistemic curvature magnitude, extrinsic boundary curvature, and symplectic normal variation at the region boundary exceeds barrier threshold E*, indicating that the boundary possesses sufficient structural resistance to perturbation from external cognitive activity to maintain the region's consolidated status under routine reasoning operations. A boundary-aware admission control condition requires that admission control outcomes for candidate insertions within the boundary neighborhood of the candidate region demonstrate consistent absorption of compatible states and exclusion of incompatible states according to stored admissibility criteria, indicating that the region's boundary is actively governing access in a manner consistent with consolidated reservoir operation. When all three formation conditions are satisfied, the candidate region is forwarded to consolidation gate 714 for multi-layer admissibility evaluation. When any formation condition is not satisfied, the candidate region is returned to pre-reservoir monitor 712 for continued geometric evolution monitoring, implementing the not-ready path depicted as a dashed return path along the left margin of the consolidation path container.

A consolidation gate 714 computes a logical conjunction of constraint flags corresponding to all three layers of the epistemic governance architecture, requiring concurrent satisfaction of conditions from each layer before permitting irreversible commitment of a candidate region to consolidated reservoir status. A first layer flag requires that epistemic admissibility conditions were satisfied at the admission evaluation stage for cognitive states participating in the candidate region, as established by epistemic admission control subsystem 120. A second layer flag requires that epistemic coherence or corroboration conditions were satisfied at the traversal monitoring stage for reasoning trajectories that traversed the candidate region, as established by holonomy and epistemic phase monitoring subsystem 150. A third layer flag requires that capacity admissibility conditions were satisfied at the consolidation evaluation stage, as established by reservoir formation evaluator 713. When the logical conjunction of all three layer flags evaluates to true, consolidation gate 714 permits the candidate region to transition to consolidated reservoir status and the flow proceeds to commit to consolidated reservoir 715. When the logical conjunction evaluates to false because any layer condition remains unsatisfied, consolidation gate 714 returns the candidate region to pre-reservoir monitor 712 for continued precursor monitoring and geometric evolution under relaxation dynamics, implementing the not-ready feedback path. Consolidation gate 714 additionally provides admissibility status flags and gate decisions to output generation and expression control subsystem 170, enabling output eligibility determinations to reflect the consolidation status of substrate regions traversed during the reasoning trajectories underlying candidate outputs.

A commit to consolidated reservoir step 715 represents the irreversible transition of a candidate substrate region to consolidated reservoir status following successful evaluation by consolidation gate 714. The commitment operation stores region identifiers, boundary indices, and stability metrics reflecting phase flatness, barrier energy, and admission control stability conditions in the irreversible reservoir data structures maintained by irreversible reservoirs 168, activates boundary-aware admission control routing for the consolidated region, and updates the barrier edge sets that define the reservoir-stratified state space used in topological admissibility evaluations by epistemic admission control subsystem 120. The committed consolidated region thereafter resists modification under routine traversal operations, with any attempt to alter the epistemic connection within the consolidated region requiring energy proportional to the barrier energy and producing detectable boundary disturbances observable by holonomy and epistemic phase monitoring subsystem 150.

A suppression path processes trajectories marked for suppression through a sequential pipeline that generates abstract constraint representations and projects them into non-navigable irreversible storage. A constraint representation generator 721 receives trajectory records marked for suppression by inversion regime classifications from holonomy and epistemic phase monitoring subsystem 150 and constructs abstract constraint representations by extracting structural violation features from the trajectory record. Extracted features include violation type identifying whether the inadmissibility arose from phase inversion, homotopy class violation, or capacity exceedance, severity indicators derived from phase magnitude or curvature metrics at the point of detected inversion, contextual scope identifiers characterizing the substrate regions and knowledge domains involved in the inadmissible trajectory, and canonical pattern identifiers generated through normalization or hashing procedures that support recognition of structurally similar inadmissible patterns in future reasoning without requiring access to the original trajectory content. A non-invertible projection operator 722 applies a many-to-one canonicalization mapping to the abstract constraint representations generated by constraint representation generator 721, implementing the mapping such that multiple distinct inadmissible trajectories or trajectory classes may map to a common canonical constraint pattern and no inverse mapping from stored constraint representation to original trajectory record exists within active traversal data structures. The many-to-one mapping discards reconstructable trajectory details including specific manifold coordinates, traversal sequences, and intermediate cognitive state identifiers while preserving canonical constraint identifiers and structural pattern descriptors sufficient for inadmissible pattern recognition in future reasoning. Projected constraint artifacts 723 represent the canonical constraint records produced by non-invertible projection operator 722, characterized as non-navigable and non-reconstructable artifacts that do not constitute locations or trajectories within the active reasoning substrate and from which original inadmissible trajectory content cannot be recovered through any traversal or decoding mechanism available within the active reasoning architecture. Irreversible reservoirs 724 represent the deposition of projected constraint artifacts into the non-navigable constraint storage component of irreversible reservoirs 168, completing the suppression path by committing the abstract constraint records to the irreversible storage infrastructure from which they will influence future reasoning through the asymmetric constraint feedback mechanism without being accessible to active reasoning processes.

A reservoir revision layer handles the special case in which persistent contradiction boundary events from boundary event classifier 711 accumulate beyond revision threshold Φᵣₑᵥ at a consolidated reservoir boundary, triggering localized restructuring of the affected region. A revision controller 731 receives accumulated contradiction magnitude signals from boundary event classifier 711 when B3 classification events accumulate beyond the revision threshold and initiates localized restructuring of the affected consolidated knowledge region, comprising localized connection parameter updates within a bounded geodesic radius of the boundary defect cluster, temporary relaxation of phase flatness constraints within the affected subregion to permit geometric adjustment, and re-engagement of connection relaxation flow to redistribute epistemic curvature within the restructured region. Revision controller 731 confines restructuring to vertices and faces within a bounded geodesic radius of the accumulating contradiction cluster and does not propagate restructuring to distant portions of the consolidated reservoir, preserving the stability of established knowledge in regions unaffected by the accumulated contradiction. A connection re-relaxation block 732 applies connection relaxation flow to the restructured boundary region following revision operations initiated by revision controller 731, driving epistemic curvature within the affected region back toward the flatness threshold through incremental phase updates and either restoring the region to consolidated status with updated epistemic connection values consistent with the accumulated evidence or permanently de-consolidating the affected region when the accumulated contradiction evidence is inconsistent with restoration of phase flatness within the region.

An asymmetric constraint feedback layer 205 exposes read-only access to constraint information stored in irreversible reservoirs 168 for use by upstream subsystems and the manifold evolution infrastructure, implementing the architectural principle that active reasoning does not modify reservoir contents through the feedback channel in either direction. Constraint indices 741 provide read-only access to canonical constraint identifiers and structural pattern descriptors derived from projected constraint artifacts to epistemic admission control subsystem 120, enabling admissibility threshold comparisons and homotopy class suppression checks in subsequent reasoning cycles to incorporate the accumulated pattern of previously identified inadmissible reasoning classes without requiring access to the underlying trajectory content from which those patterns were derived. Barrier edge sets 742 provide read-only access to the boundary indices of consolidated knowledge regions to epistemic admission control subsystem 120, enabling topological admissibility evaluations and corroboration non-deformability assessments to reflect the current consolidated knowledge boundary structure established across all prior consolidation transitions. Reservoir formation events 743 provide notifications of consolidation transitions, revision events, and barrier edge set updates to manifold evolution subsystem 172 for incorporation into ongoing geometric evolution and threshold recalibration of epistemically conditioned manifold substrate 161, ensuring that the evolution dynamics of the substrate reflect the accumulated consolidated knowledge structure produced by the consolidation and suppression processing of flow 700.

An outputs layer at the bottom of the figure identifies the three categories of information produced by flow 700 for consumption by downstream components of the governed reasoning architecture. Admissibility status 751 comprising admissibility status flags and consolidation gate decision records from consolidation gate 714 is directed to output generation and expression control subsystem 170, conditioning output eligibility determinations on the concurrent satisfaction of multi-layer admissibility conditions and enabling output qualification to reflect the consolidation status of substrate regions traversed during the reasoning trajectories underlying candidate outputs. Constraint feedback 752 comprising constraint indices and barrier edge sets from asymmetric constraint feedback layer 205 is directed to epistemic admission control subsystem 120, enabling admission threshold comparisons, topological admissibility evaluations, and homotopy class suppression checks in subsequent reasoning cycles to reflect the accumulated epistemic governance decisions of the consolidation and suppression flow. Geometric evolution events 753 comprising reservoir formation notifications, revision events, and barrier edge set updates from asymmetric constraint feedback layer 205 are directed to manifold evolution subsystem 172 for incorporation into the ongoing geometric evolution of epistemically conditioned manifold substrate 161, ensuring that compression flow, connection relaxation flow, and threshold calibration operations reflect the current consolidated knowledge structure and accumulated suppression history of the governed reasoning architecture.

The consolidation, reservoir, and irreversible suppression flow 700 is not limited to the specific parallel path organization illustrated herein, and alternative arrangements in which consolidation evaluation, constraint representation generation, non-invertible projection, revision control, and asymmetric feedback are implemented through different computational mechanisms or organizational structures may be employed without departing from the scope of the consolidation, reservoir, and irreversible suppression architecture described herein.

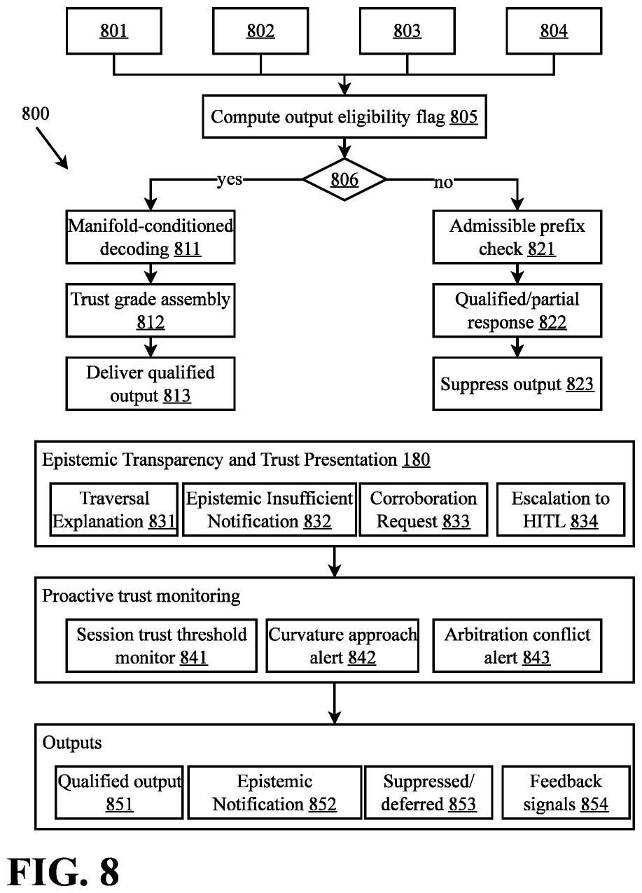

FIG. 8 is a flow diagram illustrating an exemplary output gating, qualification, and suppression flow 800, according to an embodiment. The output gating, qualification, and suppression flow 800 implements the expression control layer of the governed reasoning architecture, conditioning all output generation on the epistemic admissibility status maintained throughout the three-layer governance pipeline and providing structured epistemic transparency to human operators, downstream processes, and end users when outputs are qualified, withheld, or accompanied by epistemic insufficiency notifications. The flow 800 ensures that decoder-level mechanisms are invoked only when the full conjunction of admissibility conditions spanning all three governance layers has been satisfied, that outputs derived from inadmissible reasoning trajectories are never silently emitted, and that the epistemic conditions underlying each output decision are communicated to recipients in a form that is structurally grounded, actionable, and adapted to the interface and use context. The flow 800 additionally implements proactive trust monitoring that surfaces epistemic quality indicators to human operators without waiting for explicit confidence queries, and generates output feedback signals that contribute to the lifecycle optimization operations of lifecycle optimizer 196.

An inputs layer at the top of the architecture identifies four exemplary categories of epistemic status information that the output generation and expression control subsystem 170 receives from upstream governance layers before computing output eligibility. Trajectory endpoints 801 are received from traversal and reasoning subsystem 140 and represent the terminal cognitive states and associated geometric context of completed reasoning trajectories, providing the manifold-level content from which output generation and expression control subsystem 170 will decode external representations if admissibility conditions are satisfied. Phase regime classifications 802 are received from holonomy and epistemic phase monitoring subsystem 150 and identify the coherent, drift, corroborated, or inversion regime assignments of the reasoning trajectories underlying candidate outputs, providing the traversal coherence indicators required for the second-layer admissibility condition of the output eligibility computation. Admissibility status flags 803 are received from consolidation and irreversible suppression subsystem 160 and encode the outcomes of admission evaluation and consolidation gate processing for the cognitive states and substrate regions participating in the candidate output trajectories, providing the first-layer and third-layer admissibility indicators required for the output eligibility computation. Consolidation gate flags 804 are received from consolidation and irreversible suppression subsystem 160 and represent the results of consolidation gate 714 evaluations for substrate regions traversed during reasoning, providing direct confirmation of whether the concurrent multi-layer admissibility conditions required for consolidated output have been satisfied for the specific reasoning trajectories underlying candidate outputs.

A compute output eligibility flag step 805 assembles the output eligibility determination for each completed reasoning trajectory by evaluating a logical conjunction of stored status indicators received from the three governance layers. The eligibility computation requires concurrent satisfaction of three conditions: an absorb outcome at the admission evaluation stage as established by epistemic admission control subsystem 120 and reflected in admissibility status flags 803, a coherent or corroborated phase regime classification at the traversal monitoring stage as established by holonomy and epistemic phase monitoring subsystem 150 and reflected in phase regime classifications 802, and a true consolidation gate flag from the consolidation evaluation stage as established by consolidation and irreversible suppression subsystem 160 and reflected in consolidation gate flags 804. The computed output eligibility flag is stored as a discrete binary status indicator associated with each completed trajectory and governs whether manifold-conditioned decoding operations may be invoked for that trajectory. The output eligibility computation is performed by output generation and expression control subsystem 170 as a structural prerequisite to all decoding operations, ensuring that decoder-level mechanisms are architecturally prevented from emitting output when the eligibility flag is false regardless of the semantic plausibility or fluency of the content that would otherwise be generated.

An output eligibility flag decision step 806 evaluates the stored output eligibility flag and routes processing to one of two parallel handling paths based on the flag value. When the output eligibility flag is true, indicating that the completed reasoning trajectory satisfied all three-layer admissibility conditions, processing is routed to the admissible output path for manifold-conditioned decoding and trust grade assembly. When the output eligibility flag is false, indicating that one or more admissibility conditions were not satisfied, processing is routed to the inadmissible output path for prefix evaluation, qualification, or suppression.

An admissible output path processes completed reasoning trajectories whose output eligibility flags are true through a sequence of decoding, trust grading, and delivery operations that produce fully qualified outputs grounded in epistemically admissible cognitive content. A manifold-conditioned decoding step 811 executes the decoding operations that translate admissible cognitive states and trajectory results from their geometric representations within the persistent cognitive substrate into external representations appropriate for delivery to users or downstream processes. Manifold-conditioned decoding is conditioned on the output eligibility flag in a structural sense, meaning that the invocation of decoder-level mechanisms including language model generation, symbolic translation, or action specification is architecturally contingent on the true value of the flag and these mechanisms are prevented from executing when the flag is false. The decoding process interprets not only the terminal cognitive state of the trajectory but the full geometric context of the reasoning path including the sequence of substrate regions traversed, the thought cache structures accessed during reasoning, the goal potential fields that guided traversal, and the epistemic connection values encountered along the trajectory, producing outputs that reflect the structured reasoning process rather than only its terminal conclusion. A trust grade assembly step 812 constructs a structured trust grade for the decoded output by integrating four components reflecting the epistemic provenance of the output across the dimensions relevant to human decision-making and downstream process integration. A participation state component reflects the highest participation state achieved by cognitive states traversed during the reasoning trajectory, distinguishing outputs grounded in consolidated cognitive states from those traversing absorbed but non-consolidated states or provisional states carrying unresolved structural anomalies. A coherence classification component reflects the phase regime classification of closed reasoning loops detected during traversal, distinguishing fully coherent outputs from corroboration-supported outputs that achieved consolidation eligibility through independent verification rather than direct phase coherence. A consolidation status component reflects whether the substrate regions traversed during reasoning include consolidated irreversible reservoir regions, frontier regions undergoing active geometric restructuring, or contested regions where arbitration among multiple sources has not been fully resolved. A source provenance component identifies the contributing reasoning sources whose candidate cognitive states participated in the reasoning trajectory together with the participation states achieved by those candidates and any inter-source corroboration relationships established during arbitration. A deliver qualified output step 813 transmits the decoded representation together with its assembled trust grade to the external interface or downstream process, providing recipients with both the substantive content of the admissible output and the structured epistemic characterization of the conditions under which the output was generated.

An inadmissible output path processes completed reasoning trajectories whose output eligibility flags are false through a sequence of prefix evaluation, qualification, and suppression operations that ensure recipients receive the maximum epistemically grounded information available while accurately representing the limitations of the underlying reasoning. An admissible prefix check step 821 evaluates whether a stored admissible prefix of the trajectory exists, corresponding to a portion of the trajectory that maintained coherent or corroborated phase regime status prior to the detection of incoherence and being identified using stored phase regime transition points or discontinuity markers recorded during traversal monitoring. The admissible prefix check determines whether any portion of the trajectory that preceded the epistemic failure maintained sufficient admissibility to support partial output generation. When a stored admissible prefix is available, processing proceeds to qualified or partial response generation. When no admissible prefix is available, processing is routed directly to suppress output, bypassing partial response generation entirely.

A qualified or partial response step 822 generates a qualified or partial response derived solely from the cognitive states associated with the admissible prefix of the trajectory, accompanied by structured epistemic insufficiency indicators that communicate to the recipient the nature and location of the admissibility failure that prevented full output generation. The qualified response clearly distinguishes the admissible prefix content from the withheld remainder and includes structured indications of epistemic insufficiency corresponding to stored degeneracy region markers, high-curvature regions, barrier boundary encounters, or phase discontinuity locations encountered during traversal, enabling recipients to understand both the extent of epistemically grounded content available and the specific structural limitations that prevented complete response generation.

A suppress output step 823 is invoked when no admissible prefix exists and represents the architectural state in which output generation and expression control subsystem 170 withholds all decoded output and generates instead a suppression response selected from a set of defined suppression outcomes including withholding a response, requesting clarification or additional input from the user or upstream process, or deferring response generation to a later time or external process. The suppress output step implements suppression as a defined architectural state rather than as an error condition, ensuring that suppression events are communicated to recipients through structured suppression responses rather than through silence or system errors, and that no decoded content derived from epistemically inadmissible trajectories is emitted under any circumstances.

An epistemic transparency and trust presentation layer 180 beneath the parallel output paths implements the human-in-the-loop escalation and trust presentation capabilities of the governed reasoning architecture, providing structured epistemic communications to human operators and downstream processes that make the internal epistemic governance state of the system transparent and actionable. A traversal explanation block 831 generates structured accounts of the reasoning trajectories underlying outputs, comprising a trajectory summary describing the sequence of substrate regions traversed, a governance event log recording the specific governance decisions made by the admissibility architecture during reasoning including admission outcomes, coherence failure detections, interventions, and arbitration results, and a knowledge boundary component identifying the boundaries between consolidated knowledge regions and frontier or contested regions encountered during reasoning. The traversal explanation adapts its level of detail to the interface and use context, with lower trust grades automatically triggering more detailed traversal explanations to ensure recipients receive sufficient structural information for informed decision-making about epistemically uncertain outputs. An epistemic insufficiency notification block 832 generates structured notifications when qualified, partial, or suppressed outputs arise from epistemic limitations of the substrate, comprising a gap identification component identifying the specific substrate locations that were unavailable for admissible reasoning traversal, a constraint summary component describing the specific admissibility conditions that were not satisfied, and a resolution pathway component identifying the types of additional evidence or corroboration that would most efficiently resolve the identified epistemic insufficiency based on the learning readiness field computed at the boundaries of relevant consolidated regions. A corroboration request block 833 generates structured corroboration requests directed to human operators or upstream evidence sources when drift-regime trajectories fail corroboration evaluation, comprising a conclusion identification component describing the specific cognitive state requiring corroboration, an evidential gap component characterizing the high-curvature substrate region separating the primary trajectory's evidential basis from consolidated knowledge, and a corroboration criteria component specifying the structural conditions that an independent corroborating trajectory must satisfy translated into terms meaningful for human operators including the types of evidence and independent analyses that would constitute valid corroboration from a structural epistemic standpoint. An escalation to human-in-the-loop block 834 generates escalation communications directed to human oversight when epistemic conditions exceed the resolution capacity of the automated governance architecture, comprising complete epistemic situation reports documenting the original reasoning task, the unresolved epistemic conflict or insufficiency that triggered escalation, the traversal explanation for any partial reasoning completed before escalation, and a set of structured resolution options available to the human operator for guiding subsequent system behavior.

A proactive trust monitoring layer beneath the epistemic transparency layer implements continuous session-level epistemic quality surveillance that surfaces trust indicators to human operators without waiting for explicit confidence queries. A session trust threshold monitor 841 tracks the trust grades of outputs delivered during an ongoing reasoning session and generates alerts when the proportion of provisional, drift-regime, or corroboration-supported outputs in the session exceeds a configurable session-level epistemic quality threshold, enabling human operators to detect systematic epistemic quality degradation across a reasoning session rather than only evaluating individual output quality. A curvature approach alert block 842 monitors whether active reasoning trajectories are approaching substrate regions characterized by high epistemic curvature, low learning readiness field values, or proximity to consolidated reservoir boundaries where admissibility conditions may become restrictive, generating proactive notifications that enable human operators to anticipate epistemic limitations before they result in qualified or suppressed outputs. An arbitration conflict alert block 843 monitors the multi-source arbitration layer for unresolved epistemic inconsistencies among co-located candidate cognitive states from heterogeneous reasoning sources, generating proactive notifications when persistent conflicts indicate systematic evidential disagreement among contributing sources that may affect the reliability of outputs in specific knowledge areas. The proactive trust monitoring layer enables human operators to engage with the epistemic governance layer of the system as an active partner in knowledge-intensive reasoning tasks rather than as a passive recipient of outputs whose epistemic quality must be independently assessed after delivery.

An outputs layer at the bottom of the figure identifies the four categories of information produced by flow 800 for delivery to recipients and for feedback to the lifecycle governance infrastructure. Qualified output 851 represents fully decoded and trust-graded responses derived from epistemically admissible reasoning trajectories, delivered to users or downstream processes together with structured trust grade components that characterize the epistemic provenance of the output across participation state, coherence classification, consolidation status, and source provenance dimensions. Epistemic notification 852 represents the structured epistemic communications generated by the transparency and trust presentation layer including traversal explanations, epistemic insufficiency notifications, and corroboration requests, delivered to users or human-in-the-loop escalation subsystem 180 in formats adapted to the interface and use context. Suppressed or deferred output 853 represents the defined architectural suppression state in which no decoded content is emitted and a structured suppression response communicating the basis for withholding is delivered to users or human-in-the-loop escalation subsystem 180, implemented as a positive output state rather than as an error or null response. Feedback signals 854 represent the output quality indicators, trust grade distributions, suppression event records, and proactive monitoring alerts generated during flow 800 that are directed to lifecycle optimizer 196 as admissibility outcome signals contributing to fine-tuning signal generation, cache curation, dream manager prioritization, routing optimization, and governance threshold calibration operations across the full operational lifetime of the governed reasoning system.

A dashed feedback path depicted along the right margin of the figure from feedback signals 854 back to lifecycle optimizer 196 reflects the closed-loop governance mechanism through which output generation outcomes continuously inform the lifecycle optimization operations that improve the epistemic reliability of contributing reasoning sources, the organization of the persistent cognitive substrate, and the calibration of the epistemic governance architecture across successive reasoning cycles. This feedback path completes the full governance loop of the governed reasoning architecture, connecting the final expression control layer back to the lifecycle optimization infrastructure that uses accumulated epistemic governance experience to raise the epistemic floor of reasoning quality across all subsequent reasoning cycles.

The output gating, qualification, and suppression flow 800 is not limited to the specific eligibility computation, decoding, qualification, and suppression mechanisms illustrated herein, and alternative arrangements in which output eligibility determination, trust grade assembly, epistemic transparency, and proactive monitoring are implemented through different computational mechanisms or organizational structures may be employed without departing from the scope of the output gating, qualification, and suppression architecture described herein.

### Exemplary Computing Environment

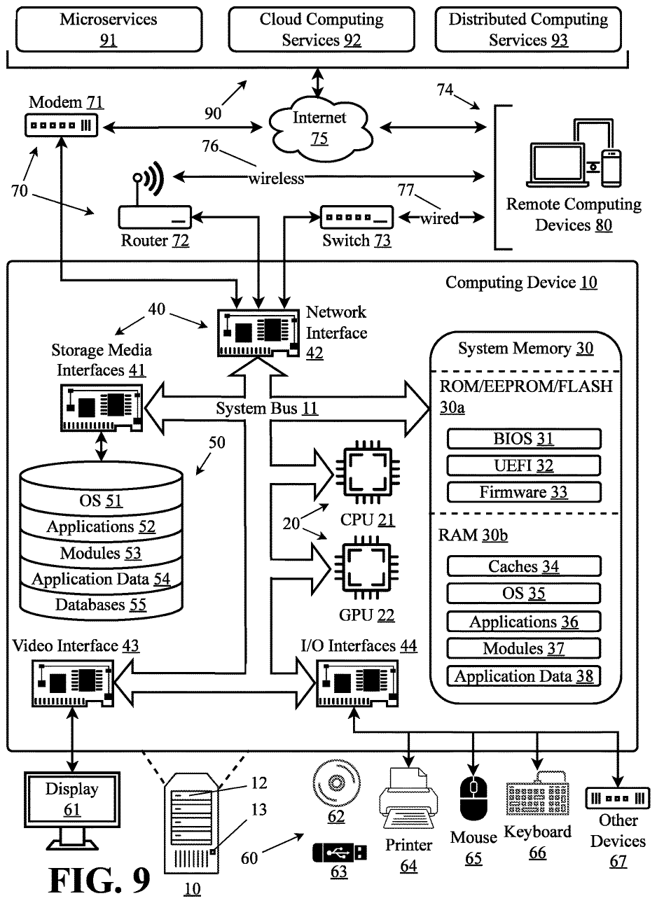

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising one or more processors and non-transitory machine-readable storage media storing instructions that cause the system to:
maintain a persistent cognitive substrate in which cognitive states are represented as structured locations and reasoning processes are represented as trajectories through the substrate, the persistent cognitive substrate encoding semantic relationships between cognitive states together with epistemic conditioning information that governs which cognitive states and reasoning trajectories are permitted to participate in active reasoning;
project a candidate state derived from an external input or an internally generated representation to a provisional location in the persistent cognitive substrate;
prior to incorporating the provisional location into active reasoning, evaluate epistemic admissibility of the provisional location against one or more structural properties of the persistent cognitive substrate, and deny admission by preventing formation of a reasoning trajectory from the provisional location when epistemic admissibility is not satisfied;
compute at least one reasoning trajectory through the persistent cognitive substrate from an admitted cognitive state;
during traversal of the reasoning trajectory, monitor epistemic coherence by tracking a path-dependent quantity accumulated along transitions of the trajectory and detecting a coherence failure condition based on the accumulated path-dependent quantity;
in response to detecting a coherence failure condition, intervene in traversal by performing at least one of interrupting the trajectory, redirecting traversal to an alternative admissible path, or marking the trajectory as epistemically inadmissible;
when a trajectory or class of trajectories is determined to be epistemically inadmissible, generate a constraint representation characterizing a structural basis for the inadmissibility and store the constraint representation in one or more irreversible reservoirs in a form that is not restorable to active reasoning participation;
apply asymmetric constraint feedback from the irreversible reservoirs to influence subsequent admissibility evaluations and traversal decisions without permitting active reasoning to modify contents of the irreversible reservoirs; and
generate an output conditioned on epistemic admissibility status maintained throughout admission and traversal, wherein the output is suppressed, qualified, or withheld when no epistemically admissible reasoning trajectory supports a response, and wherein the persistent cognitive substrate is updated based on outcomes of admissibility evaluation and traversal coherence monitoring so that subsequent reasoning cycles reflect accumulated epistemic governance decisions.

2. The computer system of claim 1, wherein the persistent cognitive substrate comprises a latent manifold carrying:
a semantic metric encoding semantic dissimilarity between cognitive states and governing geodesic distances within the latent manifold;
an almost-complex structure defined on tangent spaces of the latent manifold satisfying a squared-equals-negative-identity constraint and restricting admissible deformations of the manifold to deformations preserving both the semantic metric and the almost-complex structure;
a symplectic form reconstructed from the semantic metric and the almost-complex structure according to a compatibility relation and satisfying a closedness condition; and
an epistemic connection that is geometrically independent of the semantic metric and assigns transition-specific coherence values to transitions between cognitive states, such that two regions of the latent manifold having identical structure under the semantic metric may exhibit different epistemic curvature values reflecting different levels of evidential support.

3. The computer system of claim 2, wherein the one or more structural properties against which epistemic admissibility is evaluated comprise at least one of:
a local capacity measure derived from the symplectic form by computing a symplectic capacity associated with a neighborhood of the provisional location, wherein admission is denied when a projected post-insertion capacity density at the provisional location exceeds a capacity density threshold relative to the computed symplectic capacity;
an admissibility boundary condition derived from barrier energy computed at boundaries of consolidated irreversible reservoirs within the latent manifold, wherein admission is denied or flagged when the provisional location falls within a barrier neighborhood of a consolidated region;
a degeneracy indicator derived from epistemic curvature computed from the epistemic connection at the provisional location, wherein admission is denied or flagged when epistemic curvature magnitude exceeds a curvature threshold; or
compatibility with path-dependent descriptors maintained for the latent manifold, wherein admission is denied or flagged when path-dependent descriptors applicable to the provisional location exhibit mutual inconsistency exceeding a descriptor conflict threshold.

4. The computer system of claim 2, wherein evaluating epistemic admissibility of the provisional location comprises performing, in sequence:
evaluating structural compatibility of an almost-complex structure interpolated at the provisional location by computing a compatibility residual measuring discrepancy between the interpolated structure and existing almost-complex structures at neighboring cognitive states, and assigning a provisional participation status when the compatibility residual exceeds a structural compatibility threshold;
evaluating symplectic capacity by computing a projected post-insertion capacity density at the provisional location from local symplectic face areas derived from the symplectic form, and denying admission when the projected capacity density exceeds a capacity density threshold;
evaluating topological admissibility of the provisional location within a reservoir-stratified state space defined by removing barrier neighborhoods associated with consolidated irreversible reservoirs from the latent manifold, and denying admission when the provisional location or associated immediate transitions are not reachable within the accessible region without crossing a barrier boundary; and
evaluating epistemic curvature by computing insertion curvature over faces created by the proposed insertion and performing micro-holonomy screening over short, closed loops passing through the provisional location, and assigning a boundary defect outcome when curvature or loop phase magnitudes exceed respective thresholds and the provisional location is near a reservoir boundary.

5. The computer system of claim 1, wherein candidate states admitted to the persistent cognitive substrate are assigned one of a plurality of graded participation states comprising:
an absorbed state in which the candidate state is fully incorporated into the persistent cognitive substrate with complete structural assignments and is eligible to participate in reasoning traversal and consolidation;
a provisional state in which the candidate state participates in reasoning traversal at reduced commitment but is excluded from consolidation until local structural conditions stabilize;
a quarantined state in which the candidate state is isolated from active reasoning pending resolution of detected epistemic inconsistencies or capacity violations;
a suppressed state in which the candidate state is prevented from participating in reasoning traversal and a constraint representation characterizing the basis for suppression is stored in an irreversible reservoir; and
a consolidation-eligible state in which the candidate state has satisfied epistemic admissibility, traversal coherence, and capacity conditions and may transition to a consolidated irreversible reservoir upon satisfaction of concurrent multi-layer admissibility conditions.

6. The computer system of claim 5, wherein the system further manages transitions between graded participation states by:
promoting a provisional state to an absorbed state when structural compatibility conditions are satisfied under geometric evolution of the persistent cognitive substrate;
promoting a provisional state to a consolidation-eligible state when the candidate state additionally satisfies traversal coherence conditions and capacity admissibility conditions;
demoting an absorbed state to a quarantined state when subsequent traversal events or evidence-driven updates generate accumulated epistemic strain at the location exceeding a strain threshold;
transitioning a quarantined state to a suppressed state when contradiction evidence accumulates beyond a revision threshold without resolution; and
maintaining asymmetric constraint feedback from suppressed states to subsequent admissibility evaluations without restoring suppressed states to active reasoning participation.

7. The computer system of claim 1, wherein the persistent cognitive substrate further comprises a thought cache storing previously generated cognitive structures as compressed representations within the persistent cognitive substrate, and wherein projecting a candidate state comprises:
retrieving one or more cached cognitive structures satisfying a semantic similarity threshold relative to the candidate state;
evaluating epistemic admissibility of each retrieved cached structure against current structural properties of the persistent cognitive substrate prior to incorporating the cached structure into active reasoning; and
excluding cached cognitive structures assigned a suppressed or quarantined participation state from participating in reasoning traversal regardless of semantic similarity to the candidate state.

8. The computer system of claim 7, wherein the thought cache implements a multi-tier storage architecture comprising a session cache maintaining recent cognitive structures with full structural fidelity, a long-term cache maintaining consolidated cognitive structures with compressed representations, and a constraint cache maintaining non-reconstructable constraint artifacts projected from epistemically inadmissible reasoning patterns, and wherein retrieval from the constraint cache is limited to read-only admissibility evaluation queries and does not restore inadmissible cognitive structures to active reasoning participation.

9. The computer system of claim 1, wherein the system is further configured to admit candidate states derived from outputs of a plurality of heterogeneous reasoning sources comprising at least two of a large language model, a domain-specific expert model, a multimodal inference engine, or a sensor-derived interpretation pipeline, and wherein:
each candidate state derived from a heterogeneous reasoning source is independently evaluated for epistemic admissibility against structural properties of the persistent cognitive substrate prior to incorporation into active reasoning;
candidate states from different reasoning sources that target semantically proximate locations in the persistent cognitive substrate are evaluated for mutual epistemic consistency using path-dependent descriptors maintained for those locations; and
when candidate states from different reasoning sources exhibit epistemic inconsistency at a common location, the system assigns a quarantined participation state to the inconsistent candidates and generates a conflict representation for storage in an irreversible reservoir.

10. The computer system of claim 9, wherein the system further arbitrates among candidate states from heterogeneous reasoning sources by:
computing a composite admissibility score for each candidate state incorporating structural compatibility, capacity, and epistemic strain metrics derived from the persistent cognitive substrate;
routing candidate states exceeding an admissibility score threshold to an absorbed or provisional participation state for incorporation into active reasoning;
routing candidate states below the admissibility score threshold to a quarantined state pending corroboration from an independent reasoning source; and
when no candidate state from any reasoning source satisfies the admissibility score threshold for a given location, escalating the unresolved location to a supervisory arbitration layer configured to request additional evidence or external corroboration before permitting reasoning traversal through that location.

11. The computer system of claim 1, wherein the system is further configured to present epistemic status information to a human operator or downstream process by:
qualifying generated outputs with a graded confidence indicator derived from the participation state and traversal coherence classification of the reasoning trajectory supporting the output;
withholding a generated output and presenting an epistemic insufficiency notification identifying a structural basis for withholding when no epistemically admissible reasoning trajectory supports a response;
presenting a corroboration request to a human operator or upstream evidence source when a reasoning trajectory exhibits a coherence failure condition and no independent corroborating trajectory satisfying coherence conditions can be identified within the persistent cognitive substrate; and
providing a traversal explanation identifying locations of elevated epistemic strain, capacity constraint, or admissibility boundary encountered during reasoning traversal that contributed to output qualification or withholding.

12. The computer system of claim 11, wherein the graded confidence indicator presented with a generated output reflects at least one of:
a participation state of cognitive states traversed during the reasoning trajectory supporting the output;
a coherence classification of path-dependent quantities detected during traversal;
a consolidation status of substrate regions traversed during reasoning, distinguishing consolidated irreversible reservoir regions from frontier regions undergoing active restructuring; or
a corroboration status indicating whether conclusions reached along the reasoning trajectory were independently corroborated by a non-homotopic admissible trajectory.

13. The computer system of claim 1, wherein the persistent cognitive substrate is maintained across a plurality of distributed nodes, and wherein the system is further configured to propagate admissibility governance across the distributed nodes by:
sharing constraint representations derived from epistemically inadmissible reasoning patterns between nodes through an asymmetric propagation protocol that transmits canonical constraint identifiers and structural pattern descriptors without transmitting reconstructable trajectory details or underlying cognitive state content;
maintaining node-local admissibility indices derived from received constraint representations such that inadmissible patterns identified at one node influence admissibility evaluations at other nodes without requiring synchronization of full substrate state; and
preserving privacy boundaries between nodes by restricting propagated content to abstract constraint artifacts that cannot be used to reconstruct cognitive states, reasoning trajectories, or consolidated knowledge content of the originating node.

14. The computer system of claim 13, wherein propagating admissibility governance across distributed nodes further comprises:
synchronizing reservoir boundary sets between nodes so that topological admissibility evaluations at each node reflect consolidated knowledge boundaries established across the distributed deployment;
applying privacy-preserving mechanisms to constraint representations prior to propagation to provide quantifiable privacy guarantees against reconstruction of originating node content; and
resolving conflicts between admissibility indices received from different nodes using a consensus protocol that weights constraint representations by stability metrics of the originating consolidated regions.

15. The computer system of claim 1, wherein the system is further configured to use outcomes of admissibility evaluation and traversal coherence monitoring as governance signals for updating the persistent cognitive substrate, comprising at least one of:
using suppression events and constraint representations stored in irreversible reservoirs as fine-tuning signals or cache-curation signals that reduce retrieval probability of semantically proximate cached cognitive structures associated with suppressed trajectory classes;
using coherence failure conditions and corroboration failures detected during traversal monitoring as inputs to an autonomous reorganization process configured to restructure regions of the persistent cognitive substrate exhibiting elevated epistemic strain or persistent coherence failure during reduced-activity periods; and
using admissibility outcome distributions across a sequence of reasoning cycles as routing signals that adjust assignment of candidate states to reasoning pathways or expert domains based on observed epistemic reliability patterns.

16. The computer system of claim 15, wherein using suppression events as cache-curation signals comprises:
identifying cached cognitive structures within a proximity threshold of suppressed locations in the persistent cognitive substrate;
reducing activation energy of identified cached structures proportionally to the epistemic strain magnitude associated with the suppression event; and
accelerating decay of cached structures whose activation energy falls below a minimum threshold as a result of suppression-driven curation, thereby removing epistemically compromised cached content from the persistent cognitive substrate without requiring explicit deletion operations.
